(19) United States
(12) Patent Application Publication
(10) Pub. No.: US 2026/0303660 A1
(43) Pub. Date: Oct. 1, 2026

(54) SYSTEMS AND METHODS FOR AUTONOMOUS GENERATION, ASSESSMENT, AND DEPLOYMENT OF THREAT DETECTION INSTRUCTIONS IN A THREAT DETECTION AND RESPONSE SERVICE

(71) Applicant: Sublime Security, Inc., Washington, DC (US)

(72) Inventors: Joshua Kamdjou, Washington, DC (US); Ian Thiel, Brooklyn, NY (US); Ross Wolf, Denver, CO (US); Anna Bertiger, Washington, DC (US); Bobby Filar, Washington, DC (US); Aryan Luthra, Washington, DC (US); Stefano Meschiari, Washington, DC (US); Aiden Mitchell, Washington, DC (US); Sam Scholten, Washington, DC (US); Vivek Sharath, Washington, DC (US)

(73) Assignee: Sublime Security, Inc., Washington, DC (US)

(21) Appl. No.: 19/707,852

(22) Filed: Jun. 15, 2026

Related U.S. Application Data
(63) Continuation-in-part of application No. 19/659,492, filed on Apr. 27, 2026.
Application No. 19/659,492 is a continuation of application No. 19/348,576, filed on Oct. 2, 2025, now Pat. No. 12,641,115.
Application No. 19/348,576 is a continuation of application No. 19/261,636, filed on Jul. 7, 2025, now Pat. No. 12,452,296.
(60) Provisional application No. 63/757,898, filed on Feb. 13, 2025.
(60) Provisional application No. 63/831,662, filed on Jun. 27, 2025.
(60) Provisional application No. 63/912,391, filed on Nov. 6, 2025.
(60) Provisional application No. 64/004,982, filed on Mar. 13, 2026.

(51) Int. Cl. H04L 9/40

(52) U.S. Cl. CPC H04L 63/1441; H04L 63/1416

(57) ABSTRACT

A system, method, and computer-program product includes transmitting, to an autonomous artificial intelligence (AI) agent, message data of an electronic message that evaded a set of threat detection instructions provided by a threat detection and response service, detecting, based on the autonomous AI agent assessing the message data of the electronic message, a message signature associated with the electronic message, determining, based on the autonomous AI agent assessing the message signature against the set of threat detection instructions, a detection gap resolution operation to resolve a detection gap identified within the threat detection and response service, generating, using a language model associated with the autonomous AI agent and in accordance with the detection gap resolution operation, a candidate threat detection instruction, and iteratively modifying, by the autonomous AI agent, the candidate threat detection instruction over a plurality of iterations to generate a production-ready threat detection instruction.

### CROSS-REFERENCE TO RELATED APPLICATIONS

This application claims the benefit of U.S. Provisional Application No. 64/004,982, filed 13 Mar. 2026, U.S. Provisional Application No. 63/912,391, filed 6 Nov. 2025, U.S. Provisional Application No. 63/831,662, filed 27 Jun. 2025, and is a continuation-in-part-of U.S. application Ser. No. 19/659,492, filed 27 Apr. 2026, which is a continuation of U.S. Pat. No. 12,641,115, filed 2 Oct. 2025, which is a continuation of U.S. Pat. No. 12,452,296, filed 7 Jul. 2025, which claims the benefit of U.S. Provisional Application No. 63/757,898, filed 13 Feb. 2025, which are incorporated in their entireties by this reference.

### TECHNICAL FIELD

This invention relates generally to the cybersecurity field, and more specifically to new and useful threat detection and mitigation systems and methods in the cybersecurity field.

### BACKGROUND

Conventional cybersecurity services are designed as closed, black-box solutions. Such cybersecurity services fail to provide transparency into how security threats are detected and further restrict subscribing entities from modifying any characteristic related to threat detection. As a result, subscribing entities lack control over how security threats are detected and cannot adapt detection logic to their unique operating requirements.

Therefore, there is a need in the art for systems and methods that provide subscribing entities with transparency into how security threats are detected, as well as control over the detection logic used to identify such threats. The embodiments of the present application provide technical solutions that address, at least, the needs described above, as well as the deficiencies of the state of the art.

### BRIEF SUMMARY OF THE EMBODIMENTS

In one or more embodiments, a computer-implemented method includes at a threat detection and response service: electronically transmitting, to an autonomous artificial intelligence (AI) agent, message data of an electronic message that evaded a set of threat detection instructions provided by the threat detection and response service, wherein the electronic message evaded detection by the threat detection and response service due to a detection gap in the set of threat detection instructions; in response to the autonomous AI agent receiving the message data of the electronic message: automatically detecting, based on the autonomous AI agent assessing the message data of the electronic message, a message signature associated with the electronic message; automatically determining, based on the autonomous AI agent assessing the message signature against the set of threat detection instructions, a detection gap resolution operation to resolve the detection gap, wherein: the detection gap resolution operation corresponds to updating a respective threat detection instruction included in the set of threat detection instructions when the respective threat detection instruction is determined to be extensible to detect the message signature, and the detection gap resolution operation corresponds to generating a new threat detection instruction when no threat detection instruction included in the set of threat detection instructions is determined to be extensible to detect the message signature; generating, using a large language model associated with the autonomous AI agent and in accordance with the detection gap resolution operation, a candidate threat detection instruction that is operably configured to (i) resolve the detection gap and (ii) detect suspicious electronic messages that correspond to the message signature; iteratively modifying, by the autonomous AI agent, the candidate threat detection instruction over a plurality of iterations to generate a production-ready threat detection instruction that satisfies predetermined instruction performance criteria of the threat detection and response service; and in response to generating the production-ready threat detection instruction: displaying the production-ready threat detection instruction on a graphical user interface that is accessible by a subscribing entity that received the electronic message, or automatically deploying, within the threat detection and response service, the production-ready threat detection instruction to resolve the detection gap and prevent future electronic messages corresponding to the message signature from evading the set of threat detection instructions.

In one embodiment, iteratively modifying the candidate threat detection instruction over the plurality of iterations to generate the production-ready threat detection instruction includes in response to generating the candidate threat detection instruction, executing, by the autonomous AI agent, a first threat hunt that assesses a plurality of historical electronic messages that occurred during a target time span against the candidate threat detection instruction; receiving, based on executing the first threat hunt, hunt findings data that specifies: a total number of true positive electronic messages that the candidate threat detection instruction correctly detected as malicious, a total number of false positive electronic messages that the candidate threat detection instruction incorrectly detected as malicious, and a total number of unique true positive electronic messages that (a) the candidate threat detection instruction correctly detected as malicious and (b) were not detected as malicious by any other threat detection instructions included in the set of threat detection instructions; computing, using a subagent in operable communication with the autonomous AI agent, a detection accuracy score for the candidate threat detection instruction based on the hunt findings data associated with the first threat hunt, wherein the detection accuracy score is computed using the total number of true positive electronic messages, the total number of false positive electronic messages, and the total number of unique true positive electronic messages; detecting, by the subagent in operable communication with the autonomous AI agent, that the detection accuracy score computed for the candidate threat detection instruction fails to satisfy the predetermined instruction performance criteria of the threat detection and response service; in response to detecting the detection accuracy score computed for the candidate threat detection instruction fails to satisfy the predetermined instruction performance criteria of the threat detection and response service, generating, using the large language model associated with the autonomous AI agent, a second candidate threat detection instruction by modifying detection logic encoded in the candidate threat detection instruction; in response to generating the second candidate threat detection instruction, executing, by the autonomous AI agent, a second threat hunt that assesses the plurality of historical electronic messages that occurred during the target time span against the second candidate threat detection instruction; computing, using the subagent in operable communication with the autonomous AI agent, a detection accuracy score for the second candidate threat detection instruction using new hunt findings data received from the second threat hunt; determining, by the subagent in operable communication with the autonomous AI agent, that the detection accuracy score computed for the second candidate threat detection satisfies the predetermined instruction performance criteria of the threat detection and response service; and in response to identifying the second candidate threat detection instruction satisfies the predetermined instruction performance criteria of the threat detection and response service: designating, by the autonomous AI agent, the second candidate threat detection instruction as the production-ready threat detection instruction.

In one embodiment, iteratively modifying the candidate threat detection instruction over the plurality of iterations to generate the production-ready threat detection instruction includes: in response to generating the candidate threat detection instruction, computing, using a subagent in operable communication with the autonomous AI agent, an instruction evasion susceptibility score for the candidate threat detection instruction based on: (a) a total number of detection expressions encoded in the candidate threat detection instruction that rely on exact string matching of indicators of compromise values, and (b) a total number of detection expressions encoded in the candidate threat detection instruction that models attacker behaviors instead of relying on exacting string matching of the indicators of compromise values; detecting, by the subagent in operable communication with the autonomous AI agent, that the instruction evasion susceptibility score computed for the candidate threat detection instruction fails to satisfy the predetermined instruction performance criteria of the threat detection and response service; in response to detecting the instruction evasion susceptibility score computed for the candidate threat detection instruction fails to satisfy the predetermined instruction performance criteria of the threat detection and response service, generating, using the large language model associated with the autonomous AI agent, a second candidate threat detection instruction by modifying detection logic encoded in the candidate threat detection instruction; in response to generating the second candidate threat detection instruction, computing, using the subagent in operable communication with the autonomous AI agent, an instruction evasion susceptibility score for the second candidate threat detection instruction; determining, by the subagent in operable communication with the autonomous AI agent, that the instruction evasion susceptibility score computed for the second candidate threat detection satisfies the predetermined instruction performance criteria of the threat detection and response service; and in response to identifying the second candidate threat detection instruction satisfies the predetermined instruction performance criteria of the threat detection and response service: designating, by the autonomous AI agent, the second candidate threat detection instruction as the production-ready threat detection instruction.

In one embodiment, the production-ready threat detection instruction is encoded with a computer-executable enrichment function that is configured to perform an enrichment operation, and the computer-implemented method further includes: assessing a data model of one of the future electronic messages against the production-ready threat detection instruction; invoking the computer-executable enrichment function during the assessment of the data model of the one of the future electronic messages against the production-ready threat detection instruction; transmitting a request to a backend service of the threat detection and response service to perform the enrichment operation in response to invoking the computer-executable enrichment function; and receiving a response from the backend service that includes an enrichment output in response to the backend service performing the enrichment operation, wherein the production-ready threat detection instruction determines that the one of the future electronic messages is malicious based at least in part on the enrichment output.

In one embodiment, iteratively modifying the candidate threat detection instruction over the plurality of iterations to generate the production-ready threat detection instruction includes: detecting, based on the autonomous AI agent assessing the candidate threat detection instruction, that at least one detection expression encoded in the candidate threat detection instruction does not conform to syntax requirements defined by the threat detection and response service; generating, using the large language model associated with the autonomous AI agent, a second candidate threat detection instruction by modifying the at least one detection expression to conform to the syntax requirements defined by the threat detection and response service; in response to generating the second candidate threat detection instruction, confirming, based on the autonomous AI agent assessing the second candidate threat detection instruction against the electronic message, that the second candidate threat detection instruction detects the electronic message as malicious, spam, or graymail; in response to confirming that the second candidate threat detection instruction detects the electronic message as malicious, spam, or graymail, executing, by the autonomous AI agent, a first threat hunt that assesses a plurality of historical electronic messages of the subscribing entity using the second candidate threat detection instruction; receiving, based on executing the first threat hunt, hunt findings data that indicates the second candidate threat detection instruction did not detect any historical electronic messages of the plurality of historical electronic messages as malicious, spam, or graymail; determining, using one or more subagents in operable communication with the autonomous AI agent, that the second candidate threat detection instruction is too restrictive based in part on the one or more subagents assessing the hunt findings data; generating, using the large language model associated with the autonomous AI agent, a third candidate threat detection instruction based on modifying one or more portions of the second candidate threat detection instruction to reduce a restrictiveness of the second candidate threat detection instruction; in response to generating the third candidate threat detection instruction: confirming, based on the autonomous AI agent assessing the third candidate threat detection instruction, that the third candidate threat detection instruction satisfies the syntax requirements defined by the threat detection and response service; and confirming, based on the autonomous AI agent assessing the third candidate threat detection instruction against the electronic message, that the third candidate threat detection instruction detects the electronic message as malicious, spam, or graymail; in response to confirming that the third candidate threat detection instruction detects the electronic message as malicious, spam, or graymail, executing, by the autonomous AI agent, a second threat hunt that assesses the plurality of historical electronic messages of the subscribing entity using the third candidate threat detection instruction; receiving, based on executing the second threat hunt, a subset of the plurality of historical electronic messages that the third candidate threat detection instruction detected as malicious, spam, or graymail; determining, using the one or more subagents in operable communication with the autonomous AI agent, that the third candidate threat detection instruction is not restrictive based on the one or more subagents assessing the subset of the plurality of historical electronic messages returned from the second threat hunt; identifying that the third candidate threat detection instruction satisfies the predetermined instruction performance criteria of the threat detection and response service in response to the one or more subagents determining that the third candidate threat detection instruction is not restrictive, and in response to identifying the third candidate threat detection instruction satisfies the predetermined instruction performance criteria, designating the third candidate threat detection instruction as the production-ready threat detection instruction.

In one embodiment, the production-ready threat detection instruction generated by the autonomous AI agent includes a plurality of distinct threat detection sections, and each distinct threat detection section of the plurality of distinct threat detection sections includes: a respective subset of threat detection logic associated with a corresponding threat detection objective, and one or more natural language code comments that describe the corresponding threat detection objective associated with the respective subset of threat detection logic.

In one embodiment, the computer-implemented method further includes: before electronically transmitting the message data of the electronic message to the autonomous AI agent: displaying, on the graphical user interface, the electronic message of the subscribing entity and an AI agent invocation user interface button configured to invoke the autonomous AI agent; and receiving, while displaying the electronic message and the AI agent invocation user interface button on the graphical user interface, an input from a user selecting the AI agent invocation user interface button; and in response to receiving the input selecting the AI agent invocation user interface button, electronically transmitting, in real-time or near real-time, the message data of the electronic message to the autonomous AI agent.

In one embodiment, the production-ready threat detection instruction is displayed on the graphical user interface in response to the autonomous AI agent generating the production-ready threat detection instruction, wherein the graphical user interface includes: the production-ready threat detection instruction, a calendar date and a clock time at which the autonomous AI agent was automatically invoked to assess the message data of the electronic message, a total amount of time the autonomous AI agent autonomously operated to generate the production-ready threat detection instruction, a natural language description generated for the production-ready threat detection instruction, an autonomous AI agent reasoning summary describing, in natural language, a sequence of operations performed by the autonomous AI agent to generate and test the production-ready threat detection instruction, a message hunt user interface object specifying a set of historical electronic messages detected by the production-ready threat detection instruction over a predetermined historical time period, an instruction acceptance user interface button for approving deployment of the production-ready threat detection instruction, and an instruction rejection user interface button for rejecting deployment of the production-ready threat detection instruction, and the computer-implemented method further includes: receiving, via the graphical user interface, an input from a user selecting the instruction acceptance user interface button displayed on the graphical user interface; and in response to receiving the input selecting the instruction acceptance user interface button, automatically deploying the production-ready threat detection instruction within a distinct instance of the threat detection and response service that is configured for the subscribing entity, thereby preventing the future electronic messages from evading threat detection within the distinct instance of the threat detection and response service.

In one embodiment, the computer-implemented method further includes in response to generating the production-ready threat detection instruction: generating, using the large language model associated with the autonomous AI agent, one or more natural language artifacts for the production-ready threat detection instruction, wherein: the one or more natural language artifacts are displayed on the graphical user interface, and the one or more natural language artifacts includes: a first set of natural language text strings describing a plurality of detection expressions encoded in the production-ready threat detection instruction, a second set of natural language text strings describing one or more computational cost reduction operations encoded in the production-ready threat detection instruction, a third set of natural language text strings describing an efficacy of the production-ready threat detection instruction, a fourth set of natural language text strings describing a set of false positive mitigation controls that the autonomous AI agent encoded in the production-ready threat detection instruction, and a fifth set of natural language text strings describing a set of proposed instruction tuning recommendations generated by the autonomous AI agent for modifying the production-ready threat detection instruction upon occurrence of false positives or missed detections associated with the production-ready threat detection instruction.

In one embodiment, the computer-implemented method further includes before electronically transmitting the message data of the electronic message to the autonomous AI agent: displaying, on the graphical user interface, a plurality of autonomous AI agent control user interface objects mapped to a malicious message class, and receiving, via a first user interface control object of the plurality of autonomous AI agent control user interface objects, an input from a user that enables automated execution of the autonomous AI agent for the malicious message class; in response to receiving the input enabling automated execution of the autonomous AI agent for the malicious message class, transitioning the first user interface control object from a disabled state to an enabled state for the malicious message class; and after enabling automated execution of the autonomous AI agent for the malicious message class: receiving, in real-time or near real-time, the electronic message; determining, in real-time or near real-time by an automated message triaging agent, that the electronic message is of the malicious message class; and in response to the automated message triaging agent determining that the electronic message is of the malicious message class, automatically transmitting, by the automated message triaging agent, the message data of the electronic message to the autonomous AI agent in real-time or near real-time.

In one embodiment, the computer-implemented method further includes before electronically transmitting the message data of the electronic message to the autonomous AI agent and while displaying the plurality of autonomous AI agent control user interface objects mapped to the malicious message class on the graphical user interface: receiving, via the graphical user interface, an additional input from the user selecting a second user interface control object of the plurality of autonomous AI agent control user interface objects mapped to the malicious message class; in response to receiving the additional input selecting the second user interface control object, displaying a drop-down element that includes a plurality of distinct instruction acceptance options for the malicious message class, wherein the plurality of distinct instruction acceptance options includes at least: an automatic instruction acceptance option that, when selected, encodes the autonomous AI agent to automatically deploy all production-ready threat detection instructions generated by the autonomous AI agent for the malicious message class that satisfy a target instruction acceptance criterion defined by the threat detection and response service; a custom instruction acceptance option that, when selected, encodes the autonomous AI agent to automatically deploy all production-ready threat detection instructions generated by the autonomous AI agent for the malicious message class that satisfy a custom instruction acceptance criterion defined by the user, and a user instruction review option that, when selected, encodes the autonomous AI agent to prevent automatic deployment of production-ready threat detection instructions generated by the autonomous AI agent for the malicious message class until review and approval by the user; receiving, while the drop-down element is displayed on the graphical user interface, a subsequent user input from the user selecting the automatic instruction acceptance option; and in response to generating the production-ready threat detection instruction: automatically deploying the production-ready threat detection instruction within a distinct instance of the threat detection and response service configured for the subscribing entity based on detecting (a) the subsequent user input selected the automatic instruction acceptance option and (b) the target instruction acceptance criterion defined by the threat detection and response service is satisfied.

In one embodiment, the computer-implemented method further includes before electronically transmitting the message data of the electronic message to the autonomous AI agent: displaying, on the graphical user interface, a plurality of autonomous AI agent control user interface objects mapped to a spam message class, receiving, via a first user interface control object of the plurality of autonomous AI agent control user interface objects, an input from a user that enables automated execution of the autonomous AI agent for the spam message class; in response to receiving the input enabling automated execution of the autonomous AI agent for the spam message class, transitioning the first user interface control object from a disabled state to an enabled state for the spam message class; and after enabling automated execution of the autonomous AI agent for the spam message class: receiving, in real-time or near real-time, the electronic message; and determining, in real-time or near real-time by an automated message triaging agent, that the electronic message is of the spam message class; and in response to the automated message triaging agent determining that the electronic message is of the spam message class, automatically transmitting, by the automated message triaging agent, the message data of the electronic message to the autonomous AI agent in real-time or near real-time.

In one embodiment, the computer-implemented method further includes before electronically transmitting the message data of the electronic message to the autonomous AI agent and while displaying the plurality of autonomous AI agent control user interface objects mapped to the spam message class on the graphical user interface: receiving, via the graphical user interface, an additional input from the user selecting a second user interface control object of the plurality of autonomous AI agent control user interface objects mapped to the spam message class; in response to receiving the additional input selecting the second user interface control object, displaying a drop-down element that includes a plurality of distinct instruction acceptance options for the spam message class, wherein the plurality of distinct instruction acceptance options includes at least: an automatic instruction acceptance option that, when selected, encodes the autonomous AI agent to automatically deploy all production-ready threat detection instructions generated by the autonomous AI agent for the spam message class that satisfy a target instruction acceptance criterion defined by the threat detection and response service; a custom instruction acceptance option that, when selected, encodes the autonomous AI agent to automatically deploy all production-ready threat detection instructions generated by the autonomous AI agent for the spam message class that satisfy a custom instruction acceptance criterion defined by the user, and a user instruction review option that, when selected, encodes the autonomous AI agent to prevent automatic deployment of production-ready threat detection instructions generated by the autonomous AI agent for the spam message class until review and approval by the user; receiving, while the drop-down element is displayed on the graphical user interface, a subsequent user input from the user selecting the custom instruction acceptance option; and in response to generating the production-ready threat detection instruction: automatically deploying the production-ready threat detection instruction within a distinct instance of the threat detection and response service configured for the subscribing entity based on detecting (a) the subsequent user input selected the custom instruction acceptance option and (b) the custom instruction acceptance criterion defined by the user is satisfied.

In one embodiment, the computer-implemented method further includes before electronically transmitting the message data of the electronic message to the autonomous AI agent: displaying, on the graphical user interface, a plurality of autonomous AI agent control user interface objects mapped to a graymail message class, receiving, via a first user interface control object of the plurality of autonomous AI agent control user interface objects, an input from a user that enables automated execution of the autonomous AI agent for the graymail message class; in response to receiving the input enabling automated execution of the autonomous AI agent for the graymail message class, transitioning the first user interface control object from a disabled state to an enabled state for the graymail message class; and after enabling automated execution of the autonomous AI agent for the graymail message class: receiving, in real-time or near real-time, the electronic message; and determining, in real-time or near real-time by an automated message triaging agent, that the electronic message is of the graymail message class; and in response to the automated message triaging agent determining that the electronic message is of the graymail message class, automatically transmitting, by the automated message triaging agent, the message data of the electronic message to the autonomous AI agent in real-time or near real-time.

In one embodiment, the computer-implemented method further includes before electronically transmitting the message data of the electronic message to the autonomous AI agent and while displaying the plurality of autonomous AI agent control user interface objects mapped to the graymail message class on the graphical user interface: receiving, via the graphical user interface, an additional input from the user selecting a second user interface control object of the plurality of autonomous AI agent control user interface objects mapped to the graymail message class; in response to receiving the additional input selecting the second user interface control object, displaying a drop-down element that includes a plurality of distinct instruction acceptance options for the graymail message class, wherein the plurality of distinct instruction acceptance options includes at least: an automatic instruction acceptance option that, when selected, encodes the autonomous AI agent to automatically deploy all production-ready threat detection instructions generated by the autonomous AI agent for the graymail message class that satisfy a target instruction acceptance criterion defined by the threat detection and response service; a custom instruction acceptance option that, when selected, encodes the autonomous AI agent to automatically deploy all production-ready threat detection instructions generated by the autonomous AI agent for the graymail message class that satisfy a custom instruction acceptance criterion defined by the user, and a user instruction review option that, when selected, encodes the autonomous AI agent to prevent automatic deployment of production-ready threat detection instructions generated by the autonomous AI agent for the graymail message class until review and approval by the user; receiving, while the drop-down element is displayed on the graphical user interface, a subsequent user input from the user selecting the user instruction review option; and in response to generating the production-ready threat detection instruction: displaying the production-ready threat detection instruction on the graphical user interface based on detecting the subsequent user input selected the user instruction review option.

In one embodiment, the computer-implemented method further includes before electronically transmitting the message data of the electronic message to the autonomous AI agent: receiving, via the graphical user interface, a first input from a user selecting a user interface object associated with the autonomous AI agent; in response to receiving the first input selecting the user interface object associated with the autonomous AI agent, displaying, on the graphical user interface, an AI agent activation button for activating the autonomous AI agent; receiving, via the graphical user interface, a second input from the user selecting the AI agent activation button; in response to receiving the second input selecting the AI agent activation button, displaying, on the graphical user interface, an AI agent control user interface element that indicates the autonomous AI agent is in an inactive state; receiving, via the graphical user interface, a third user input from the user selecting the AI agent control user interface element; in response to receiving the third user input selecting the AI agent control user interface element, displaying, on the graphical user interface, a drop-down element that includes a selectable active state option and a selectable inactive state option for the autonomous AI agent; and receiving, while displaying the drop-down element, a fourth user input selecting the selectable active state option; and in response to receiving the fourth user input selecting the selectable active state option: activating the autonomous AI agent for the subscribing entity to enable automated generation of production-ready threat detection instructions by the autonomous AI agent electronic messages when the autonomous AI agent receives a subject electronic message associated with the subscribing entity that (a) evaded the set of threat detection instructions and (b) determined to correspond to one of a malicious message class, a spam message class, and a graymail message class; and transitioning the AI agent control user interface element from indicating the autonomous AI agent is in the inactive state to indicating that the autonomous AI agent is active.

In one embodiment, the computer-implemented method further includes before electronically transmitting the message data of the electronic message of the subscribing entity to the autonomous AI agent: automatically generating, using an automated message triaging agent, a threat assessment object for the electronic message, wherein the threat assessment object specifies a message threat class predicted for the electronic message and a plurality of distinct threat assessment sections that explains, in natural language, a rationale describing why the automated message triaging agent predicted the message threat class for the electronic message, and generating the candidate threat detection instruction includes: providing the threat assessment object generated for the electronic message to the large language model associated with the autonomous AI agent; generating, using the large language model, the message signature for the electronic message in response to the large language model assessing the message data of the electronic message and the threat assessment object, wherein the message signature includes a plurality of message characteristics associated with the electronic message; in response to generating the message signature for the electronic message, querying, using a representation of the message signature as a query parameter, the set of threat detection instructions to determine whether an existing threat detection instruction included in the set of threat detection instructions is associated with the message signature; determining, based on query results returned from the querying, that no threat detection instruction included in the set of threat detection instructions is determined to be extensible to detect the message signature; and in response to determining that no threat detection instruction included in the set of threat detection instructions is extensible to detect the message signature, generating, using the large language model, the new threat detection instruction based in part on the message signature, wherein the new threat detection instruction includes a plurality of detection expressions operably configured to detect the message signature.

In one embodiment, the query results returned at least one threat detection instruction that is associated with a subset of the plurality of message characteristics included in the message signature, and the computer-implemented method further includes: determining, by the large language model, that the at least one threat detection instruction is not extensible to detect the message signature due to the at least one threat detection instruction failing to evaluate the subset of the plurality of message characteristics in combination with one or more additional message characteristics included in the message signature, wherein: the large language model determined that no threat detection instruction included in the set of threat detection instructions is extensible to detect the message signature based on the large language model determining that the at least one threat detection instruction does not evaluate the subset of the plurality of message characteristics together with the one or more additional message characteristics within a single threat detection instruction.

In one embodiment, the large language model determined that no threat detection instruction included in the set of threat detection instructions is extensible to detect the message signature due to the querying failing to identify any threat detection instruction associated with the message signature.

In one embodiment, the computer-implemented method further includes: before electronically transmitting the message data of the electronic message to the autonomous AI agent: automatically generating, using an automated message triaging agent, a threat assessment object for the electronic message, wherein the threat assessment object specifies a threat class predicted for the electronic message and a plurality of distinct threat assessment sections that explains, in natural language, a rationale describing why the automated message triaging agent predicted the threat class for the electronic message, and generating the candidate threat detection instruction includes: providing the threat assessment object generated for the electronic message to the large language model associated with the autonomous AI agent; generating, using the large language model, the message signature for the electronic message in response to the large language model assessing the message data of the electronic message and the threat assessment object, wherein the message signature includes a plurality of message characteristics associated with the electronic message; querying, based on the message signature, the set of threat detection instructions to determine whether an existing threat detection instruction included in the set of threat detection instructions is associated with the message signature; returning the respective threat detection instruction based on the querying detecting the respective threat detection instruction is associated with the message signature; determining, by the large language model, that (a) the respective threat detection instruction is extensible to detect the message signature and (b) one or more additional message characteristics included in the message signature are not evaluated by the respective threat detection instruction; and generating, using the large language model, a modified version of the respective threat detection instruction by adding, within the respective threat detection instruction, one or more detection expressions configured to evaluate the one or more additional message characteristics, wherein the modified version of the respective threat detection instruction corresponds to the candidate threat detection instruction.

In one embodiment, the autonomous AI agent iteratively modifies the candidate threat detection instruction until the predetermined instruction performance criteria of the threat detection and response service is satisfied or a predetermined instruction cost criterion is satisfied, and the computer-implemented method further includes: detecting, via the autonomous AI agent, that the predetermined instruction cost criterion is satisfied; and in response to detecting that the predetermined instruction cost criterion is satisfied: designating, by the autonomous AI agent, a most recent candidate threat detection instruction generated over the plurality of iterations as the production-ready threat detection instruction; generating, using the large language model associated with the autonomous AI agent, (a) explanatory data describing feedback data received from one or more subagents in operable communication with autonomous AI agent over the plurality of iterations and (b) one or more tradeoffs associated with the production-ready threat detection instruction; and displaying the one or more tradeoffs for the production-ready threat detection instruction in association with the production-ready threat detection instruction on the graphical user interface.

### BRIEF DESCRIPTION OF THE FIGURES

FIG. 1 illustrates a schematic representation of a system 100 in accordance with one or more embodiments of the present application;

FIGS. 2-2B illustrate example methods in accordance with one or more embodiments of the present application;

FIG. 3 illustrates an example schematic of identifying a detection gap candidate in accordance with one or more embodiments of the present application;

FIGS. 4A-4B illustrate an example schematic of identifying a detection gap candidate in accordance with one or more embodiments of the present application;

FIG. 5 illustrates an example schematic of generating, assessing, and iteratively refining a second set of threat detection instructions based on the detection gap candidate in accordance with one or more embodiments of the present application;

FIG. 6 illustrates an example of generating candidate threat detection logic and assessing the candidate threat detection logic in accordance with one or more embodiments of the present application;

FIG. 7 illustrates an example of assessing evaluation results produced by applying a threat detection instruction to historical electronic communication data in accordance with one or more embodiments of the present application;

FIG. 8 illustrates an example of a system-generated threat detection instruction in accordance with one or more embodiments of the present application;

FIG. 9 illustrates an example graphical user interface for reviewing, approving, or rejecting a validated threat detection instruction in accordance with one or more embodiments of the present application;

FIGS. 10 and 10A illustrate an example of a production-ready threat detection instruction in accordance with one or more embodiments of the present application;

FIGS. 11-16 illustrate example graphical user interfaces in accordance with one or more embodiments of the present application;

FIG. 17 illustrates an example of a threat assessment object in accordance with one or more embodiments of the present application;

FIG. 18 illustrates an example of a message hunt user interface object (e.g., threat hunt user interface object) in accordance with one or more embodiments of the present application; and

FIGS. 19-22 illustrate example natural language artifacts generated by the threat detection and response service in accordance with one or more embodiments of the present application.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

The systems, methods, and computer program products described herein may be utilized in a variety of cybersecurity environments where automated or semi-automated generation and deployment of threat detection instructions is critical to preventing malicious electronic messages (e.g., malicious electronic communications or the like) from evading threat detection. This includes cybersecurity environments where identifying and mitigating suspicious activity is essential for maintaining the integrity and security of computing and digital assets of a subscribing entity.

Conventional threat detection and response systems are unable to generate and deploy new threat detection instructions at a pace sufficient to keep up with rapidly evolving malicious electronic message campaigns. This is because security threats and malicious electronic messages continuously evolve at an incalculable rate that exceeds a rate at which existing threat detection instructions can be updated within the conventional threat detection and response systems to maintain effective detection coverage. In contrast, the systems, methods, embodiments, and computer program products described herein are capable of autonomously generating and deploying threat detection instructions in a manner that enables a threat detection and response service to keep pace with emerging security threats and evolving malicious electronic message campaigns. For instance, in some embodiments, in response to the systems, methods, and computer-program products described herein detecting that an electronic message evaded a set of threat detection instructions due to a detection gap, an autonomous artificial intelligence (AI) agent and/or one or more AI subagents in operable communication with the autonomous AI agent may automatically generate a candidate threat detection instruction, iteratively modify the candidate threat detection instruction into a production-ready threat detection instruction, validate the production-ready threat detection instruction, and deploy the production-ready threat detection instruction to resolve the detection gap and prevent future malicious electronic messages associated with the detection gap from evading detection.

Conventional threat detection and response systems are further constrained to only deploying threat detection instructions that are generalized for all subscribing entities subscribing to the conventional threat detection and response systems. Accordingly, in such conventional threat detection and response systems, when a malicious electronic message received by a subscribing entity evades detection, conventional threat detection and response systems may opt not to react or generate a new threat detection instruction responsive to the malicious electronic message because the malicious electronic message may only target the subscribing entity or affect a limited subset of subscribing entities. That is, despite the malicious electronic message exposing a detection gap within the conventional threat detection and response systems by successfully evading detection, conventional threat detection and response systems may decline to generate or deploy new threat detection logic because the malicious electronic message campaign is isolated to a single subscribing entity or a limited subset of subscribing entities. In contrast, the systems, methods, embodiments, and computer program products described herein are capable of autonomously generating and deploying threat detection instructions responsive to identifying malicious electronic messages that evade detection for a single subscribing entity. For instance, in some embodiments, in response to detecting that a malicious electronic message transmitted to a single subscribing entity evaded detection due to a detection gap, an autonomous AI agent and/or one or more AI subagents in operable communication with the autonomous AI agent may automatically generate a production-ready threat detection instruction responsive to the malicious electronic message and only deploy the production-ready threat detection instruction within a computing environment associated with the single subscribing entity (e.g., not deploying the production-ready threat detection instruction within computing environments associated with unaffected subscribing entities).

Conventional large language models (LLMs) hallucinate and generate visually plausible code that appears facially acceptable but nevertheless fails to operate correctly within a production computing environment for many reasons. For example, conventional LLMs may generate code that is logically flawed, overly brittle, performs inconsistently, lacks robustness, and/or fails under edge-case conditions. In contrast, the systems, methods, embodiments, and computer program products described herein do not blindly rely on outputs generated by a large language model to generate production-ready threat detection instructions. Instead, the systems, methods, embodiments, and computer program products described herein are capable of autonomously testing, validating, and iteratively modifying candidate threat detection instructions generated using a large language model until predetermined instruction performance criteria of a threat detection and response service is satisfied. In other words, rather than blindly relying on a threat detection instruction initially generated by a large language model, the systems, methods, embodiments, and computer program products described herein are capable of autonomously testing and iteratively modifying the threat detection instruction until the threat detection instruction satisfies predetermined instruction performance criteria of a threat detection and response service. For instance, in some embodiments, an autonomous AI agent and/or one or more AI subagents in operable communication with the autonomous AI agent may automatically execute one or more instruction validation operations for a candidate threat detection instruction generated using a large language model, iteratively modify detection logic encoded in the candidate threat detection instruction responsive to validation results generated from the one or more validation operations, and designate a modified threat detection instruction as a production-ready threat detection instruction based on the modified threat detection instruction satisfying the predetermined instruction performance criteria of the threat detection and response service. Therefore, the systems, methods, embodiments, and computer program products described herein overcome the technical challenges associated with using large language models.

### 1.0 System for Real-Time Detection and Mitigation of Malicious Electronic Communications

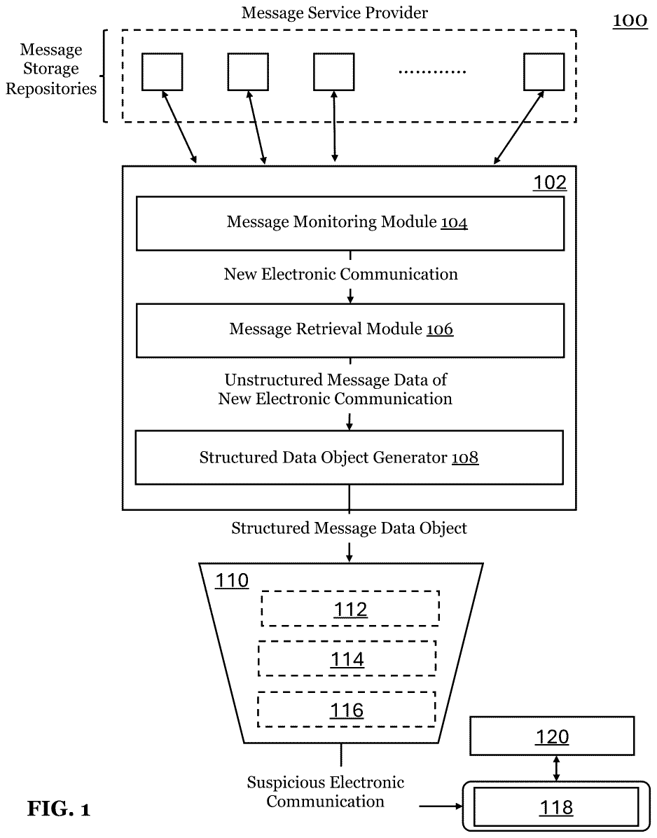

As shown in FIG. 1, a system 100 for implementing remote detection and mitigation of malicious electronic communications may include a message detection and transformation module 102 that includes a message monitoring module 104, a message retrieval module 106, and a structured data object generator 108. The system 100 may further include a message threat assessment module no that includes one or more detection layers, such as a first detection layer 112, a second detection layer 114, and a third detection layer 116. The system 100 may further include a message threat mitigation module 118.

The system 100 may sometimes be referred to herein as a message threat detection and response service, a threat detection and response service, or the like. The message threat detection and response service, in one or more embodiments, may be implemented by a network of distributed computers.

The system 100 may enable real-time message detection and intelligent threat response for mitigating detected malicious electronic communications. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

### 1.1 Message Detection and Transformation Module

The message detection and transformation module 102, sometimes referred to herein as the “message detection and transformation engine” may be operably configured to monitor one or more message storage repositories of one or more subscribing entities for new electronic communications.

The message monitoring module 104 of the message detection and transformation module 102 may be operably configured to detect message delivery events that occur at the one or more message storage repositories. A message delivery event, in some embodiments, may indicate that a new electronic communication has been electronically delivered or transmitted to one of the one or more message storage repositories that the system 100 is actively monitoring. The message monitoring module 104 may detect such message delivery events using any suitable programmatic mechanism.

Additionally, after detecting that a new electronic communication was delivered or transmitted to a monitored message storage repository, message retrieval module 106 of the message detection and transformation module 102 may function to retrieve unstructured message data (e.g., raw text data, plain text data, etc.) corresponding to the new electronic communication. The message retrieval module 106 may function to retrieve the unstructured message data corresponding to the new electronic communication by ingesting live message flows from the respective messaging service provider using an internet message access protocol (IMAP), calling an application programming interface (API) provided by the respective messaging service provider, or any other suitable programmatic communication mechanism.

Additionally, after obtaining the unstructured message data that corresponds to the new electronic communication, the structured data object generator 108 of the message detection and transformation module 102 may function to automatically generate, in real-time or near real-time, a structured message data object based on the unstructured message data that corresponds to the new electronic communication. The structured data object generator 108 may function to instantiate a message data object (e.g., data model or the like) based on a predefined message data model schema, extract a plurality of message components from the unstructured message data in accordance with the predefined message data model schema, and populate the message data object with the extracted message components to create a structured, machine-readable representation of the new electronic communication that is suitable for automated message assessment and threat detection.

### 1.2 Message Threat Assessment Module

The message threat assessment module 110, sometimes referred to herein as the “message threat assessment engine” may be operably configured to automatically evaluate, in real-time or near real-time, the structured message data object outputted by the message detection and transformation module 102 to detect whether the new electronic communication or the representation thereof is suspicious or malicious.

The message threat assessment module 110 may automatically assess or evaluate the structured message data object corresponding to the new electronic communication against one or more message detection layers. Each message detection layer may be configured to assess the structured message data object against a distinct corpus of threat detection instructions (e.g., message threat detection instructions or the like). For instance, the first detection layer 112 may be configured to automatically assess the structured message data object that represents the new electronic communication against a set of subscriber-agnostic threat detection instructions (e.g., heuristics, rules, or the like), the second detection layer 114 may be configured to automatically assess the structured message data object that represents the new electronic communication against a set of subscriber-specific threat detection instructions (e.g., heuristics, rules, or the like), and the third detection layer 116 may be configured to automatically assess the structured message data object that represents the new electronic communication against a set of third-party threat detection instructions. That is, the message threat assessment module 110 may function to concurrently or sequentially evaluate the structured message data object against global detection logic, subscriber-defined detection logic, and externally sourced detection logic to determine whether the new electronic communication exhibits characteristics indicative of anomalous, suspicious, or malicious behavior.

Accordingly, in one or more embodiments, the message threat assessment module no may detect that the new electronic communication is suspicious or malicious when the structured message data object representing the new electronic communication satisfies one or more logical conditions, heuristic expressions, or detection rules defined within at least one of the threat detection instruction sets used by the message threat assessment module 110.

### Accessing Global or User Lists

In some embodiments, the system 100 implementing the message threat assessment module 110 may function to reference one or more structured data lists from within the MQL. In such embodiments, the structured data lists may include global lists managed by the threat detection and response service provider, as well as organization-specific lists configured by administrators of the subscribing entity. Each structured data list may include data values that correspond to email attributes or other contextual identifiers, including but not limited to sender email addresses, email domains, Internet Protocol (IP) addresses, user identifiers, department codes, or organizational roles.

Additionally, or alternatively, an MQL interpreter or the message threat assessment module 110 may be configured to access the structured data lists during evaluation of threat detection instructions. A structured message data object may be assessed against a threat detection instruction that includes a logical expression or pointer referencing a structured data list. For example, a threat detection instruction may include a logical expression (e.g., detection logic or the like) that determines whether a sender attribute extracted from a structured message data object is present within a structured data list corresponding to known internal users or high-value personnel accounts. In one or more embodiments, the threat detection and response service may retrieve the structured data list from a configuration store or list management service and may incorporate the data from the structured data list into the evaluation logic (e.g., detection logic) applied by the message threat assessment module 110.

In some embodiments, the system 100 may further include a list management interface through which an administrator of the subscribing entity may define, update, or delete structured data lists. The list management interface may expose an API or a GUI through which structured data values may be specified. The MQL interpreter may dynamically retrieve or cache the structured data lists to support real-time rule evaluation without requiring manual rule redefinition. By enabling access to structured data lists from within the MQL, the system 100 may support context-aware threat detection logic that reflects policies or conditions specific to the subscribing entity.

### Historical Context

Additionally, or alternatively, the threat detection and response service implementing the message threat assessment module 110 or the like may automatically maintain one or more historical data stores that record prior message attributes and classification results specific to a subscribing entity. The historical data may include records indicating whether prior messages associated with particular senders, domains, subjects, or payload characteristics were previously classified as malicious, suspicious, spam, graymail, or benign. The historical data may further include timestamps of prior message detections, historical threat scores, or metadata associated with user actions taken in response to prior messages.

In some embodiments, the threat detection and response service may detect anomalous behavior by comparing attributes of a current electronic communication against previously observed behaviors associated with the same sender. For example, the threat detection and response service may determine that a sender typically transmits electronic communications that pass domain-based message authentication, reporting, and conformance (DMARC) checks, and may identify a deviation when a message from the same sender fails DMARC verification. As another example, the threat detection and response service may determine that a sender does not historically transmit electronic communications containing financial intent or payment requests and may flag a current message as suspicious when natural language understanding (NLU) analysis indicates the presence of financial transaction-related language. Such historical profiling may enhance detection of contextually abnormal messages that would otherwise appear benign in isolation.

In some embodiments, the threat detection and response service may detect anomalous behavior by comparing attributes of a current electronic communication against previously observed behaviors associated with the same sender. For example, the threat detection and response service may determine that a sender typically transmits electronic communications that pass domain-based message authentication, reporting, and conformance (DMARC) checks, and may identify a deviation when a message from the same sender fails DMARC verification. As another example, the threat detection and response service may determine that a sender does not historically transmit electronic communications containing financial intent or payment requests and may flag a current message as suspicious when natural language understanding (NLU) analysis indicates the presence of financial transaction-related language. Such historical profiling may enhance detection of contextually abnormal messages that would otherwise appear benign in isolation.

In one or more embodiments, the threat detection and response service may store the historical data in a structured data repository indexed by one or more message attributes. Accordingly, the system 100 may expose the historical data to the MQL interpreter or the message threat assessment module 110 as a queryable input during evaluation of threat detection instructions. A threat detection instruction defined in the MQL may reference the historical data to determine, for example, whether a newly received electronic communication was transmitted from a sender address not previously observed in historical message records, or whether prior communications from the same domain were previously identified as malicious. The system 100 may update the historical data in real time upon processing each new electronic communication, enabling dynamically evolving detection logic based on the behavior of prior message traffic within the organization.

### 1.3 Threat Mitigation Module

The threat mitigation module 118, sometimes referred to herein as the “message threat mitigation engine” may be operably configured to mitigate a security threat associated with the new electronic communication when the message threat assessment module 110 detects that the new electronic communication is malicious, spam, graymail, or suspicious.

The threat mitigation module 118 may function to mitigate, in real-time or near real-time, a security threat associated with the new electronic communication in response to the message threat assessment module 110 detecting that the new electronic communication is malicious or suspicious, as described in more detail herein.

In one embodiment, the system 100 may include a subsystem (not shown) configured to autonomously generate, refine, and validate threat detection instructions in response to detection gaps identified by the system 100 or feedback received from users or subscribers to the message threat detection and response service. The automated subsystem may be operably coupled to the threat detection and response service and may function as an intelligent artificial intelligence (AI) based agent (e.g., an autonomous AI agent or the like) that monitors for false negatives (FNs), false positives (FPs), and emerging threats not yet covered by existing detection logic.

The automated subsystem may include a proposal engine that receives triggering inputs from multiple sources, including: (i) internal detection engineers manually submitting FN or FP samples, (ii) users submitting samples via user interfaces, (iii) automated feedback mechanisms from the threat assessment pipeline, and (iv) system-initiated triggers derived from behavioral anomalies or public threat intelligence sources. Upon receipt of a trigger, the automated subsystem may propose a candidate detection instruction, e.g., a rule authored in a domain-specific message query language (MQL), tailored to the triggering sample or scenario.

The automated subsystem may then execute a validation and refinement loop, wherein the candidate detection instruction is automatically tested against a corpus of benign and known malicious message data. During each iteration, the automated subsystem may modify rule prompts, logical conditions, detection logic, and/or parameter thresholds to minimize false positives while maintaining high recall on malicious samples. The refinement loop may terminate upon reaching a success condition, e.g., zero or minimal FPs, or halt if the system determines the rule cannot meet efficacy constraints (e.g., compute efficacy constraints or the like) within a bounded number of retries (e.g., three retries, four retries, six retries, ten retries, twenty retries, etc.).

In one embodiment, the automated subsystem may support multiple modes of deployment including: (i) passive review workflows where generated rules (e.g., threat detection instructions or the like) are presented to security personnel for manual approval, (ii) semi-automated workflows where rules are proposed to users for organizational testing, and (iii) fully automated deployments governed by policy-based thresholds. Approved rules are then integrated into the threat detection corpus and propagated to appropriate detection layers (e.g., subscriber-specific or global).

Additionally, the automated subsystem may encode enrichment workflows that leverage backend services, such as machine learning-based logo detection, link screenshot classification, or OCR-based text analysis, to produce detection logic based on high-fidelity signal features. This enables automated rule generation not only from raw email data but also from embedded artifacts such as attachments, hyperlinks, or screenshots. The enrichment functions described herein may include optical character recognition, archive extraction, or macro inspection and, in turn, the integration of these enrichment functions within the syntax and semantics of the message query language provides many technical advantages. The ability to invoke enrichment operations as callable components from within threat detection instructions enables granular, user-defined logic that governs when and how enrichment is performed during message assessment.

Moreover, the enrichment functions described herein are provided as illustrative examples and do not represent an exhaustive enumeration of capabilities. Additional enrichment functions may include domain registration or WHOIS record analysis to assess sender legitimacy, topic modeling or natural language processing to identify the semantic themes of message content, geolocation inference based on IP metadata, or detection of impersonation risk using visual or phonetic similarity metrics. The enrichment framework may be modular and extensible, allowing new functions to be defined, registered, and invoked from within the message query language as callable components.

### 1.4 Rule Engine I Autonomous AI Agent

In one or more embodiments, the system 100 may further include a rule engine 120 (e.g., an autonomous AI agent or the like) configured to autonomously generate, assess, and iteratively refine threat detection instructions for identifying malicious electronic communications. The rule engine 120 may comprise, in one non-limiting example, an agentic detection engineering (ADE) system that is configured to operate with substantially the same investigative tools, reference knowledge, and analytical capabilities that may be available to a user accessing one or more portions of system 100, while being programmatically constrained to operate on a per-message basis. In such embodiments, the rule engine 120 may function as an autonomous detection engineering system configured to produce executable threat detection instructions for subsequent approval, validation, or deployment by the system 100.

In one or more embodiments, the rule engine 120 may include a rule generation subsystem configured to automatically produce candidate threat detection instructions based on observed detection gaps, structured electronic communication data, and/or associated execution metadata. The rule generation subsystem may comprise one or more computational components configured to perform pattern synthesis, logical inference, and constraint-aware code generation. In one or more embodiments, the one or more computational components of the rule generation subsystem may at least include a large language model executed by one or more processors. The large language model may be configured to receive structured representations of electronic communications, detection outcomes, and contextual signals, and to generate intermediate detection logic representations responsive to an identified detection gap.

In one or more embodiments, the rule engine 120 may be implemented as a model-agnostic architecture that is decoupled from any specific large language model weights. Instead, the rule engine 120 may be structured around a curated detection knowledge base that includes detection engineering best practices, existing detection instruction patterns, known attacker behaviors, tactics techniques and procedures, and comprehensive documentation associated with a target detection programming language. This architectural separation may allow the rule engine 120 to operate with different underlying foundation models without requiring retraining or fine-tuning of model parameters.

In one or more embodiments, the rule engine 120 may further include access to a plurality of analysis and validation tools that are programmatically invocable during threat detection instruction generation. Such tools may include dynamic file analysis tools for evaluating electronic communication attachments, natural language understanding components for analyzing electronic communication content, computer vision components for extracting features from embedded images, sender profiling components for assessing sender reputation and prevalence, and threat hunting tools for executing generated threat detection instructions against historical electronic communication data. In such embodiments, the rule engine 120 may integrate outputs from these tools into intermediate representations that guide detection instruction generation and refinement.

In one or more embodiments, the rule engine 120 may include a multi-agent execution framework in which the rule engine 120 may delegate specialized analytical subtasks to one or more subagents. Such subagents may be configured to perform focused operations including detection rule critique, hunt result analysis, robustness assessment, and/or false-positive characterization. In such embodiments, the rule engine 120 may aggregate feedback produced by the one or more subagents to inform subsequent regeneration or adjustment of candidate threat detection instructions. This subagent delegation architecture may enable concurrent or staged analysis of different aspects of a candidate threat detection instruction while maintaining centralized control over instruction synthesis.

In one or more embodiments, the rule engine 120 may be configured to initiate operation in response to receiving an electronic communication (e.g., a representation of an electronic message, a data model associated with the electronic message, or message data associated with the electronic message). Upon receipt of such an electronic communication, the rule engine 120 may perform a structured investigative process that includes analyzing message headers, message body content, embedded links, attached files, and sender characteristics. The rule engine 120 may identify candidate attack vectors, indicators of compromise, and behavioral patterns associated with the electronic communication to determine whether the electronic communication is malicious or potentially malicious. The rule engine 120 may be configured to investigate characteristics including, but not limiting to, content obfuscation techniques, malicious attachment properties, suspicious sender attributes, or anomalous delivery characteristics.

In one or more embodiments, following initial investigation, the rule engine 120 may search a repository of existing threat detection instructions to identify detection logic that targets similar threats or employs related indicators. This may enable the rule engine 120 to identify existing coverage, avoid redundant detection logic, and detect potential coverage gaps. Accordingly, in some embodiments, the rule engine 120 may generate one or more candidate threat detection instructions for the electronic communication that encode detection logic targeting multiple attack vectors simultaneously, such as combining sender-based indicators with content analysis and attachment inspection.

In one or more embodiments, the rule engine 120 may be configured to iteratively refine generated threat detection instructions using an automated closed-loop feedback architecture. In such embodiments, the rule engine 120 may include a rule evaluation subsystem at least configured to validate syntactic correctness of generated detection logic, execute the detection logic against one or more electronic communication samples, and initiate historical threat hunting against previously observed electronic communication data. Outputs of these evaluations may include, without limitation, detection accuracy indicators, false-positive indicators, and robustness indicators. The rule engine 120 may use these outputs as corrective feedback signals to modify detection logic, adjust conditions, incorporate additional behavioral indicators, and/or reduce brittleness until a convergence condition is reached.

In one or more embodiments, the rule engine 120 may be specifically configured to mitigate long-context degradation associated with multi-step agentic workflows by integrating evaluation feedback directly into generation cycles. Error messages, validation failures, and evaluation metrics may be treated as structured guidance signals that steer subsequent detection instruction generation. This feedback-driven convergence architecture may enable the rule engine 120 to complete complex detection engineering tasks that would otherwise fail due to loss of context or objective misalignment over extended reasoning horizons.

In one or more embodiments, the rule engine 120 may output a finalized threat detection instruction together with associated evaluation results for downstream approval, deployment, or rejection. In such embodiments, the rule engine 120 may function to surface both the executable detection logic and corresponding hunt performance outputs for user review. The architecture of the rule engine 120 may thereby support systematic measurement, validation, and iterative improvement of autonomously generated threat detection instructions within the system 100.

2.0 Method for Autonomous Real-Time Generation and Real-Time Assessment of Threat Detection Instructions for Mitigating Malicious Electronic Communications that Evaded Detection

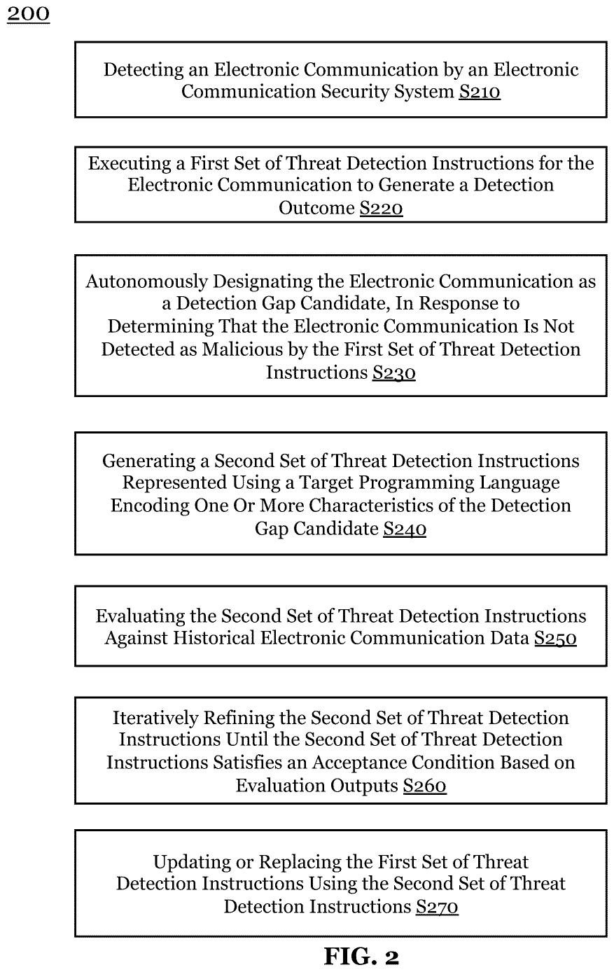

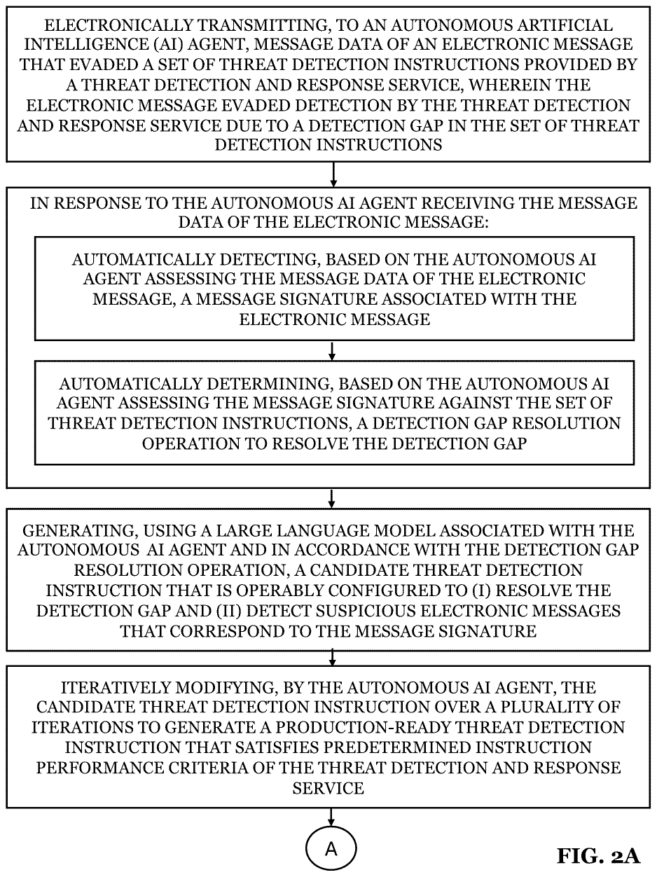

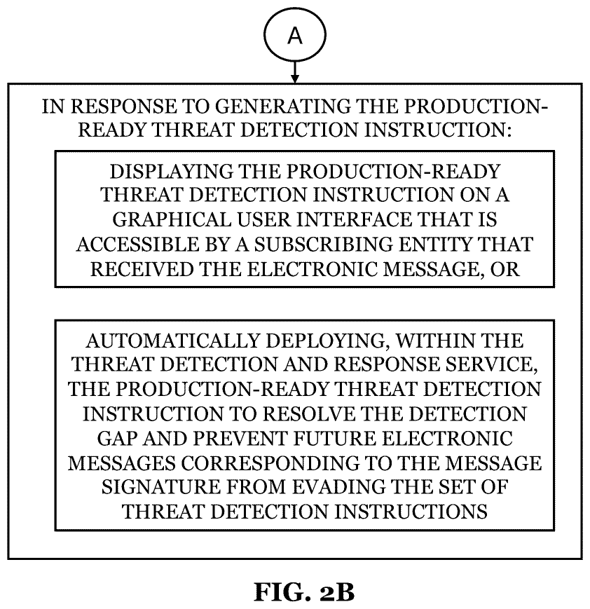

As shown in FIG. 2, a method 200 for real-time generation and assessment of threat detection instructions for mitigating malicious electronic communications may include detecting an electronic communication by an electronic communication security system S210; executing a first set of threat detection instructions for the electronic communication to generate a detection outcome S220; designating the electronic communication as a detection gap candidate in response to determining that the electronic communication is not detected as malicious by the first set of threat detection instructions S230; generating a second set of threat detection instructions represented using a target programming language encoding one or more characteristics of the detection gap candidate S240; evaluating the second set of threat detection instructions against historical electronic communication data S250; iteratively refining the second set of threat detection instructions until the second set of threat detection instructions satisfies an acceptance condition based on evaluation outputs S260; and updating or replacing the first set of threat detection instructions using the second set of threat detection instructions S270.

### 2.1 Detecting an Electronic Communication

S210, which includes detecting an electronic communication by an electronic communication security system, e.g., system 100, may function to detect, in real time or near real time, an electronic communication transmitted or delivered to one or more message storage repositories monitored by the system 100. In one or more embodiments, the system 100 may be implemented as a message threat detection and response service 100, as shown in FIG. 1. An electronic communication, as generally referred to herein, may be a digital message transmitted over a computer network to one or more target electronic addresses, endpoints, or destinations, including electronic mail messages and other electronically transmitted message formats supported by a messaging service provider.

In one or more embodiments, the system 100 may be accessible via a network-based or web-based deployment and may operate as part of a cloud-based messaging security service, an enterprise security gateway, or a distributed electronic communication detection platform. In such embodiments, the system 100 may be implemented by a network of distributed computing systems operably configured to receive, process, and analyze electronic communications associated with one or more subscribing entities.

In one or more embodiments, the system 100 implementing method 200 may receive a service enrollment request from a subscribing entity that requests the system 100 to monitor one or more distinct message storage repositories associated with the subscribing entity for electronic communications. The one or more message storage repositories may include individual user mailboxes, shared mailboxes, distribution group inboxes, journaling mailboxes, or any other suitable message storage locations. In response to receiving the service enrollment request, S210 may function to initiate automated monitoring of the one or more message storage repositories to detect, in real time or near real time, when electronic communications are transmitted to or delivered into the monitored repositories.

In some embodiments, each distinct message storage repository monitored by the system 100 may correspond to a respective user account associated with the subscribing entity. For example, a subscribing entity may request monitoring of a plurality of individual user inboxes, each accessible by a corresponding end user, such that S210 may function to detect electronic communications delivered to each of the monitored user accounts as the communications are received.

In one or more embodiments, after receiving the service enrollment request, S210 may function to automatically establish programmatic access to the one or more message storage repositories designated by the subscribing entity. In such embodiments, the programmatic access may be established by the message detection and transformation module 102, as shown in FIG. 1. The established programmatic access may enable the message monitoring module 104 of the message detection and transformation module 102 to detect message delivery events associated with electronic communications transmitted to the monitored repositories. Such programmatic access may be established using an application programming interface provided by a messaging service provider, an internet message access protocol (IMAP), or any other suitable programmatic communication mechanism.

In some embodiments, S210 may function in a post-delivery configuration in which electronic communications are detected after being delivered to a message storage repository. Additionally, or alternatively, in some embodiments, S210 may function in an inline configuration, in which electronic communications are detected during message transmission prior to acceptance by a recipient mailbox, for example through integration with message routing rules, mail flow policies, or transport-layer controls enforced by the messaging service provider.

In one or more embodiments, the system 100 may interface with a plurality of distinct electronic communication processing stages. The plurality of electronic communication processing stages may include, without limitation, an electronic communication ingestion stage autonomously implemented by the message detection and transformation module 102, an electronic communication normalization stage, a threat detection execution stage autonomously implemented by the message threat assessment module 110, and a threat mitigation or disposition stage autonomously implemented by the message threat mitigation module 118. In such embodiments, S210 may function as an initial electronic communication ingestion operation that introduces detected electronic communications into the system 100 for subsequent processing by downstream stages.

In one or more embodiments, S210 may function to detect and intake electronic communications that include, but are not limited to, electronic mail messages, message headers and routing metadata, message body content, embedded uniform resource locators or redirection chains, attachment payloads, attachment metadata, and externally sourced electronic communications submitted for analysis, including public write-ups or blog content.

In one or more embodiments, electronic communications detected by S210 may be passed from the message monitoring module 104 to a message retrieval module 106 and subsequently to a structured data object generator 108 of the message detection and transformation module 102, as shown in FIG. 1, for downstream transformation into structured electronic communication data objects. The structured electronic communication data objects may include normalized header fields, extracted message features, derived behavioral attributes, and contextual metadata associated with message delivery patterns or sender behavior.

At least one technical benefit of detecting electronic communications by the system 100 in real time or near real time may include enabling subsequent automated processing of newly detected electronic communications by downstream components of the system 100, including components configured to normalize electronic communications, execute threat detection instructions, support adaptive improvement of threat detection logic, and coordinate electronic communication disposition actions.

### 2.2 Executing a First Set of Threat Detection Instructions for the Electronic Communication to Generate a Detection Outcome

S220, which includes executing a first set of threat detection instructions against the electronic communication to generate a detection outcome, may function to enable the system 100 to autonomously evaluate a detected electronic communication using a currently active or incumbent collection of threat detection instructions deployed by the system 100. In one or more embodiments, the system 100 may maintain the first set of threat detection instructions including a pre-existing collection of executable detection logic that is actively deployed within a production detection environment of the system 100. The first set of threat detection instructions may represent detection logic that was previously authored, validated, approved, and deployed for classifying electronic communications processed by the system 100.

In one or more embodiments, the first set of threat detection instructions may be encoded in a target programming language configured for electronic communication threat detection execution, such as a message query language (MQL) or rule execution language. Encoding of threat detection instructions is described in U.S. patent application Ser. No. 19/261,636, entitled “SYSTEMS AND METHODS FOR REAL-TIME DETECTION AND MITIGATION OF MALICIOUS ELECTRONIC COMMUNICATIONS,” which is incorporated herein by reference in its entirety. In such embodiments, the first set of threat detection instructions may be interpreted and executed by one or more execution components of the system 100, including the message threat mitigation module 118, to evaluate structured electronic communication data objects corresponding to detected electronic communications.

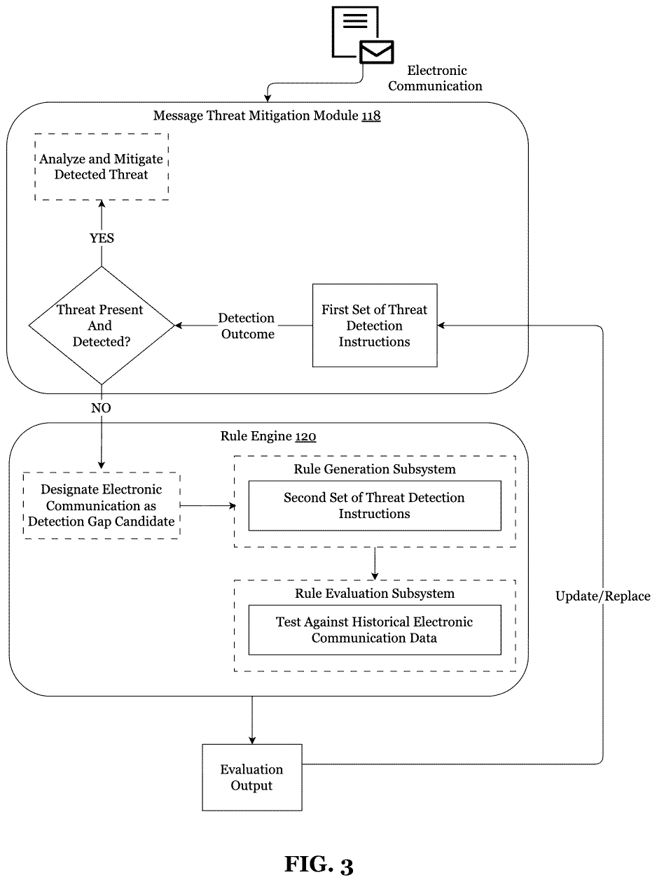

In one or more embodiments, S220 may include providing, by the system 100, an electronic communication as input to the message threat mitigation module 118, as shown in one non-limiting example in FIG. 3. In such embodiments, the message threat mitigation module 118 may be operably configured to autonomously execute the first set of threat detection instructions against message data derived from the electronic communication and to generate a detection outcome as an output, as further shown in FIG. 3. In one or more embodiments, the first set of threat detection instructions executed by the message threat mitigation module 118 may correspond to the currently deployed or incumbent set of threat detection instructions maintained by the system 100.

In one or more embodiments, the first set of threat detection instructions may include a plurality of distinct threat detection instruction types, each configured to evaluate different aspects of an electronic communication. The plurality of threat detection instruction types may include, but are not limited to, sender authentication and sender impersonation detection rules, hyperlink analysis and redirection behavior detection rules, attachment analysis detection rules, message structure or formatting anomaly detection rules, and behavioral or contextual detection rules that evaluate message attributes relative to historical or organizational context.

In one or more embodiments, each threat detection instruction within the first set of threat detection instructions may be associated with a predefined set of detection conditions (e.g., detection logic) that may specify logical expressions, comparison operators, thresholds, and/or evaluation criteria to be applied to attributes of a structured electronic communication data object. Additionally, each threat detection instruction of the first set of threat detection instructions may be associated with one or more label types that represent possible classification outcomes produced by execution of the threat detection instruction. The one or more label types may include, for example, a malicious message classification label, a non-malicious message classification label, a suspicious message classification label, a spam message classification label, a graymail message classification label, or an indeterminate message classification label.

In one or more embodiments, each threat detection instruction of the first set of threat detection instructions may further be associated with historical performance metadata that describes prior execution characteristics of the threat detection instruction. The historical performance metadata may include, for example, prior classification outcomes, historical false positive or false negative indicators, execution frequency metrics, execution latency metrics, or efficacy measurements derived from prior executions of the threat detection instruction against historical electronic communications, as described in U.S. patent application Ser. No. 19/261,636, entitled “SYSTEMS AND METHODS FOR REAL-TIME DETECTION AND MITIGATION OF MALICIOUS ELECTRONIC COMMUNICATIONS,” which is herein incorporated by reference in its entirety.

In one or more embodiments, S220 may include executing the first set of threat detection instructions against one or more structured electronic communication data objects generated for the detected electronic communication. As briefly described with respect to S210, the structured electronic communication data objects may include normalized header fields, extracted message features, derived behavioral attributes, and contextual metadata associated with message delivery patterns or sender behavior. During execution, the message threat mitigation module 118 may sequentially or concurrently evaluate the structured electronic communication data objects against the detection conditions defined by the first set of threat detection instructions.

In one or more embodiments, execution of the first set of threat detection instructions may produce a detection outcome (e.g., a message threat class or the like) for the electronic communication. The detection outcome may include a classification of the electronic communication as malicious, a classification of the electronic communication as non-malicious, or a classification of the electronic communication as indeterminate or suspicious. The detection outcome may represent an aggregate result derived from execution of one or more threat detection instructions within the first set of threat detection instructions, and the detection outcome may be output by the message threat mitigation module 118, as shown in FIG. 3.

In one or more embodiments, S220 may further include generating and storing execution logs associated with execution of the first set of threat detection instructions. The execution logs may include information identifying which threat detection instructions were evaluated, which detection conditions were satisfied or not satisfied, execution traces generated during evaluation, and/or intermediate evaluation results produced prior to generation of the detection outcome. The execution logs may be stored in one or more data repositories accessible to downstream components of the system 100.

In one or more embodiments, the detection outcome and the associated execution logs generated at S220 may be persisted and made available to downstream processing stages of the system 100. The detection outcome and execution logs may later be referenced by subsequent steps of method 200 to determine whether the electronic communication represents a potential detection gap relative to the first set of threat detection instructions, to support adaptive refinement of detection logic, or to inform rule generation, validation, or replacement operations performed by other system components.

At least one technical benefit of executing a first set of threat detection instructions by the system 100 may include enabling a deterministic and programmatic generation of a detection outcome for an electronic communication based on a currently active set of executable detection logic. By executing an incumbent set of threat detection instructions via a message threat mitigation module against structured electronic communication data objects, the system enables consistent and scalable application of threat detection logic across heterogeneous electronic communication sources while producing machine-readable detection outcomes and execution metadata that may be referenced by downstream system components to support detection gap identification, adaptive refinement of threat detection instructions, and coordinated electronic communication disposition actions.

2.3 Autonomously Designating the Electronic Communication as a Detection Gap Candidate in Response to Determining that the Electronic Communication is not Detected as Malicious by the First Set of Threat Detection Instructions

S230, which includes autonomously designating the electronic communication as a detection gap candidate in response to determining that the electronic communication is not detected as malicious by the first set of threat detection instructions, may function to enable system 100 to autonomously identify electronic communications for which detection coverage is incomplete relative to the first set of threat detection instructions, i.e., incumbent or currently deployed set of threat detection instructions.

In one or more embodiments, S230 may include determining, using one or more components of the system 100, that the electronic communication is associated with a potential cybersecurity threat, despite a detection outcome generated at S220 indicating, in one non-limiting example, that the electronic communication is not detected as malicious by the first set of threat detection instructions. In such embodiments, the determination that the electronic communication is associated with a potential cybersecurity threat may be based on correlation of the detection outcome and execution logs generated during execution of the first set of threat detection instructions with one or more external signals. In one or more embodiments, the external signals may include one or more external post-classification signals indicating a possible misclassification of the electronic communication. In an embodiment, such an external post-classification signal may originate from a subscribing entity, a security analyst, an automated post-delivery analysis component, or an external threat intelligence source.

In other embodiments, a determination that the electronic communication is associated with a potential cybersecurity threat may be based on analysis of one or more threat intelligence feeds that identify malicious sender infrastructure, phishing campaigns, malware indicators, or attack techniques. In some embodiments, the threat intelligence feeds may include automatically ingested public threat disclosures, malware repository verdict updates, or submissions to external reputation systems. When such threat intelligence feeds indicate that an electronic communication previously classified as benign is malicious, the system 100 may treat the electronic communication as a false-negative candidate and trigger designation of the electronic communication as the detection gap candidate. Additionally, or alternatively, one or more additional information sources such as incident response data indicating that the electronic communication was involved in a confirmed security incident, user account compromise, credential theft event, and/or unauthorized action within a protected computing environment may trigger designation of the electronic communication as a detection gap candidate.

In one or more embodiments, the determination that the electronic communication is associated with a potential cybersecurity threat may further be based on manual or automated labeling outcomes generated after initial delivery of the electronic communication. For example, a subscribing entity device, security analyst, and/or automated analysis system may label the electronic communication as malicious based on retrospective review, sandbox execution, or behavioral observation. In such embodiments, the manual labeling outcome or automated analysis result may constitute the triggering event that initializes the workflow associated with S230. For instance, a subscriber device may explicitly report a delivered electronic communication as malicious via a graphical user interface control (e.g., a “Report Phish” interface element). In another example, a security analyst may retroactively classify the electronic communication as malicious within a review console, thereby signaling that the first set of threat detection instructions failed to detect the threat at time of delivery. Additionally, or alternatively, the determination may be based on retrospective analysis of detection coverage performed by the system 100 across historical electronic communication data.

As shown in the example of FIG. 3, the detection outcome generated in S220 may be analyzed to determine whether a potential cybersecurity threat associated with the electronic communication was present but was unidentified through execution of the first set of threat detection instructions. In a scenario, wherein the threat is present and identified, the message threat mitigation module may analyze and mitigate the threat autonomously, as described in U.S. patent application Ser. No. 19/261,636, entitled “SYSTEMS AND METHODS FOR REAL-TIME DETECTION AND MITIGATION OF MALICIOUS ELECTRONIC COMMUNICATIONS,” which is herein incorporated by reference in its entirety.

In one or more embodiments, wherein the electronic communication is associated with a potential cybersecurity threat and the detection outcome generated at S220 indicates that the electronic communication is “non-malicious” or “benign,” a rule engine 120 of the system 100 may autonomously designate the electronic communication as a detection gap candidate, as generally shown in FIG. 3. In one embodiment, the designation of the electronic communication as a detection gap candidate may represent an indication that the electronic communication requires further evaluation and/or that the first set of threat detection instructions are required to be modified or replaced.

In one or more embodiments, the electronic communication may be designated as a detection gap candidate based on one or more supplementary conditions. The supplementary conditions may include, but are not limited to, post-delivery identification of a malicious electronic communication, subscriber-reported malicious electronic communications, analyst-reviewed electronic communications, internally generated false-negative indicators produced by automated analysis components, and/or externally sourced threat intelligence describing emerging attack campaigns or newly disclosed exploitation techniques.

In one or more embodiments, designating the electronic communication as a detection gap candidate may include generating a structured, machine-readable data object generated by the rule engine 120, e.g., to encode an identified deficiency in detection coverage of the first set of threat detection instructions with respect to the electronic communication. The data object may include a plurality of structured fields stored in memory and populated by one or more processors, including an electronic communication identifier or normalized reference to the electronic communication, identifiers of one or more threat detection instructions executed within the first set of threat detection instructions, identifiers of detection conditions evaluated and not satisfied during execution, a recorded detection outcome associated with the first set of threat detection instructions, and a source indicator identifying a scenario in response to which the detection gap was identified. The data object may further include execution metadata linking the data object to corresponding execution logs, timestamps indicating when the detection gap condition was generated, and contextual metadata describing message attributes or behavioral characteristics implicated in the detection failure.

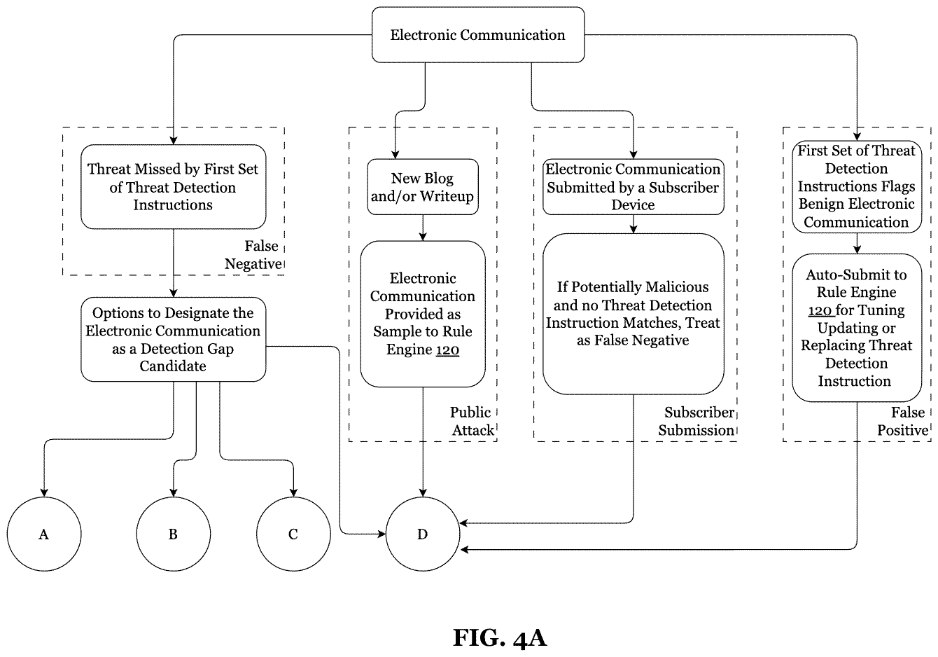

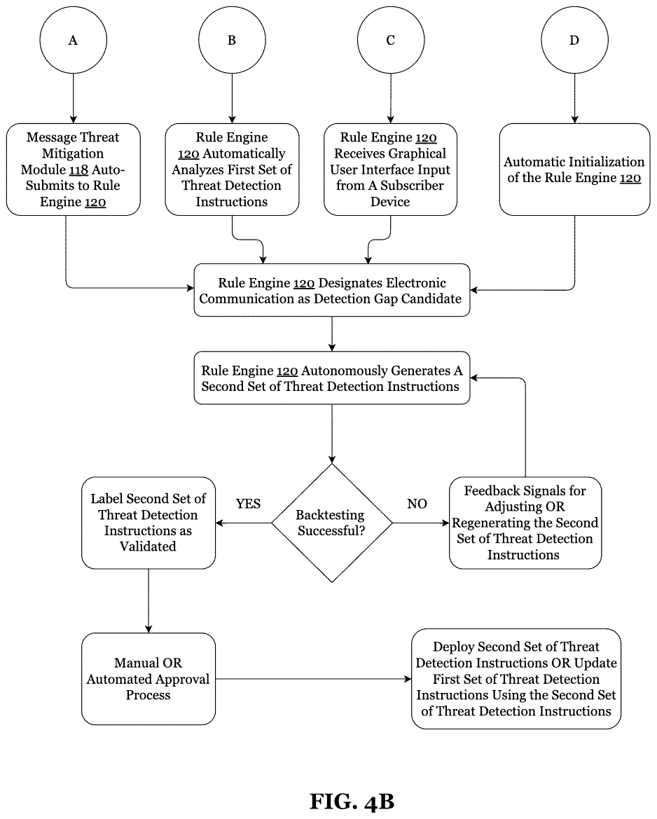

In one or more embodiments, as shown in FIG. 3, the rule engine 120 may be configured to autonomously designate the electronic communication as a detection gap candidate. Further, as shown in non-limiting examples in FIGS. 4A and 4B, the electronic communication may be designated as the detection gap candidate in response to multiple distinct detection gap conditions that collectively illustrate how missed detections, external intelligence, and/or user or analyst interactions converge to initialize the rule engine 120 for detection gap analysis within the system 100. As shown in FIG. 4A, the designation of an electronic communication as a detection gap candidate may be initiated in response to identification of one of a false-negative condition, a public attack condition, a subscriber submission condition, or a false positive condition.

In one embodiment, in the false-positive condition, the electronic communication may be evaluated by the first set of threat detection instructions and not detected as malicious. In this embodiment, the electronic communication may be processed by the message threat mitigation module 118 and first evaluated using the first set of threat detection instructions, as generally shown in FIG. 3. In one implementation, the detection outcome generated from execution of the first set of threat detection instructions may indicate that the electronic communication is “benign” or “non-malicious”. As shown in FIG. 4A, despite this detection outcome, the electronic communication may be associated with a potential cybersecurity threat, thereby constituting a false-negative condition relative to the first set of threat detection instructions.

As shown in FIG. 4A, in response to identifying the false-negative condition, the system 100 may utilize one or more options to designate the electronic communication as a detection gap candidate. For instance, as shown in FIG. 4B, in a first option, the message threat mitigation module 118 may automatically submit the electronic communication to the rule engine 120 (e.g., autonomous AI agent or the like). This is further depicted in the non-limiting example shown in FIG. 3. In one embodiment, in the false-negative condition, responsive to the automatic submission of the electronic communication to the rule engine 120, the rule engine 120 may designate the electronic communication as a detection gap candidate, as generally shown in FIG. 4B. In one or more embodiments, the rule engine 120 may analyze execution data associated with the first set of threat detection instructions, including which threat detection instructions were executed and which detection conditions were evaluated but not satisfied. Based on this analysis, the rule engine 120 may designate the electronic communication as the detection gap candidate, representing that the electronic communication was not adequately detected by the first set of threat detection instructions and requires further detection engineering action.

As further shown in FIGS. 4A and 4B, in a second option, in response to identifying the false-negative condition, the system 100 may invoke the rule engine 120 to automatically analyze the first set of threat detection instructions without requiring automatic submission of the electronic communication by the message threat mitigation module 118. In the second option, the rule engine 120 may independently and autonomously analyze execution results associated with the first set of threat detection instructions that were applied to the electronic communication, including identification of which threat detection instructions were executed, which detection conditions were evaluated, and which detection conditions were not satisfied during evaluation of the electronic communication. In one embodiment, based on the automated analysis performed by the rule engine 120 with respect to the first set of threat detection instructions and the false-negative condition, the rule engine 120 may designate the electronic communication as a detection gap candidate, as shown in FIG. 4B. The designation may represent that the electronic communication exposed a deficiency in detection coverage of the first set of threat detection instructions and is eligible for further detection engineering, rule refinement, or instruction replacement within the system 100.

As further shown in FIG. 4A, in a third option, in response to identifying the false-negative condition, the system 100 may invoke the rule engine 120 based on graphical user interface input received from a subscriber device. In the third option, a subscriber device may interact with a user interface provided by the system 100 to submit the electronic communication, e.g., that was previously processed by the first set of threat detection instructions and classified as non-malicious or benign, but is believed to be associated with a potential cybersecurity threat.

In one or more embodiments, the graphical user interface input may include an explicit indication from the subscriber device identifying the electronic communication as suspicious, malicious, or incorrectly classified, thereby signaling the false-negative condition with respect to the first set of threat detection instructions. Responsive to receiving the graphical user interface input from the subscriber device, the rule engine 120 may receive the electronic communication and associated contextual information and may analyze execution results corresponding to the first set of threat detection instructions that were applied to the electronic communication.

In one embodiment, the analysis performed by the rule engine 120 may include identifying which threat detection instructions within the first set of threat detection instructions were executed, which detection conditions were evaluated during processing of the electronic communication, and which detection conditions were not satisfied despite the presence of the threat. Based on the analysis of the execution results and the false-negative condition indicated through the subscriber-provided interface input, the rule engine 120 may designate the electronic communication as a detection gap candidate, as generally shown in FIG. 4B.

In one or more embodiments, the designation of the electronic communication as the detection gap candidate in the third option may indicate that the electronic communication exposed an inadequacy in the detection coverage of the first set of threat detection instructions and may require further detection engineering actions, including refinement, updating, or replacement of one or more threat detection instructions within the system 100.

As further illustrated in FIG. 4A, in one or more alternate embodiments, the electronic communication may also be designated as a detection gap candidate responsive to multiple conditions distinct to the false-negative condition. In one alternate embodiment, as shown in FIG. 4A, a new blog, write-up, and/or publicly available resource describing a public attack may be identified. In one or more non-limiting examples, a public attack may be described in a newly published blog, write-up, or other publicly available resource generated by a security researcher, cybersecurity vendor, incident response team, or industry organization. Such a publicly available resource may describe a phishing campaign, business email compromise campaign, malware delivery operation, or social engineering attack that is propagated, at least in part, through electronic communications. The write-up may include example electronic communications, message subject lines, sender identities or domains, message body content, embedded uniform resource locators, attachment types, screenshots, or behavioral observations associated with the attack. In some embodiments, the public attack write-up may further describe a confirmed security incident, breach post-mortem, or vulnerability exploitation scenario in which an electronic communication served as an initial access vector. Electronic communications described in the public attack write-up may correspond to electronic communications that were previously processed by the system 100 and classified as non-malicious by the first set of threat detection instructions. As such, the public attack write-up may be used to identify a false-negative condition and to support designation of the electronic communication as a detection gap candidate, as described herein.

In one embodiment, an electronic communication associated with the public attack may be provided as a sample to the rule engine 120. Upon receiving the sample, the rule engine 120 may be automatically initialized and designate the electronic communication as a detection gap candidate, as shown generally in FIG. 4B.

In another alternate embodiment, FIG. 4A illustrates another condition for designation of the electronic communication as a detection gap candidate. In this embodiment, a potentially malicious electronic communication may be submitted by a subscriber device, e.g., as a graphical user interface input. In one or more embodiments, when the submitted electronic communication is potentially malicious and no existing threat detection instructions are available in the system 100 to process the potentially malicious electronic communication, the electronic communication may be treated as a false negative. The subscriber submission condition may automatically initialize the rule engine 120. The rule engine 120 may then designate the electronic communication as a detection gap candidate based on the subscriber submission.

In a further alternate embodiment, FIG. 4A illustrates a false-positive condition in which the first set of threat detection instructions may flag a benign electronic communication as malicious. In this embodiment, the benign electronic communication may be automatically submitted to the rule engine 120 (e.g., autonomous AI agent or the like) for tuning, updating or replacing the first set of threat detection instructions. In response to the false-positive condition, the rule engine 120 may be automatically initialized and designate the electronic communication as a detection gap candidate, as generally shown in FIG. 4B.

As further illustrated in FIG. 4B, regardless of whether the detection gap condition includes, a public attack condition, a subscriber submission condition, or a false-positive condition, the rule engine 120 may be automatically initialized and designate the electronic communication as a detection gap candidate. In one or more embodiments, the automatic initialization of the rule engine 120 may be performed by one or more processors of the system 100 in response to detection of a qualifying condition. In such embodiments, the system 100 may generate a machine-readable invocation request that includes a reference to the electronic communication, identifiers of the first set of threat detection instructions applied to the electronic communication, and/or execution metadata associated with evaluation of the electronic communication. The invocation request may be transmitted to the rule engine 120 via an internal application programming interface (API) or message queue, causing the rule engine 120 to load relevant execution logs, detection outcomes, and message attributes into working memory. Upon initialization, the rule engine 120 may transition into an analysis state configured to evaluate detection coverage of the first set of threat detection instructions and to determine whether designation of the electronic communication as a detection gap candidate is warranted.

In one or more embodiments, designating the electronic communication as the detection gap candidate may include storing the electronic communication in a detection gap repository maintained by the system 100. Additionally, or alternatively, designating the detection gap candidate may include associating the electronic communication with metadata describing the detection failure, tagging the electronic communication with one or more threat context indicators, and linking the electronic communication to execution logs generated during execution of the first set of threat detection instructions.

In one or more embodiments, the detection gap candidate designated at S230 may comprise a single electronic communication. Additionally, or alternatively, the detection gap candidate may comprise a plurality of related electronic communications that share common attributes, behaviors, or threat indicators. In further embodiments, the detection gap candidate may comprise an abstracted representation derived from multiple similar electronic communications, where the abstracted representation captures common characteristics responsible for the detection gap across the plurality of electronic communications.

In one or more embodiments, the rule engine 120 may associate the detection gap candidate with contextual information to support downstream detection engineering operations. The contextual information may include identification of the threat detection instructions executed within the first set of threat detection instructions, identification of detection conditions that were evaluated and not satisfied, and message attributes, behavioral characteristics, or contextual signals implicated in the detection failure.

In one or more embodiments, designation of the detection gap candidate at S230 may function as a trigger condition for initiating an autonomous detection engineering workflow. The autonomous detection engineering workflow may be initiated automatically based on system policy, initiated in response to subscriber action, or initiated in response to analyst review. In such embodiments, the detection gap candidate may serve as a primary input to downstream system components configured to generate, evaluate, and refine a second set of threat detection instructions.

In one or more embodiments, the detection gap candidate designated at S230 may be persisted and made accessible to downstream system components, including a rule generation subsystem or rule engine, configured to automatically generate, validate, iteratively refine, and deploy a second set of threat detection instructions that address the detection gap represented by the detection gap candidate.

At least one technical benefit of designating the electronic communication as a detection gap candidate at S230 may include reducing the latency between identification of a missed detection condition and initiation of corrective detection engineering actions. By autonomously initializing the rule engine 120 based on qualifying detection gap conditions and providing the rule engine 120 with direct access to structured execution metadata, the system avoids delayed or manual escalation paths and enables near real-time progression from detection failure identification to threat detection coverage improvement. This technical effect improves the responsiveness of the system 100 to emerging threats and detection blind spots.

2.4 Generating a Second Set of Threat Detection Instructions Encoded with One Or More Characteristics of the Detection Gap Candidate

S240, which includes generating a second set of threat detection instructions encoded with one or more characteristics of the detection gap candidate, may function to enable the system 100 to autonomously generate executable detection logic that addresses a detection gap represented by the detection gap candidate designated at S230. As shown generally in FIG. 3, the electronic communication designated as a detection gap candidate at S230 may be accessed by a rule generation subsystem included within the rule engine 120. The rule generation subsystem may be configured to translate characteristics of the detection gap candidate into a second set of threat detection instructions encoded in a target programming language.

In one or more embodiments, the detection gap candidate may include, as briefly described above, a structured data representation of one or more electronic communications, execution metadata associated with execution of the first set of threat detection instructions, identifiers of detection conditions that were evaluated and not satisfied, and/or contextual information describing message attributes, behavioral characteristics, or threat indicators implicated in the detection gap.

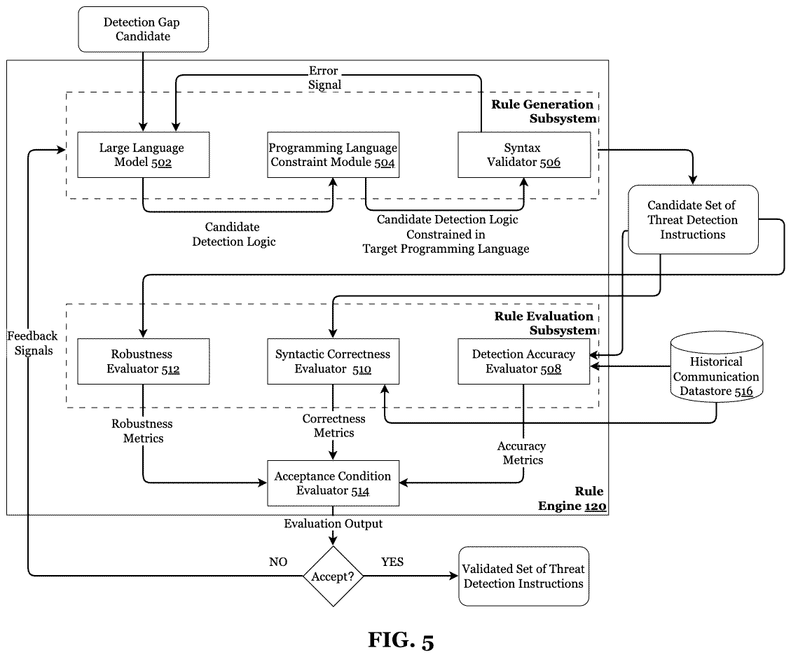

As shown in a non-limiting example of FIG. 5, the rule generation subsystem may comprise a plurality of communicatively coupled system components at least including a large language model 502, a programming language constraint module 504, and a syntax validator 506, each of which may be implemented by one or more processors executing computer-readable instructions stored in memory. In one embodiment, the detection gap candidate may be provided as an input to a large language model 502 of the rule generation subsystem. In one or more embodiments, the large language model 502 may be implemented as a transformer-based language model executed by one or more processors and configured to process structured and semi-structured representations of electronic communications, detection metadata, and detection outcomes. The large language model 502 may receive the detection gap candidate together with contextual inputs derived from execution logs, message attributes, and detection outcomes to generate candidate detection logic that is responsive to the identified detection gap.

In one or more embodiments, prior to generating candidate detection logic, the rule generation subsystem may execute a research and analysis programming pipeline in which the rule engine 120 may search an existing corpus of deployed threat detection instructions to identify threat detection instructions targeting similar threats or employing comparable indicators. In such embodiments, the rule generation subsystem may analyze existing threat detection instructions encoded in the target programming language to determine how similar threat characteristics have been previously detected, which indicators have been leveraged, and which detection patterns are already covered. This research and analysis programming pipeline may enable the system to avoid redundant threat detection instruction generation and to identify potential coverage gaps relative to existing detection logic.

In one or more embodiments, the research and analysis programming pipeline may include an investigation phase in which the rule engine 120 may autonomously analyze the detection gap candidate using one or more analysis tools executed by the system 100. In such embodiments, the rule engine 120 may utilize the large language model 502 as a reasoning component configured to select investigative operations and identify attributes of the detection gap candidate for examination. The rule engine 120 may invoke one or more analysis tools to determine characteristics of the detection gap candidate and to further determine indicators of compromise, tactics, techniques, or procedures that may be present within the electronic communication or related electronic communications.

In one embodiment, the rule engine 120 may invoke a message query language (MQL) analysis tool configured to execute MQL subqueries against one or more electronic communication data repositories storing historical electronic communications. Using this MQL tool, the rule engine 120 may retrieve electronic communications containing candidate indicators associated with the detection gap candidate, including, but not limited to, message attributes, attachment properties, hyperlink attributes, sender identifiers, and enrichment outputs derived from structured electronic communication data objects.

Additionally, or alternatively, the rule engine 120 may invoke a structured message attribute inspection tool configured to retrieve and analyze attributes stored within structured electronic communication data objects. Using the structured message attribute inspection tool, the rule engine 120 may extract message attributes such as sender domains, hyperlink domains, attachment file types, authentication outcomes, embedded script indicators, and recipient identifiers associated with the detection gap candidate.

In one or more embodiments, the rule engine 120 may further invoke a detection rule corpus search tool configured to analyze a corpus of existing threat detection instructions encoded in the target programming language. Using the detection rule corpus search tool, the rule engine 120 may determine whether existing threat detection instructions reference the same or similar indicators identified within the detection gap candidate and may detect one or more threat detection instructions that may trigger or fail to trigger when evaluated against electronic communications containing those indicators.

In such embodiments, the rule engine 120 may evaluate results returned from the analysis tools to determine indicators that may be consistently present across related electronic communications and indicators that may fail to trigger existing threat detection instructions. This investigation phase may enable the rule engine 120 to identify deficiencies in detection coverage of the first set of threat detection instructions relative to the existing threat detection instructions and to determine detection patterns that may be undetected prior to generating new threat detection instructions.

In one or more embodiments, following the research and analysis programming pipeline, the large language model 502 may generate candidate detection logic, as generally shown in FIG. 5. In such embodiments, the candidate detection logic may be generated based on investigative outputs produced during execution of the analysis tools described above. The investigative outputs may include indicators of compromise, message attributes, behavioral attributes, attachment attributes, hyperlink attributes, sender attributes, and/or enrichment outputs extracted from structured electronic communication data objects during execution of the MQL subqueries and analysis of the existing threat detection instructions.

In one or more embodiments, the large language model 502 may utilize the investigative outputs together with attributes of the detection gap candidate to construct candidate detection logic encoding detection conditions that address deficiencies in detection coverage associated with the first set of threat detection instructions. In such embodiments, the candidate detection logic may incorporate indicators extracted from the detection gap candidate together with indicators identified through execution of the analysis tools to generate detection logic targeting electronic communications exhibiting characteristics associated with the detection gap candidate.

In one or more embodiments, the candidate detection logic may encode detection conditions targeting multiple attack vectors within a single threat detection instruction or across a plurality of threat detection instructions. The detection conditions may include sender-based indicators, message content indicators, attachment-related indicators, hyperlink-related indicators, recipient targeting indicators, authentication indicators, and contextual behavioral indicators identified during the research and analysis programming pipeline executed by the rule engine 120.

In one or more embodiments, “candidate detection logic” may refer to an intermediate, machine-readable representation of proposed detection behavior generated by the large language model 502, for a detection gap candidate prior to final encoding as one or more threat detection instructions in the target programming language. The candidate detection logic may be stored in memory as a structured data object and may be created or updated by one or more processors of the rule generation subsystem executing the large language model 502. In one or more embodiments, the candidate detection logic may include (i) one or more message attribute references corresponding to fields of a structured electronic communication data object, (ii) one or more data object traversal paths identifying how to extract target message attribute values from the structured electronic communication data object, (iii) one or more attribute value conditions and logical expressions defining when the extracted values satisfy a suspicious or malicious condition, (iv) one or more optional enrichment function invocations that, when invoked during evaluation, cause a backend service to produce enrichment results usable as additional inputs to the logical expressions, and (v) one or more output label designations indicating a detection outcome to be asserted when the logical expressions evaluate as satisfied. In one or more embodiments, the candidate detection logic may further include metadata fields linking the logic to the detection gap candidate, including an identifier of the detection gap candidate, identifiers of one or more executed threat detection instructions associated with the detection gap, identifiers of evaluated but not satisfied detection conditions, and one or more provenance indicators identifying whether the candidate detection logic was generated based on a false-negative condition, a false-positive condition, a subscriber submission condition, and/or a public attack condition.

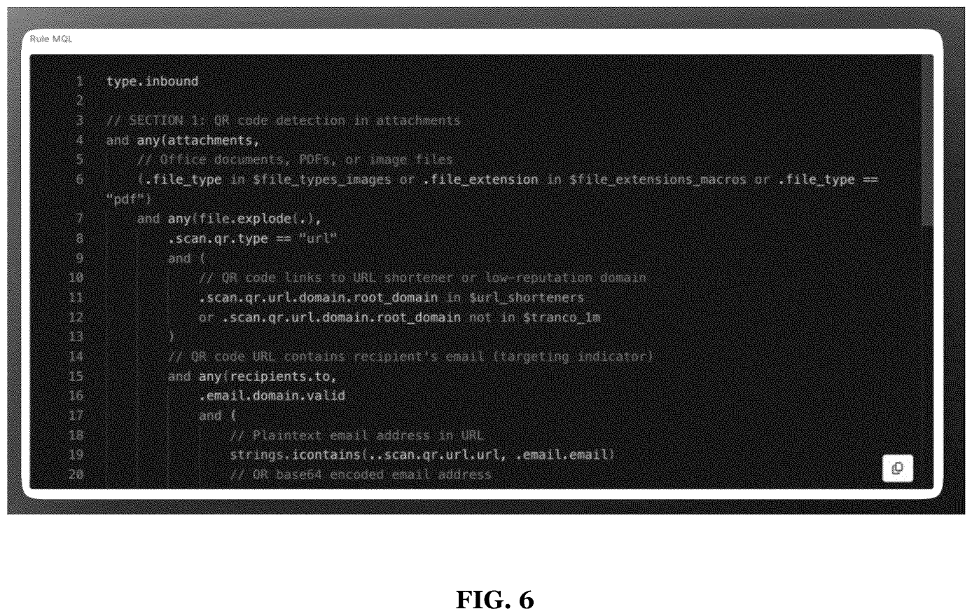

In one or more embodiments, FIG. 6 illustrates a non-limiting example of constrained candidate detection logic expressed in a target programming language. The candidate detection logic may be organized into multiple logical portions that are explicitly labeled within the rule representation, as shown in FIG. 6. The candidate detection logic may begin with a global scoping condition identifying “inbound” electronic communications, and thereafter include a first logical portion labeled “SECTION 1: QR code detection in attachments.”

In one or more embodiments, the first logical portion may correspond to candidate detection logic configured to evaluate attachment-level characteristics of a structured electronic communication data object. As illustrated, the first logical portion may include logic that iterates across one or more attachments and apply file-type gating conditions that treat office document formats, portable document format files, and image-based files as eligible for further analysis. In such embodiments, the first logical portion of the candidate detection logic may further include logic configured to process attachment content and evaluate whether the attachment contains a detected quick response code, and whether the detected quick response code resolves to a uniform resource locator.

In one or more embodiments, within the first logical portion, FIG. 6 further illustrates domain-based evaluation logic associated with the detected uniform resource locator. As shown, this evaluation logic may include conditions that assess whether a root domain associated with the uniform resource locator corresponds to a known shortening service or falls outside a predefined set of commonly observed domains. In such embodiments, this domain-based evaluation logic may operate as a targeting indicator that refines detection behavior beyond simple presence of a quick response code.

In one or more embodiments, FIG. 6 further illustrates a second logical portion labeled “QR code URL contains recipient's email (targeting indicator).” In such embodiments, the second logical portion may correspond to candidate detection logic that evaluates recipient-specific attributes associated with the electronic communication. As shown, the second logical portion includes logic that may iterate across one or more intended recipients of the electronic communication, validate a recipient domain attribute, and evaluate whether a recipient identifier is present within the uniform resource locator associated with the detected quick response code. In some embodiments, the illustrated logic may account for multiple representations of the recipient identifier, including a direct textual representation and an encoded representation. Collectively, the non-limiting example in FIG. 6 illustrates candidate detection logic that combines attachment inspection, quick response code extraction, domain-based evaluation, and recipient targeting into a coordinated detection behavior responsive to a detection gap candidate.

In one or more embodiments, the candidate detection logic generated by the large language model 502 may be provided to a programming language constraint module 504, as shown in FIG. 5. The programming language constraint module 504 may be configured to enforce structural, semantic, and syntactic constraints associated with the target programming language. In such embodiments, the constraint module 504 may transform or constrain the candidate detection logic generated by the large language model 502 into a form that is expressible within the syntax and semantics of the target programming language.

In one or more embodiments, the target programming language may include a message detection language designed to reference and evaluate message components or message attribute values contained within structured electronic communication data objects. In one or more embodiments, each respective threat detection instruction may be encoded using a message detection language (e.g., message query language (MQL)) that is designed to reference and evaluate message components or message attribute values contained within a structured message data object.

In one or more embodiments, each respective threat detection instruction may be encoded with a respective data object traversal path that specifies a distinct sequence of one or more message attribute identifiers configured to extract a target message attribute value from a subject structured message data object. Additionally, each respective threat detection instruction may be encoded with one or more attribute value conditions to evaluate the extracted target message attribute value. The encoding of the threat detection instructions is described in detail in U.S. patent application Ser. No. 19/261,636, entitled “SYSTEMS AND METHODS FOR REAL-TIME DETECTION AND MITIGATION OF MALICIOUS ELECTRONIC COMMUNICATIONS,” which is herein incorporated by reference in its entirety.

In one or more embodiments, the programming language constraint module 504 may ensure that the candidate detection logic includes valid data object traversal paths, valid attribute references, and valid logical expressions consistent with the predefined schema of structured electronic communication data objects. In such embodiments, the constraint module 504 may further ensure that enrichment functions referenced by the candidate detection logic are callable enrichment functions supported by the system 100.

In one or more embodiments, the constrained candidate detection logic may be provided to a syntax validator 506, as shown in FIG. 5. The syntax validator 506 may be configured to perform syntactic validation of the constrained detection logic to ensure compliance with the formal grammar of the target programming language. In such embodiments, the syntax validator 506 may output a syntax validation result indicating whether the candidate detection logic is syntactically valid or contains one or more errors.

In one or more embodiments, if the syntax validator 506 detects a syntax error, semantic inconsistency, or unsupported construct, the syntax validator 506 may generate an error signal that is provided back to the large language model 502, as generally illustrated in FIG. 5. The error signal may include information identifying the syntax location or syntax nature of the error. In such embodiments, the rule generation subsystem may iteratively refine the candidate detection logic by re-invoking the large language model 502 with the error signal until syntactically valid detection logic is produced.

In one or more embodiments, upon successful validation by the syntax validator 506, the rule generation subsystem may output a candidate set of threat detection instructions represented in the target programming language. The candidate set of threat detection instructions may include one or more threat detection instructions configured to detect electronic communications exhibiting characteristics associated with the detection gap candidate.

In one or more embodiments, each respective threat detection instruction of the candidate set of threat detection instructions (e.g., a second set of threat detection instructions distinct from the first set of threat detection instructions) may be encoded to detect a subject electronic communication as suspicious or not suspicious based on whether extracted message attribute values satisfy one or more attribute value conditions. In such embodiments, the candidate set of threat detection instructions may leverage enrichment functions, including but not limited to screenshot enrichment functions, base64 scanning enrichment functions, link analysis enrichment functions, logo detection enrichment functions, macro classification enrichment functions, machine learning-based natural language understanding enrichment functions, and/or any other enrichment function, as described in U.S. patent application Ser. No. 19/261,636, entitled “SYSTEMS AND METHODS FOR REAL-TIME DETECTION AND MITIGATION OF MALICIOUS ELECTRONIC COMMUNICATIONS,” which is herein incorporated by reference in its entirety.

In one or more embodiments, the second set of threat detection instructions generated at S240 may comprise a single threat detection instruction or a plurality of threat detection instructions. In some embodiments, the plurality of threat detection instructions may collectively address a detection gap by targeting different manifestations of a threat or different stages of an attack, such as sender impersonation combined with malicious attachment delivery, or phishing content combined with deceptive hyperlinks. In one or more embodiments, the second set of threat detection instructions generated at S240 may be persisted in memory and provided to downstream system components for evaluation, validation, and refinement, as further described in subsequent steps of method 200.

FIG. 8 illustrates a non-limiting example of a threat detection instruction comprising a single threat detection instruction encoded using a message detection language. In one or more embodiments, FIG. 8 illustrates a system-generated threat detection instruction, i.e., a rule generated by the rule generation subsystem. The system-generated threat detection instruction may be generated, in one example, for detecting an inbound electronic communication exhibiting characteristics associated with a detection gap candidate (e.g., a false-negative electronic communication), as described in S240.

As illustrated, the system-generated threat detection instruction may begin by scoping evaluation to an inbound message type (e.g., “type.inbound”). The system-generated threat detection instruction may further include candidate detection logic partitioned into multiple sections that each encode a distinct detection objective, thereby allowing the single threat detection instruction to target multiple attack vectors simultaneously. In one non-limiting example, a first section illustrated as “Section 1: EML attachment with SVG content” may include detection logic that inspects one or more attachments and checks for an attached message container having a content type consistent with an embedded electronic mail message (e.g., “message/rfc822”). The detection logic may further evaluate parsed text extracted from the attached message container to determine whether the extracted text contains an indicator associated with scalable vector graphics content (e.g., a “.svg” string occurrence). In this manner, the first section of the rule may be structured to detect an embedded-message attachment scenario in which vector-graphic content is present in or referenced by an attached electronic communication.

As further illustrated, the system-generated threat detection instruction may include a second section, namely, “Section 2: Base64 encoded JavaScript obfuscation patterns.” The second section may include detection logic that evaluates one or more attachments of an embedded-message content type (e.g., “message/rfc822”) and uses a base64 scanning operation to extract text from the embedded message content (e.g., by scanning base64-encoded strings derived from parsed text). The second section may further include multiple obfuscation-related indicators that may be matched against decoded or extracted values, including string indicators corresponding to base64 decoding or script execution behaviors (e.g., “atob”, “eval”, “fromCharCode”), indicators corresponding to navigation or redirection behaviors (e.g., “window.location”, “document.location”), and an additional indicator pattern associated with character-code based reconstruction (e.g., a “parseInt” and “charCodeAt” pattern). In this manner, the second section may include candidate detection logic that may not be limited to detecting a base64-encoded string, but additionally structured to detect obfuscation behaviors and redirection behaviors that may be embedded within or derived from decoded content.

Additionally, or alternatively, in one or more embodiments, the system-generated threat detection instruction may include a third section illustrated as “Section 3: Recipient targeting indicator.” The third section may include detection logic that evaluates an embedded-message attachment condition (e.g., a “message/rfc822” content type) and further evaluates a recipient-related condition in which extracted text is checked for the presence of an intended recipient value (e.g., a recipient address). The detection logic may also check a recipient-domain validity indicator (e.g., a “domain.valid” condition), as shown in FIG. 8. In one embodiment, the third section may thereby encode the candidate detection logic configured to detect a targeted-message characteristic in which the embedded message content includes recipient-identifying strings, rather than merely detecting generic lure content.

Additionally, or alternatively, the system-generated threat detection instruction may further include a fourth section illustrated as “Section 4: Sender validation.” The fourth section may include detection logic that evaluates sender-profile and authentication-related attributes, as shown in the figure. In one embodiment, the fourth section may include a sender prevalence check that classifies a sender as newly observed or anomalous (e.g., sender prevalence being “new” or “outlier”). The fourth section may further include additional sender trust conditions, e.g., conditions corresponding to whether a sender is solicited and whether message authentication passes, such as a domain-based message authentication reporting and conformance pass indicator. In an embodiment, the fourth section may encode a threat detection instruction that may be additionally structured to incorporate sender reputation and authentication outcomes as part of the candidate detection logic.

Accordingly, in one embodiment, the system-generated threat detection instruction may explicitly structure the detection logic into multiple named sections, wherein each section encodes a distinct detection objective within the same rule. In one embodiment, the system-generated threat detection instruction may include, within a single threat detection instruction, embedded-message content indicators together with recipient targeting indicators and sender validation indicators, such as those corresponding to “Section 3: Recipient targeting indicator” and “Section 4: Sender validation.” In another embodiment, the system-generated threat detection instruction may express a unified, multi-vector detection strategy by combining attachment-based indicators, base64 and obfuscation indicators, recipient-specific targeting indicators, and sender-validation conditions within a single coherent rule structure.

At least one technical benefit of S240 may include enabling the system 100 to automatically produce executable detection logic that is syntactically valid, semantically constrained, and tailored to an identified detection gap. By combining large language model-based generation with rule corpus analysis, constraint enforcement, and syntax validation, the system may reduce false negatives while maintaining consistency with existing detection logic and system-wide rule semantics. Another technical benefit of S240 may include enabling multi-vector detection coverage by synthesizing threat detection instructions that incorporate multiple indicators derived from structured electronic communication data objects, enrichment outputs, and behavioral attributes. This may improve detection effectiveness for complex threats that evade single-indicator detection approaches while preserving compatibility with the target programming language used by the system 100.

### 2.5 Evaluating the Second Set of Threat Detection Instructions Against Historical Electronic Communication Data

S250, which includes evaluating the second set of threat detection instructions against historical electronic communication data, may function to simulate operational deployment of the second set of threat detection instructions and to determine performance characteristics of the second set of threat detection instructions. In one or more embodiments, S250 may function to cause the rule engine 120 to execute the second set of threat detection instructions against historical electronic communication data and generate one or more evaluation outputs, as generally shown in FIG. 3. In an embodiment, the historical communication data may be stored in one or more electronic communication data repositories. S250 may function to generate one or more evaluation outputs indicating whether the second set of threat detection instructions satisfies one or more predefined operational criteria.

In one or more embodiments, the historical electronic communication data may include a plurality of electronic communications previously processed by the system 100, including, but not limiting to, previously observed malicious electronic communication and previously observed benign electronic communication. In one or more embodiments, the historical electronic communication data may further include subscriber-specific electronic communication datasets and subscriber-agnostic electronic communication datasets. Additionally, or alternatively, in one or more embodiments, the historical electronic communication data may include labeled datasets and partially labeled datasets, and may include datasets in which at least a subset of electronic communications is labeled by one or more analysts and/or are assigned probabilistic labels by a supervised machine learning model that outputs a probability that an electronic communication is malicious.

As shown generally in a non-limiting example of FIG. 5, S250 may be implemented by the rule evaluation subsystem of the rule engine 120, where the rule evaluation subsystem may include a plurality of communicatively coupled system components comprising at least a detection accuracy evaluator 508, a syntactic correctness analyzer 510, a robustness evaluator 512, and an acceptance condition evaluator 514. In an embodiment, the rule evaluation subsystem may be further communicatively coupled to historical communication datastore 516. In one or more embodiments, the rule evaluation subsystem may receive, as input, (i) the second set of threat detection instructions generated at S240 and (ii) the historical electronic communication data stored in the historical communication datastore 516, and the rule evaluation subsystem may execute the second set of threat detection instructions against the historical electronic communication data to generate one or more evaluation outputs.

In one or more embodiments, S250 may function to evaluate the second set of threat detection instructions including determining one or more detection coverage characteristics indicating which historical malicious electronic communications would be detected by the second set of threat detection instructions. In one or more embodiments, S250 may function to evaluate the second set of threat detection instructions by determining false positive characteristics, e.g., indicating which historical benign electronic communications would be incorrectly classified as suspicious or malicious. In one or more embodiments, S250 may further function to determine selectivity characteristics associated with a breadth or narrowness of detection logic encoded by the second set of threat detection instructions, e.g., including whether the second set of threat detection instructions relies on over-specific detection logic that may reduce generalization across related electronic communications.

In one or more embodiments, the detection accuracy evaluator 508 may be configured to measure detection accuracy by measuring a number of true positives and a number of false positives generated when the second set of threat detection instructions is executed against the historical electronic communication data. In one or more embodiments, the detection accuracy evaluator 508 may additionally determine whether true positives are unique to the second set of threat detection instructions, including determining whether a true positive electronic communication detected by the second set of threat detection instructions has been found by any other threat detection instructions in a deployed rule corpus, such that true positives not found by any other threat detection instructions may be weighted as having additional value relative to true positives flagged by multiple threat detection instructions.

In one or more embodiments, the detection accuracy evaluator 508 may further be configured to compute an accuracy metric based on (i) a precision score computed from a ratio of true positives to a sum of true positives and false positives; and (ii) a unique-true-positive precision computed from a ratio of unique true positives to the sum of true positives and false positives. In an embodiment, the computed accuracy metric may comprise an average of the precision score and the unique-true-positive precision.

In one or more embodiments, the syntactic correctness analyzer 510 may be implemented as a rule validation module executed by one or more processors and configured to programmatically evaluate whether one or more candidate threat detection instructions of the second set of threat detection instructions conform to a formal grammar, tokenization scheme, and structural constraints of the target programming language. In such embodiments, the syntactic correctness analyzer 510 may parse each candidate threat detection instruction into an intermediate representation, including one or more abstract syntax trees or equivalent parse structures, and evaluate the intermediate representation against a predefined grammar specification associated with the target programming language to detect malformed expressions, invalid operators, unresolved attribute references, unsupported function calls, or illegal rule constructs. In one or more embodiments, the syntactic correctness analyzer 510 may be associated with a mandatory validation stage of the rule generation pipeline, such that successful completion of the validation stage may be required before the second set of threat detection instructions is permitted to advance to downstream evaluation or deployment stages. In response to detecting a syntactic error or invalid construct, the syntactic correctness analyzer 510 may cause the rule engine 120 to initiate a retry loop in which one or more processors generate revised candidate detection logic and re-submit the revised logic for re-validation.

In one or more embodiments, the correctness metrics generated by the syntactic correctness analyzer 510 may include a pass-attempt success rate representing a proportion of candidate threat detection instructions that successfully satisfy syntactic validation on an initial generation attempt without requiring iterative correction. Additionally, or alternatively, in one or more embodiments, the correctness metrics may include one or more compute resource utilization indicators associated with syntactic validation, including processor execution time, memory utilization, and a number of generation attempts required before syntactic validation is satisfied. In such embodiments, the correctness metrics may be structured for downstream consumption by the acceptance condition evaluator 514 to inform automated refinement, acceptance, or rejection decisions associated with the second set of threat detection instructions.

In one or more embodiments, the robustness evaluator 512 may function to evaluate robustness characteristics of the second set of threat detection instructions by evaluating how susceptible the second set of threat detection instructions is to attacker evasion attempts, including low-effort bypasses that may be achieved through minor variations in message structure or content. In one or more embodiments, the robustness evaluator 512 may compute a brittleness score based on an evaluation of whether the second set of threat detection instructions relies on direct string matches on static indicators such as internet protocol addresses, domains, or hash values, which may be treated as indicating brittleness, since such patterns may be bypassed through trivial evasions by malicious actors.

Additionally, or alternatively, in one or more embodiments, the robustness evaluator 512 may treat behavioral indicators and fuzzy matching as signs of robustness, including sender prevalence, domain reputation scores, and machine learning-based natural language understanding outputs, since such indicators may provide generalizable detection behavior across variations in attack patterns. In one or more embodiments, the robustness evaluator 512 may map a ratio of robustness rewards to brittleness penalties to a bounded robustness metric using a logistic mapping function.

In one or more embodiments, the acceptance condition evaluator 514 may function to receive accuracy metrics from the detection accuracy evaluator 508, correctness metrics from the syntactic correctness analyzer 510, and robustness metrics from the robustness evaluator 512, as generally illustrated in FIG. 5. The acceptance condition evaluator 514 may be configured to determine whether the second set of threat detection instructions satisfies an acceptance condition, as described in greater detail in S260. In one or more embodiments, the acceptance condition evaluator 514 may compare evaluation results associated with the second set of threat detection instructions against evaluation results associated with the first set of threat detection instructions, baseline detection performance thresholds, and/or predefined operational criteria. In one or more embodiments, the acceptance condition evaluator 514 may output an acceptance signal indicating that the second set of threat detection instructions satisfies the acceptance condition or, alternatively, output a feedback signal indicating that additional modification of the second set of threat detection instructions is required.

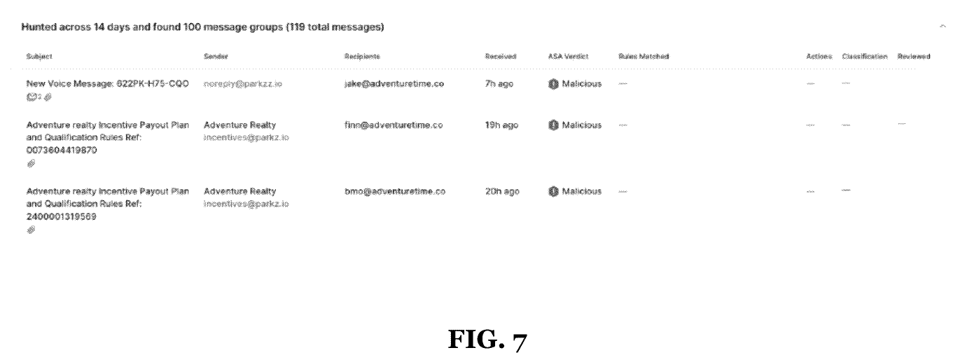

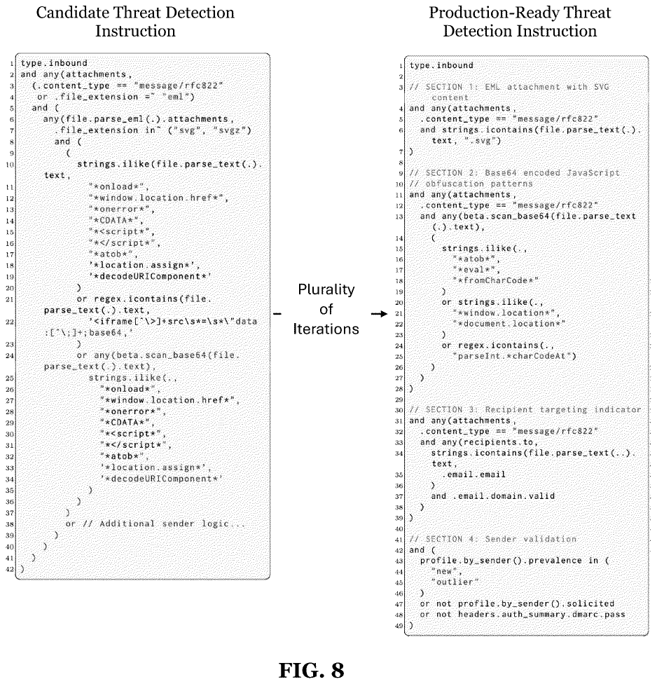

As shown in a non-limiting example of FIG. 7, execution of the second set of threat detection instructions against historical electronic communication data may produce a structured set of evaluation results that are presented as message-level records corresponding to a simulated hunt or batch evaluation operation. In the illustrated example, the rule evaluation subsystem of the rule engine 120 may execute the second set of threat detection instructions across a defined historical time window, resulting in identification of one or more message groups and associated electronic communications that satisfy detection conditions encoded by the second set of threat detection instructions. The example of FIG. 7 depicts a tabular evaluation output in which each row may correspond to an electronic communication or message group identified during evaluation, and each column may correspond to a distinct evaluation attribute generated by the rule evaluation subsystem.

In one or more embodiments, the evaluation output shown in FIG. 7 may include a “Subject” field identifying a message subject line, a “Sender” field identifying a sender address or sender identity, a “Recipients” field identifying one or more recipient addresses, and a “Received” field indicating a time at which the electronic communication was originally observed. Additionally, the evaluation output may include an “ASA verdict” field indicating a detection outcome assigned by the system 100 when applying the second set of threat detection instructions to the historical electronic communication data. In the illustrated example, the “ASA verdict” field may indicate that one or more evaluated electronic communications are classified as malicious, reflecting successful detection of historical malicious messages by the second set of threat detection instructions.

It shall be recognized that, in one or more embodiments, the system 100 and/or method 200 may use one or more processes, modules, and/or the like described in U.S. Patent Application No. 63/912,604, filed 6 Nov. 2025, which is incorporated herein in its entirety by this reference. It shall be recognized that, in one or more embodiments, the system 100 and/or method 200 may additionally or alternatively use one or more processes, modules, and/or the like described in U.S. Patent Application No. 64/075,422, filed 28 May 2026, which is incorporated herein in its entirety by this reference.

In one or more embodiments, the evaluation output shown in FIG. 7 may further include fields indicating whether any threat detection instructions were matched (“Rules Matched”), one or more actions associated with the detection outcome (“Actions), a classification label assigned to the electronic communication (“Classification”), and an indication of whether the electronic communication has been reviewed by an analyst or automated review process (“Reviewed”). In such embodiments, these fields collectively represent structured evaluation outputs generated by the rule evaluation subsystem and may be stored in memory, displayed via a graphical user interface, or provided to downstream system components for automated analysis.

In one or more embodiments, the aggregated evaluation summary shown in FIG. 7, including an indication of a total number of message groups evaluated and a total number of electronic communications processed during the evaluation window, may correspond to detection coverage characteristics and false positive characteristics computed by the detection accuracy evaluator 508. In such embodiments, the structured evaluation output shown in FIG. 7 may serve as a concrete representation of evaluation metrics and message-level evidence used by the acceptance condition evaluator 514 to determine whether the second set of threat detection instructions satisfies predefined operational criteria prior to deployment.

In one or more embodiments, evaluation of the second set of threat detection instructions at S250 may be performed as part of an autonomous threat hunting operation executed by the rule engine 120 across historical electronic communication data. In such embodiments, the rule engine 120 may execute the second set of threat detection instructions as hunt queries against one or more electronic communication data repositories storing historical electronic communications. Execution of the second set of threat detection instructions as hunt queries may cause the rule engine 120 to identify electronic communications that satisfy detection conditions encoded by the second set of threat detection instructions and to generate hunt results representing candidate malicious electronic communications detected during the evaluation process.

In one or more embodiments, the autonomous threat hunting operation may enable the rule engine 120 to analyze detection behavior of the second set of threat detection instructions across large volumes of previously observed electronic communications without modifying live production detection pipelines. In such embodiments, the hunt results may include structured records describing electronic communications detected during execution of the second set of threat detection instructions together with associated message attributes, detection outcomes, and contextual metadata. The rule evaluation subsystem may analyze the hunt results to compute detection coverage characteristics, false positive characteristics, and robustness characteristics associated with the second set of threat detection instructions prior to determining whether the second set of threat detection instructions satisfies an acceptance condition.

At least one technical benefit of S250 may include evaluating the second set of threat detection instructions against historical electronic communication data to enable the system 100 to simulate operational deployment conditions prior to modifying an incumbent set of threat detection instructions. By executing the second set of threat detection instructions against historically observed malicious and benign electronic communications, the rule engine 120 may quantify detection coverage characteristics, false positive characteristics, accuracy characteristics, and robustness characteristics without exposing live production traffic to unvalidated detection logic. In such embodiments, the evaluation may further enable comparative analysis between the second set of threat detection instructions and the incumbent set of threat detection instructions using a common historical dataset, thereby supporting objective determination of whether newly generated detection logic improves detection coverage while maintaining acceptable false positive behavior. Additionally, by generating structured, machine-readable evaluation outputs and metrics, the rule engine 120 may enable automated acceptance decisions, iterative refinement, or rejection of candidate detection logic without user intervention, thereby reducing deployment risk, improving detection reliability, and supporting autonomous evolution of threat detection instructions within the system 100.

### 2.6 Iteratively Refining the Second Set of Threat Detection Instructions Until the Second Set of Threat Detection Instructions Satisfies an Acceptance Condition Based on Evaluation Outputs

S260, which includes iteratively refining the second set of threat detection instructions until the second set of threat detection instructions satisfies an acceptance condition based on evaluation outputs, may function to iteratively update the second set of threat detection instructions using automated system feedback prior to deployment of the second set of threat detection instructions or prior to updating of the first set of the threat detection instructions using the second set of threat detection instructions. In one or more embodiments, the rule engine 120 may include an acceptance condition evaluator 514 that may operate as part of, or in conjunction with, the rule engine 120, as illustrated generally in FIG. 5. In one or more embodiments, the acceptance condition evaluator 514 may be configured to receive evaluation outputs generated at S250, and use the evaluation outputs for iterative refinement of the second set of threat detection instructions. In one or more embodiments, the evaluation outputs may include robustness metrics produced by the robustness evaluator 512, correctness metrics produced by the syntactic correctness analyzer 510, and accuracy metrics produced by the detection accuracy evaluator 508.

In one or more embodiments, the acceptance condition evaluator 514 may be configured to compute a composite acceptance signal based on aggregating multiple evaluation outputs associated with the second set of threat detection instructions. In one or more embodiments, the composite acceptance signal may be stored as a structured acceptance signal data object that at least includes (i) an accuracy sub-score, (ii) a robustness sub-score, and (iii) a correctness efficiency sub-score.

In one or more embodiments, the accuracy sub-score may be computed by the acceptance condition evaluator 514 based on one or more accuracy metrics indicating how the second set of threat detection instructions behave when evaluated against historical electronic communication data. For example, the accuracy metrics may include counts of true positives and false positives generated by executing a candidate threat detection instruction of the second set of threat detection instructions against a human-labeled dataset of electronic communications. In one or more embodiments, the accuracy metrics may additionally include an indication of whether one or more true positives are unique to the candidate threat detection instruction relative to an incumbent threat detection instruction of the first set of threat detection instructions. In one or more embodiments, the acceptance condition evaluator 514 may compute the accuracy sub-score using a scoring function that combines a precision value with a unique true-positive precision value, thereby producing the accuracy sub-score that balances alert noise reduction with net-new detection coverage.

Additionally, in one or more embodiments, the robustness sub-score may be computed by the acceptance condition evaluator 514 based on robustness metrics indicating a susceptibility of the second set of threat detection instructions to adversarial evasion and low-effort bypasses. In one or more embodiments, as described briefly in the foregoing, the robustness evaluator 512 may compute a brittleness score on a bounded scale based on evaluating whether a candidate threat detection instruction of the second set of threat detection instructions relies on brittle direct string matches on indicators of compromise, versus relying on behavioral indicators and fuzzy matching that generalize across variations in attack patterns. In one or more embodiments, the acceptance condition evaluator 514 may compare the robustness sub-score to a robustness threshold that defines a minimum acceptable durability for deployment. In one embodiment, the robustness threshold may indicate that a robustness score exceeding a predetermined value corresponds to a threat detection instruction that, when evaluated by the robustness evaluator 512, demonstrates bounded degradation in detection performance under synthetically varied historical electronic communications.

Additionally, in one or more embodiments, the correctness efficiency sub-score may be computed by the acceptance condition evaluator 514 based on correctness metrics that model an economic cost associated with achieving syntactic correctness of a candidate threat detection instruction prior to evaluation against historical communication data. As described herein, a candidate threat detection instruction that fails syntactic validation may not be evaluated against historical electronic communication data and, therefore, each syntactic validation failure may incur an incremental computational and economic cost associated with generating a subsequent iteration of candidate detection logic.

In one or more embodiments, as briefly described in the foregoing, the correctness metrics may be generated in connection with a syntactic validation step that operates as a mandatory gating condition before a candidate threat detection instruction proceeds to evaluation against historical electronic communication data. In such embodiments, failure to satisfy the syntactic validation step may cause the rule generation subsystem to enter a retry loop in which one or more processors initiate successive generation attempts until syntactically valid candidate detection logic is produced.

In one or more embodiments, the acceptance condition evaluator 514 may compute the correctness efficiency sub-score using an adapted cost-to-pass framework in which an expected economic cost to achieve syntactic correctness may be estimated as a function of (i) a cost per generation attempt associated with generating new message query language logic and (ii) a success rate corresponding to a pass-at-1 rate of a message query language validator. In such embodiments, the cost per generation attempt may represent an expected computational or monetary expenditure incurred for each generation attempt, and the pass-at-1 rate may represent a likelihood that a single generation attempt produces syntactically valid detection logic without requiring retry.

Additionally, or alternatively, in one or more embodiments, the correctness metrics may include an observed total correctness cost computed as a product of the cost per generation attempt and a total number of generation attempts required for the candidate threat detection instruction to pass the syntactic validation step. In such embodiments, the correctness efficiency sub-score may represent either an expected cost-to-pass estimate or an observed cumulative cost incurred prior to achieving syntactic correctness. Accordingly, in one or more embodiments, the correctness efficiency sub-score may enable the acceptance condition evaluator 514 to quantify an economic efficiency of autonomously generating syntactically valid threat detection instructions and to incorporate economic feasibility into acceptance condition determinations, alongside detection accuracy and robustness characteristics.

In one or more embodiments, the acceptance condition evaluator 514 may compare each sub-score of the composite acceptance signal against one or more predefined thresholds to determine a binary acceptance outcome or rejection outcome. In one or more embodiments, a binary acceptance outcome may be produced when the second set of threat detection instructions simultaneously satisfies (i) a minimum detection accuracy threshold, (ii) a minimum robustness threshold, and (iii) a maximum correctness efficiency threshold. In one or more embodiments, the acceptance condition evaluator 514 may store the binary acceptance outcome together with the composite acceptance signal as an acceptance result record that is structured for automated downstream processing.

In one or more embodiments, in response to determining that the second set of threat detection instructions does not satisfy the acceptance condition, the acceptance condition evaluator 514 may initiate an iterative refinement process.

In one or more embodiments, the acceptance condition evaluator 514 may generate one or more feedback signals describing deficiencies indicated by the composite acceptance signal. The one or more feedback signals may be provided by the acceptance condition evaluator 514 back to the rule generation subsystem for regeneration or adjustment of the second set of threat detection instructions.

In one or more embodiments, the one or more feedback signals may include an indication that detection logic of one or more threat detection instructions is overly broad based on an elevated false positive rate within historical benign electronic communications. The one or more feedback signals may further include an indication that detection logic of one or more threat detection instructions is overly narrow based on failure to detect a target threshold quantity of labeled malicious electronic communications. In one or more embodiments, the one or more feedback signals may additionally include an indication that a candidate threat detection instruction is brittle based on excessive reliance on static indicators of compromise. In another embodiment, the one or more feedback signals may include an indication that the candidate threat detection instruction should be modified to incorporate behavioral indicators or fuzzy matching to improve the robustness sub-score.

As shown generally in FIG. 4B, the rule engine 120 may generate the second set of threat detection instructions and perform back-testing for the generated second set of threat detection instructions. As used herein, “back-testing” may include evaluating the second set of threat detection instructions against historical communication data, including previously observed malicious electronic communication and previously observed benign electronic communication. As further illustrated in FIG. 4B, in case the back-testing is unsuccessful, feedback signals may be generated to initiate adjusting or regenerating the second set of threat detection instructions.

In one or more embodiments, the rule engine 120 may utilize the evaluation outputs generated at S250 to determine whether modification of an existing candidate threat detection instruction is sufficient to improve performance characteristics or whether the candidate threat detection instruction should be discarded and replaced with newly generated detection logic. In one or more embodiments, sufficiency of the modification may be determined based on changes observed in one or more evaluation metrics associated with the candidate threat detection instruction when executed against historical electronic communication data. For example, the rule engine 120 may determine that modification is sufficient when an adjusted candidate threat detection instruction produces an increase in true positive detections, a reduction in false positive detections within benign electronic communications, and/or an increase in the value of one or more robustness metrics computed by the robustness evaluator 512.

Additionally, in one or more embodiments, the rule engine 120 may determine that modification is insufficient when the adjusted candidate threat detection instruction fails to satisfy one or more acceptance thresholds associated with the composite acceptance signal generated by the acceptance condition evaluator 514. In such embodiments, the rule engine 120 may discard the previously generated candidate threat detection instruction and initiate generation of alternative detection logic based on additional investigative outputs associated with the detection gap candidate. In such embodiments, the rule engine 120 may autonomously determine whether to refine an existing candidate threat detection instruction, generate additional detection conditions, remove previously generated detection conditions, or generate an entirely new candidate threat detection instruction derived from the detection gap candidate.

In one or more embodiments, the rule engine 120 may further perform additional investigative operations prior to regenerating the second set of threat detection instructions. For example, the rule engine 120 may analyze hunt results produced during evaluation against historical electronic communication data to identify electronic communications that triggered the candidate threat detection instructions and electronic communications that were not detected by the candidate threat detection instructions. Based on the results from this analysis, the rule engine 120 may identify additional indicators of compromise, tactics, techniques, or procedures associated with the detection gap candidate.

Additionally, or alternatively, the rule engine 120 may re-execute the research and analysis programming pipeline described with respect to S240. In such embodiments, the rule engine 120 may execute additional MQL subqueries against electronic communication data repositories to retrieve additional electronic communications associated with the detection gap candidate. The rule engine 120 may further analyze results returned from the MQL subqueries to determine whether alternative indicators, message attributes, behavioral attributes, or contextual indicators may provide improved detection characteristics relative to the previously generated detection logic.

In one or more embodiments, the rule engine 120 may further analyze the existing corpus of threat detection instructions to determine whether alternative detection strategies may be derived from previously deployed detection logic. For example, the rule engine 120 may identify detection instructions that successfully detect related threat patterns and may incorporate corresponding detection conditions or structural patterns into newly generated candidate detection logic.

Stated differently, the rule engine 120 may perform multiple forms of refinement operations to iteratively refine the second set of threat detection instructions until the second set of threat detection instructions satisfy an acceptance condition based on evaluation outputs. The refinement operations may include modifying an existing candidate threat detection instruction, replacing portions of the detection logic within the candidate threat detection instruction, discarding the previously generated candidate threat detection instruction and generating a new candidate threat detection instruction based on additional investigative outputs, or generating multiple alternative candidate threat detection instructions targeting different combinations of indicators associated with the detection gap candidate.

In one or more embodiments, the acceptance condition evaluator 514 may provide the one or more feedback signals to the rule generation subsystem of the rule engine 120 to drive generation of an alternative or modified version of the second set of threat detection instructions based on the above refinement operations. In one or more embodiments, the one or more feedback signals may be used to adjust one or more inputs to the large language model 502 executed by the rule generation subsystem. In another embodiment, the one or more feedback signals may be used to modify constraints applied by the programming language constraint module 504. Additionally, or alternatively, the one or more feedback signals may include a correctness-oriented feedback signal that prioritizes syntactic constructs with a higher pass-at-1 success likelihood to reduce an expected cost-to-pass metric and reduce a number of retry loop iterations.

In one or more embodiments, upon generation of an adjusted or regenerated version of the second set of threat detection instructions, the rule engine 120 may resubmit the updated second set of threat detection instructions for evaluation against historical electronic communication data and may repeat the acceptance condition determination using the acceptance condition evaluator 514. In one or more embodiments, the rule engine 120 may repeat the evaluation and feedback cycle one or more times until the acceptance condition is satisfied or until a termination condition is met. In one or more embodiments, a termination condition may include exhaustion of a predefined number of refinement iterations. In one or more embodiments, a termination condition may include identification of conflicting acceptance criteria. In one or more embodiments, a termination condition may include invocation of an analyst review workflow.

In one or more embodiments, in response to determining that the second set of threat detection instructions satisfies the acceptance condition, the system 100 may designate the second set of threat detection instructions as validated threat detection instructions, as generally shown in FIGS. 4B and 5.

At least one technical benefit of S260 may include enabling the system 100 to perform closed-loop, automated improvement of threat detection instructions prior to deployment, thereby reducing reliance on user rule tuning and subjective analyst judgment. By iteratively refining the second set of threat detection instructions using evaluation outputs derived from historical electronic communication data, syntactic validation results, and robustness analysis, the system 100 may converge on detection logic that simultaneously balances detection accuracy, false positive control, generalization capability, and computational efficiency. Another technical benefit of S260 may include enabling the system 100 to quantitatively assess and compare candidate detection logic using a composite acceptance signal that aggregates multiple performance dimensions into structured, machine-readable acceptance results, thereby supporting deterministic acceptance or rejection decisions. Additionally, S260 may reduce resource inefficiencies associated with repeated rule generation attempts by explicitly modeling correctness efficiency and expected cost-to-pass behavior, allowing the system 100 to bias regeneration toward syntactically robust constructs with higher validation success likelihood. Further, by generating structured feedback signals that identify specific deficiencies such as over-breadth, over-narrowness, brittleness, or syntactic inefficiencies, S260 may enable targeted regeneration of detection logic rather than wholesale re-authoring, improving convergence speed and stability of the detection rule generation pipeline.

### 2.7 Updating or Replacing the First Set of Threat Detection Instructions Using the Second Set of Threat Detection Instructions

S270, which includes updating or replacing the first set of threat detection instructions using the second set of threat detection instructions, may function to automatically modify, in real-time or near real-time, an operational detection configuration of the system 100 in response to determining that the second set of threat detection instructions satisfies an acceptance condition. Updating or replacing threat detection instructions, as generally referred to herein, may include one or more computer-executable operations that, when executed, alter how the system 100 evaluates, classifies, or responds to subsequently processed electronic communications. It shall be recognized that the phrase “updating or replacing threat detection instructions” may be interchangeably referred to herein as “detection configuration modification,” “rule deployment,” and/or the like.

In one or more embodiments, in response to determining that the second set of threat detection instructions generated through the closed-loop generation, evaluation, and refinement process satisfies the acceptance condition, S270 may function to automatically designate the second set of threat detection instructions as validated threat detection instructions, as generally shown in FIGS. 4B and 5. S270 may function to integrate the validated second set of threat detection instructions into the rule engine 120. Stated another way, in some embodiments, validated second set of threat detection instructions may be digitally linked to the rule engine 120 such that subsequent electronic communications processed by the system 100 are evaluated using the validated detection logic.

In one or more embodiments, updating the first set of threat detection instructions may include automatically replacing one or more threat detection instructions of the first set of threat detection instructions with one or more validated threat detection instructions of the second set of threat detection instructions. In a non-limiting example, a previously deployed threat detection instruction from the first set of threat detection instructions that relied on a static indicator or narrow literal condition may be programmatically disabled or removed, and a validated threat detection instruction from the second set of threat detection instructions encoding a broader, multi-vector detection strategy derived from the detection gap candidate may be installed to mitigate future electronic communications exhibiting similar threat characteristics.

In another non-limiting example, updating the first set of threat detection instructions may include augmenting the first set of threat detection instructions with the validated second set of threat detection instructions without disabling or removing existing detection logic. In such an embodiment, S270 may function to retain incumbent detection rules from the first set of threat detection instructions, while adding one or more threat detection instructions from validated second set of threat detection instructions to expand detection coverage. This may enable the rule engine 120 to evaluate inbound electronic communications against both existing threat detection instructions and the newly generated threat detection instructions in parallel.

In one or more embodiments, updating or replacing the first set of threat detection instructions may further include modifying an execution order, evaluation priority, or grouping associated with the first set of threat detection instructions. In such embodiments, threat detection instructions from the validated second set of threat detection instructions that are associated with higher confidence indicators or broader generalization characteristics may be assigned a higher execution priority, evaluated earlier within a detection pipeline, and/or influence downstream classification or response logic relative to other threat detection instructions.

In one or more embodiments, updating or replacing the first set of threat detection instructions may include persisting the validated second set of threat detection instructions to a threat detection instruction repository that is accessible to the rule engine 120. In such embodiments, the threat detection instruction repository may store executable detection logic in a target programming language and may support versioning, retrieval, rollback, and auditing of deployed detection instructions.

In one or more embodiments, the validated second set of threat detection instructions may be encoded using the same target programming language as the first set of threat detection instructions and may be executable by the rule engine 120 described with respect to S230 and S240. In such embodiments, integrating the validated detection logic may not require modification to the underlying detection execution infrastructure, thereby enabling seamless deployment within an existing operational environment.

In one or more embodiments, updating or replacing the first set of threat detection instructions may include associating metadata with the validated second set of threat detection instructions. Such metadata may include version identifiers distinguishing successive detection rule revisions, provenance information identifying a detection gap candidate or triggering event that resulted in rule generation, evaluation summaries or acceptance condition indicators, deployment timestamps, and one or more policy identifiers governing how and when the validated detection logic was authorized for deployment.

In one or more embodiments, after updating or replacing the first set of threat detection instructions, the system 100 may function to update live detection execution paths such that subsequently received electronic communications are evaluated using the updated detection configuration. In such embodiments, the transition to the updated detection configuration may occur without interrupting electronic communication processing and without requiring system downtime. Further, in one or more embodiments, updating or replacing the first set of threat detection instructions may occur automatically without user intervention in response to satisfaction of the acceptance condition and one or more system policies.

Additionally, or alternatively, updating or replacing the first set of threat detection instructions may occur in response to a policy-based approval workflow, a user review, or a subscriber approval. In one non-limiting example as shown in FIG. 4B, the validated second set of threat detection instructions may undergo a manual or automated approval process, before the second set of threat detection instructions are deployed within the system 100 or before the first set of threat detection instructions are updated using the second set of threat detection instructions.

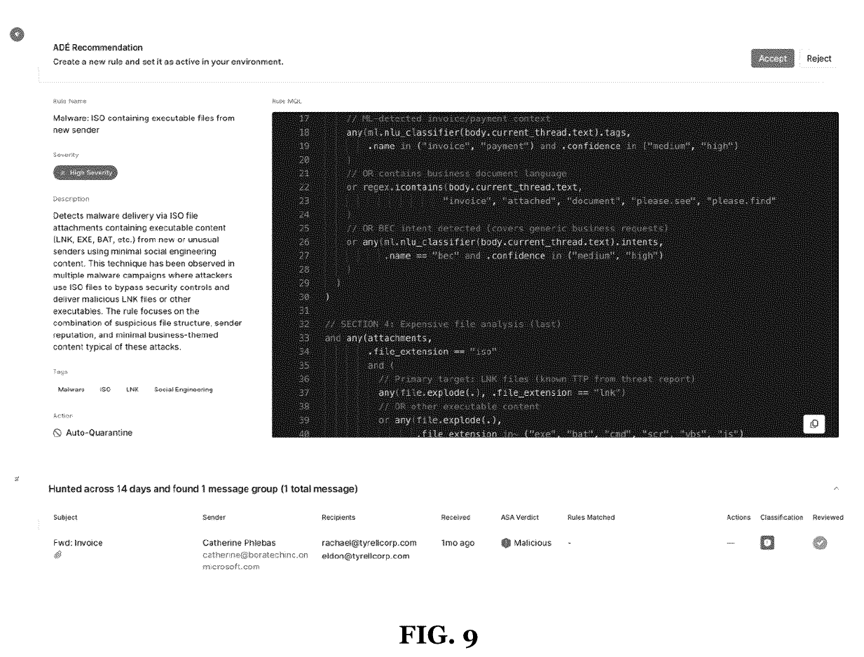

In one or more embodiments, the system 100 may generate a graphical user interface (GUI) for the user approval process. One exemplary GUI is as shown in the non-limiting example of FIG. 9. In one or more embodiments, as part of updating or replacing the first set of threat detection instructions using the validated second set of threat detection instructions, the system 100 may present, via the GUI, a detection instruction review environment that may enable controlled deployment decisions for a system-generated threat detection instruction. The review environment may include a displayed rule editor region shown as interface element “Rule MQL.” Within the “Rule MQL” interface element, a validated threat detection instruction may be rendered as executable detection logic encoded in a target programming language and presented in a formatted, line-numbered view suitable for analyst inspection.

In one or more embodiments, the displayed detection logic within the “Rule MQL” interface element may include multiple logically distinct portions of executable code corresponding to different detection objectives, including structured conditional expressions, enrichment function invocations, and logical groupings that collectively define the behavior of the validated threat detection instruction. In the illustrated example, the detection logic may correspond to a rule targeting malware delivery via file attachments, and may visibly include references to file type analysis, content inspection, sender context evaluation, and attachment execution characteristics, thereby enabling the reviewing user to visually assess the scope, structure, and intent of the detection logic prior to deployment.

In one or more embodiments, the review environment may further include a first interface control labelled “Accept” and a second interface control labeled “Reject.” Each of these interface controls may be implemented as selectable user interface elements positioned adjacent to the rendered detection logic. Selection of the “Accept” interface control may cause the system 100 to proceed with updating or replacing the first set of threat detection instructions by installing the validated threat detection instruction into the operational detection configuration. Conversely, selection of the “Reject” interface control may cause the system 100 to withhold deployment of the validated threat detection instruction and may trigger rollback, deactivation, or further refinement workflows, as described elsewhere herein.

In one or more embodiments, the review environment may further display rule metadata, including an interface element “Name” identifying the detection rule, an interface element “Severity” indicating an assigned severity level for the detection logic, and an interface element “Description” providing a textual summary of the threat scenario targeted by the detection rule. In the illustrated example, the description may reference detection of malware delivery via an archive or disk image file using minimal social engineering, thereby contextualizing the executable detection logic within a concrete attack narrative.

In one or more embodiments, the review environment may further include interface elements such as “Tags” and “Action.” The “Tags” interface element may display categorical labels associated with the detection logic, including threat type indicators and attack technique identifiers. The “Action” interface element may indicate a default or recommended response action, such as automatic quarantine, that will be executed when the detection rule triggers during live operation.

In one or more embodiments, the review environment may further display historical evaluation results associated with the validated threat detection instruction, including an interface element depicting “Hunted across 14 days and found 1 message group (1 total message).” This portion of the interface may reflect evaluation outputs generated during prior testing of the validated threat detection instruction against historical electronic communication data, thereby providing evidence of detection behavior prior to deployment. The review environment may further include a review table with column headers such as “Subject,” “Sender,” “Recipients,” “Received,” and “ASA Verdict,” which may together present a concrete example of a previously observed electronic communication that satisfied the detection logic during evaluation.

As shown in FIG. 9, the “ASA verdict” column may display a value “Malicious,” which may represent an automated classification outcome produced by executing the validated threat detection instruction against a historical electronic communication. The example may further include recipient and sender information, timestamps, and classification status, thereby enabling an authorized reviewer to correlate the validated detection logic with a real-world electronic communication instance prior to accepting deployment.

In one or more embodiments, the review table may further include columns “Actions,” “Classification,” and “Reviewed,” each corresponding to a distinct operational field associated with the displayed historical evaluation result. The “Actions” column may indicate one or more threat mitigation actions executed, recommended, or queued in association with the electronic communication that satisfied the validated threat detection instruction, including, in a non-limiting example, quarantine, routing to a review queue, or other automated handling operations. The “Classification” column may indicate a categorical classification state assigned to the electronic communication, such as malicious, suspicious, or benign, based on execution of the validated threat detection instruction and any supplementary classification logic applied by the system 100. The “Reviewed” column may indicate a review status associated with the electronic communication, including whether the electronic communication has been reviewed by an analyst or subscriber, and may further include a visual indicator reflecting a completed review state or an unreviewed state for the displayed message group.

Accordingly, in such embodiments, the GUI may function as a controlled deployment surface through which the system 100 supports human-in-the-loop approval, rejection, or oversight of validated threat detection instructions prior to updating or replacing the first set of threat detection instructions or deploying the second set of threat detection instructions. Upon selection of the “Accept” interface control, the system 100 may persist the validated threat detection instruction, activate it within the rule engine 120, and update live detection execution paths such that future electronic communications are evaluated using the modified detection configuration. Upon selection of the “Reject” interface control, the system 100 may inhibit deployment and maintain the existing detection configuration, while optionally recording the rejection as deployment metadata associated with the validated detection logic.

In one or more embodiments, the system 100 may support rollback, deactivation, or suspension of updated threat detection instructions or validated second set of threat detection instructions in response to subsequent detection performance degradation, updated system policies, or administrator or analyst action. In such embodiments, selection of a rejection interface input or deactivation control may cause the rule engine 120 to revert to a previous detection configuration and discontinue use of the validated detection logic for future electronic communications.

Upon completion of S270, the system 100 may operate with a modified detection configuration that mitigates future electronic communications exhibiting characteristics similar to those associated with the detection gap candidate identified at S230. In such embodiments, the system 100 may continuously evolve its detection capabilities by iteratively identifying detection gaps, generating candidate detection logic, validating detection performance, and updating operational threat detection instructions in an automated or semi-automated manner.

At least one technical benefit of S270 may include enabling the system 100 to programmatically and reliably evolve an operational detection configuration without requiring user rule authoring, user deployment scripting, or system downtime. By updating or replacing the first set of threat detection instructions using a validated second set of threat detection instructions generated through closed-loop evaluation and refinement, the system 100 may ensure that newly deployed detection logic reflects empirically verified performance characteristics derived from historical electronic communication data. Another technical benefit of S270 may include reducing detection latency for emerging or previously undetected threat patterns by integrating validated detection logic directly into live execution paths of the rule engine 120, thereby enabling subsequent electronic communications exhibiting similar characteristics to be detected and mitigated in real time or near real time. Additionally, S270 may improve operational stability and auditability by persisting validated threat detection instructions with associated metadata, version identifiers, and provenance indicators, which may support controlled deployment, rollback, policy-based approvals, and traceability of detection configuration changes. Further, S270 may enable scalable detection lifecycle management by allowing detection coverage to expand or adapt through automatic replacement, augmentation, or prioritization of threat detection instructions, thereby reducing long-term reliance on static detection logic and improving the ability of the system 100 to respond to evolving adversarial techniques.

### Example Instances of System 100 and Method 200

In one or more embodiments, a threat detection and response service (e.g., the system or service implementing method 200) may electronically transmit message data of an electronic message (e.g., malicious electronic message, spam-based electronic message, graymail-based electronic message, or the like) that evaded a set of threat detection instructions used by the threat detection and response service to an autonomous AI agent (e.g., autonomous detection engineer (ADE) or the like). In other words, in some embodiments, the electronic message may have evaded detection by the threat detection and response service due to a detection gap in the set of threat detection instructions. The set of threat detection instructions, in some embodiments, may include a set of subscriber-agnostic threat detection instructions provided by the threat detection and response service, a set of subscriber-specific threat detection instructions created by a subscribing entity that received the electronic message, and/or a corpus of third-party threat detection instructions created by a third-party entity external to the subscribing entity and the threat detection and response service, as described in U.S. Pat. No. 12,452,296, titled SYSTEMS AND METHODS FOR REAL-TIME DETECTION AND MITIGATION OF MALICIOUS ELECTRONIC COMMUNICATIONS, which is incorporated in its entirety by this reference.

In one or more embodiments, in response to the autonomous AI agent receiving the message data of the electronic message, the autonomous AI agent may function to automatically detect or determine a message signature associated with the electronic message based on the autonomous AI agent assessing the message data of the electronic message. A message signature, in some embodiments, may include a set of message characteristics, attack patterns, behavioral indicators, message attributes, content features, sender characteristics, attachment characteristics, link characteristics, and/or any other property associated with the electronic message that may be used by one or more components of the threat detection and response service to generate a new threat detection instruction or modify an existing threat detection instruction. In such an embodiment, in response to the autonomous AI agent receiving the message data of the electronic message, the autonomous AI agent may function to invoke or use one more computer-executable enrichment functions (e.g., a message screenshot enrichment function, a base64 scanning enrichment function, a file screenshot enrichment function, a machine learning-based link analysis enrichment function, a machine learning-based logo detection enrichment function, a machine learning-based macro classification enrichment function, a HTML screenshot enrichment function, and/or a machine learning-based natural language understanding enrichment function) to assess the electronic message, one or more headers included in the electronic message, one or more pieces of graphical or textual content included in the electronic message, one or more attachments included in the electronic message, one or more links included in the electronic message, and a sender (e.g., sender characteristics) of the electronic message and, in turn, derive the message signature based on the assessment. It shall be recognized that the one or more computer-executable enrichment functions (e.g., enrichment functions or the like) are described in U.S. Pat. No. 12,452,296, titled SYSTEMS AND METHODS FOR REAL-TIME DETECTION AND MITIGATION OF MALICIOUS ELECTRONIC COMMUNICATIONS, which is incorporated in its entirety by this reference.

For instance, in a non-limiting example, the message signature generated for the electronic communication may be expressed in one or more text strings such as “1. Display name claims to be “Al-Sa'aD khalifa General trading company” but sends from ‘info@mollbro.de’ (unrelated German domain), 2. Reply-to is ‘purchase@al-saadkhaliftradingco.com’—completely different domain from sender, 3. Subject: “RFQ Price Offer”—trade-based lure, 4. Classic advance fee fraud/BEC initial contact pattern, 5. Generic greeting, vague references to “Exports council”, 6. No malicious links/attachments—purely social engineering, 7. Unregistered/unknown sender domain, and 8. Out-of-band pivoting via reply-to to different domain.” In another non-limiting example, the message signature generated for the electronic communication may be expressed in one or more text strings such as “1. Sender: ‘office.mail.box1115@bk.ru’—Russian freemail (bk.ru), 2. X-Mailer: Mail.Ru Mailer 1.0—confirms Mail.Ru origin, 3. Display name: “Nicholas Robertson”—impersonating an employee, 4. Subject: “Welcome to the Team, Kenny”—new employee onboarding lure, 5. Content: Asking for preferred email address (out-of-band communication request), 6. No links to external sites (only mailto: links to tyrellcorp.com), 7. No attachments, 8. DMARC/SPF pass (for bk.ru), 9. Sender is not in $org_display_names (likely—it's not from the org), 10. New/unsolicited sender.” In another non-limiting example, the message signature generated for the electronic communication may be expressed in one or more text strings such as “Key indicators:Display name=email address (submission@ptzdata.com), Subject contains recipient email address with tracking identifier (I AMM suffix), Fake thread structure (mimics reply but no in_reply_to/references), Urgency language (“respond within 24 hours”, “immediate attention”), Flattery language (“someone of your calibre”), No unsubscribe mechanism, Disposition-notification-to header (read receipt request for tracking active emails), Desktop-originated message ID (DESKTOP-CIKAHVH), Academic journal solicitation content, Domain mismatch (ptzdata.com sending for academic journal).” In another non-limiting example, the message signature generated for the electronic communication may be expressed in one or more text strings such as “1. **Sender**: Display name: “Meta Ad Review”, Email: shaungs4941xa110@coladventistamaranatha.co, Domain: coladventistamaranatha.co (Colombian TLD), 2. **Subject**: “Temporary Limit Applied to Your Ad Campaigns” 3. **Body Content**:—Multiple Facebook/Meta references, —Urgency: “24 hours, Threats: “permanent” restrictions, Account violation language, Meta Platforms, Inc. footer, 4. **Links**: Legitimate Facebook links (terms, community standards), Primary malicious link: https://rebrand.ly/kz8xyqv (URL shortener), 5. **Authentication**: SPF: “none”.”

Additionally, or alternatively, in one or more embodiments, in response to the autonomous AI agent detecting (e.g., determining, generating, etc.) the message signature for the electronic communication, the autonomous AI agent may function to assess the message signature against the set of threat detection instructions and, in turn, determine a detection gap resolution operation to resolve the detection gap based on the assessment of the message signature against the set of threat detection instructions.

In a non-limiting example, the detection gap resolution operation may correspond to updating a respective threat detection instruction included in the set of threat detection instructions when the respective threat detection instruction is determined to be extensible to detect the message signature. Updating the respective threat detection instruction included in the set of threat detection instructions, in some embodiments, may include automatically identifying one or more additional message characteristics included in the message signature that are not evaluated by the respective threat detection instruction, generating one or more additional detection expressions configured to evaluate the one or more additional message characteristics, and modifying the respective threat detection instruction to include the one or more additional detection expressions. In this way, the autonomous AI agent may function to extend the detection logic of an existing threat detection instruction to detect electronic messages associated with the message signature, rather than generating a new threat detection instruction from scratch.

For instance, in one or more embodiments, the autonomous AI agent may determine that a respective threat detection instruction associated with suspicious attachment characteristics is extensible to detect the message signature based on the message signature including one or more additional attachment characteristics that are not evaluated by the respective threat detection instruction. In response to determining that the respective threat detection instruction is extensible to detect the message signature, the autonomous AI agent may generate one or more additional detection expressions configured to evaluate the one or more additional attachment characteristics and modify the respective threat detection instruction to include the one or more additional detection expressions, thereby extending detection coverage of the existing threat detection instruction to detect electronic messages associated with the message signature.

Additionally, or alternatively, in one or more embodiments, the autonomous AI agent may determine that a respective threat detection instruction associated with suspicious sender behavior is extensible to detect the message signature based on the message signature including one or more additional sender characteristics that are not evaluated by the respective threat detection instruction. In response to determining that the respective threat detection instruction is extensible to detect the message signature, the autonomous AI agent may generate one or more additional detection expressions configured to evaluate the one or more additional sender characteristics and modify the respective threat detection instruction to include the one or more additional detection expressions, thereby extending detection coverage of the existing threat detection instruction to detect electronic messages associated with the message signature.

Additionally, or alternatively, in one or more embodiments, modifying the respective threat detection instruction may include replacing one or more existing detection expressions encoded in the respective threat detection instruction with one or more modified detection expressions generated by the autonomous AI agent. For instance, in a non-limiting example, the autonomous AI agent may determine that a first detection expression encoded in the respective threat detection instruction is overly restrictive because the first detection expression requires a first suspicious sender characteristic and a first suspicious attachment characteristic to both be present for detection of an electronic message. In response to determining that the first detection expression is overly restrictive, the autonomous AI agent may modify the first detection expression by replacing a logical AND operator included in the first detection expression with a logical OR operator, thereby extending detection coverage of the respective threat detection instruction to detect additional electronic messages associated with the message signature.

Additionally, or alternatively, in one or more embodiments, modifying the respective threat detection instruction may include replacing one or more existing detection expressions encoded in the respective threat detection instruction with one or more modified detection expressions generated by the autonomous AI agent. For instance, in a non-limiting example, the autonomous AI agent may determine that a first detection expression encoded in the respective threat detection instruction is overly restrictive because the first detection expression only evaluates a first suspicious file extension included in the message signature. In response to determining that the first detection expression is overly restrictive, the autonomous AI agent may replace the first detection expression with a modified detection expression configured to evaluate both the first suspicious file extension and one or more additional suspicious file extensions included in with the message signature, thereby extending detection coverage of the respective threat detection instruction to detect additional electronic messages associated with the message signature.

In another non-limiting example, the detection gap resolution operation may correspond to generating a new threat detection instruction when no threat detection instruction included in the set of threat detection instructions is determined to be extensible to detect the message signature. Generating a new threat detection instruction, in some embodiments, may include generating, using a large language model associated with the autonomous AI agent, a plurality of new detection expressions configured to evaluate a plurality of message characteristics included in the message signature and combining the plurality of new detection expressions to form the new threat detection instruction. In some embodiments, the autonomous AI agent may generate the new threat detection instruction from scratch based on the message signature without relying on any preexisting threat detection instruction included in the set of threat detection instructions. Stated differently, the autonomous AI agent may generate the new threat detection instruction independent of any threat detection instruction included in the set of threat detection instructions. For instance, in a non-limiting example, the autonomous AI agent may determine that no threat detection instruction included in the set of threat detection instructions evaluates a combination of suspicious attachment characteristics, suspicious sender characteristics, and suspicious link characteristics included in the message signature. In response to determining that no threat detection instruction included in the set of threat detection instructions is extensible to detect the message signature, the autonomous AI agent may generate, from scratch, a new threat detection instruction that at least includes a first set of detection expressions configured to evaluate the suspicious attachment characteristics, a second set of detection expressions configured to evaluate the suspicious sender characteristics, and a third set of detection expressions configured to evaluate the suspicious link characteristics associated with the message signature.

At least one technical advantage of the systems, methods, embodiments, and computer program products described herein is that the autonomous AI agent may autonomously determine whether a detection gap is best resolved by extending an existing threat detection instruction or by generating a new threat detection instruction independent of any preexisting threat detection instruction. In this way, the autonomous AI agent may preserve and extend existing detection logic when appropriate while also autonomously generating new detection logic when no existing threat detection instruction is extensible to detect the message signature. Accordingly, the autonomous AI agent may improve operational efficiency and adaptability of the threat detection and response service by intelligently selecting between modification of existing threat detection instructions and autonomous generation of new threat detection instructions based on characteristics of the message signature.

Another technical advantage of the systems, methods, embodiments, and computer program products described herein is that the autonomous AI agent may autonomously determine whether a candidate threat detection instruction should be generated by extending detection logic of an existing threat detection instruction or by generating new detection logic independent of any preexisting threat detection instruction. In this way, the autonomous AI agent may preserve and extend existing detection logic when appropriate while also autonomously generating new detection logic when no existing threat detection instruction is extensible to detect the message signature. Accordingly, the autonomous AI agent may improve computational efficiency and adaptability of the threat detection and response service by intelligently selecting between autonomous modification of existing threat detection instructions and autonomous generation of new threat detection instructions based on characteristics of the message signature and the set of threat detection instructions.

Additionally, in one or more embodiments, a large language model associated with the autonomous AI agent may function to generate a candidate threat detection instruction in accordance with the detection gap resolution operation. It shall be recognized that, in some embodiments, the candidate threat detection instruction may be operably configured to (i) resolve the detection gap and (ii) detect suspicious electronic messages that correspond to the message signature. A candidate threat detection instruction, as generally referred to herein, may correspond to an intermediate or preliminary threat detection instruction generated by the autonomous AI agent before satisfaction of predetermined instruction performance criteria of the threat detection and response service. In some embodiments, the candidate threat detection instruction may be iteratively tested, validated, and modified by the autonomous AI agent and/or one or more AI subagents in operable communication with the autonomous AI agent prior to designation of the candidate threat detection instruction as a production-ready threat detection instruction.

In one or more embodiments, the autonomous AI agent may generate the candidate threat detection instruction using a knowledge base associated with or in operable communication with the autonomous AI agent. The knowledge base, in some embodiments, may correspond to a structured and/or unstructured repository of cybersecurity information accessible by the autonomous AI agent for generation, modification, validation, and optimization of candidate threat detection instructions and production-ready thread detection instructions. For example, in some embodiments, the knowledge base may include detection engineering best practices, the set of threat detection instructions, existing threat detection instruction patterns, predetermined attacker behaviors, tactics, techniques, and procedures (TTPs), historical threat intelligence data, message classification heuristics, enrichment function documentation, syntax requirements of the threat detection and response service (e.g., the syntax requirements required by a threat detection language associated with the threat detection and response service for successful execution of a threat detection instruction), operational performance criteria, and/or historical validation feedback associated with prior threat detection instructions. In some embodiments, the autonomous AI agent may function to retrieve one or more portions of the knowledge base based on the message signature and provide the retrieved portions of the knowledge base as contextual input to a large language model associated with the autonomous AI agent for generation of the candidate threat detection instruction. In this way, the autonomous AI agent may function to constrain and contextually ground generation of the candidate threat detection instruction using cybersecurity knowledge associated with the threat detection and response service, thereby improving syntactic compatibility, operational robustness, and detection effectiveness of candidate threat detection instructions generated by the large language model.

Detection engineering best practices, in one or more embodiments, may include recommended threat detection logic structures, false-positive mitigation heuristics, syntax formatting standards, rule optimization techniques, detection expression composition guidelines, enrichment function usage guidelines, performance tuning recommendations, threat detection language implementation constraints, and/or historical threat detection instruction modification patterns associated with successfully deployed production-ready threat detection instructions. For instance, in one or more embodiments, the detection engineering best practices may specify preferred usage patterns for one or more enrichment functions, recommended combinations of detection expressions associated with particular categories of malicious electronic messages, and/or one or more operational thresholds associated with false-positive rates, execution latency, detection coverage, or computational resource utilization of threat detection instructions executed by the threat detection and response service. In some embodiments, the autonomous AI agent may function to retrieve one or more detection engineering best practices associated with the message signature from the knowledge base and provide the retrieved detection engineering best practices to the large language model to control generation of the candidate threat detection instruction.

Existing threat detection instruction patterns, in one or more embodiments, may include predefined detection logic structures, reusable detection expression combinations, historical threat detection instruction templates, previously deployed production-ready threat detection instructions, and/or one or more common threat detection workflows associated with detection of particular categories of malicious electronic messages. For instance, in one or more embodiments, the existing threat detection instruction patterns may include one or more reusable detection logic patterns associated with business email compromise (BEC) attacks, credential phishing attacks, callback phishing attacks, malware delivery campaigns, QR-code phishing attacks, impersonation attacks, attachment-based attacks, and/or social engineering attacks. In some embodiments, the autonomous AI agent may function to retrieve one or more existing threat detection instruction patterns associated with the message signature from the knowledge base and provide the retrieved existing threat detection instruction patterns to the large language model to control generation of the candidate threat detection instruction.

Predetermined attacker behaviors, in one or more embodiments, may include predefined behavioral representations that encode tactics, techniques, and procedures (TTPs), social engineering behaviors, infrastructure usage patterns, evasion techniques, message delivery patterns, and/or historical malicious electronic message behaviors associated with known malicious electronic message attacks or attack campaigns. For instance, in one or more embodiments, the predetermined attacker behaviors may encode behavioral indicators associated with known business email compromise (BEC) attacks, credential phishing attacks, callback phishing attacks, malware delivery campaigns, impersonation attacks, QR-code phishing attacks, attachment-based attacks, and/or account takeover attacks. In some embodiments, the autonomous AI agent may function to retrieve one or more predetermined attacker behaviors associated with the message signature from the knowledge base and provide the retrieved predetermined attacker behaviors to the large language model to control generation of the candidate threat detection instruction.

Tactics, techniques, and procedures (TTPs), in one or more embodiments, may include predefined representations of known attacker methodologies, attack execution patterns, attack progression workflows, persistence mechanisms, evasion techniques, credential harvesting techniques, social engineering techniques, malware delivery techniques, lateral movement techniques, and/or infrastructure utilization patterns associated with known malicious electronic message attacks or attack campaigns. For instance, in one or more embodiments, the TTPs may encode one or more behavioral relationships between sender characteristics, message content characteristics, attachment characteristics, link characteristics, authentication characteristics, and/or message routing characteristics associated with a category of malicious electronic message attacks. In some embodiments, the autonomous AI agent may function to retrieve one or more TTPs associated with the message signature from the knowledge base and provide the retrieved TTPs to the large language model to control generation of the candidate threat detection instruction.

Historical threat intelligence data, in one or more embodiments, may include previously identified malicious electronic message characteristics, historical attack campaign data, indicators of compromise (IOCs), historical sender reputation data, historical infrastructure usage data, previously detected attack behaviors, prior threat investigation results, and/or historical detection outcomes associated with known malicious electronic message attacks or attack campaigns. For instance, in one or more embodiments, the historical threat intelligence data may encode one or more relationships between malicious sender domains, suspicious attachment characteristics, malicious link patterns, social engineering techniques, and/or message delivery behaviors previously associated with malicious electronic messages detected by the threat detection and response service. In some embodiments, the autonomous AI agent may function to retrieve one or more portions of the historical threat intelligence data associated with the message signature from the knowledge base and provide the retrieved historical threat intelligence data to the large language model to guide (e.g., control) generation of the candidate threat detection instruction.

Enrichment function documentation, in one or more embodiments, may include documentation describing one or more computer-executable enrichment functions accessible by the threat detection and response service, input parameters required by the one or more computer-executable enrichment functions, output data generated by the one or more computer-executable enrichment functions, invocation syntax for the one or more computer-executable enrichment functions, and/or usage constraints associated with executing the one or more computer-executable enrichment functions. For instance, in one or more embodiments, the enrichment function documentation may specify how to invoke a message screenshot enrichment function, a base64 scanning enrichment function, a file screenshot enrichment function, a link analysis enrichment function, a logo detection enrichment function, a macro classification enrichment function, an HTML screenshot enrichment function, and/or a natural language understanding enrichment function within a candidate threat detection instruction. In some embodiments, the autonomous AI agent may function to retrieve enrichment function documentation associated with one or more message characteristics included in the message signature from the knowledge base and provide the retrieved enrichment function documentation to the large language model to guide generation of the candidate threat detection instruction.

Syntax requirements of the threat detection and response service, in one or more embodiments, may include one or more grammar rules, expression formatting requirements, operator usage requirements, function invocation requirements, data type requirements, field reference requirements, nesting requirements, and/or execution constraints associated with a threat detection language used by the threat detection and response service. For instance, in one or more embodiments, the syntax requirements may specify valid detection expression formats, valid logical operators, valid field names, valid enrichment function calls, valid comparison operations, valid string-matching operations, and/or valid ordering of threat detection expressions within a candidate threat detection instruction. In some embodiments, the autonomous AI agent may function to retrieve, from the knowledge base, one or more syntax requirements based in part on the message signature and, in response, provide the retrieved syntax requirements to the large language model to guide generation of syntactically valid candidate threat detection instructions.

Operational performance criteria, in one or more embodiments, may include one or more predefined performance thresholds, deployment requirements, validation requirements, execution requirements, and/or detection effectiveness requirements associated with deployment of production-ready threat detection instructions within the threat detection and response service. For instance, in one or more embodiments, the operational performance criteria may specify acceptable false-positive thresholds, minimum detection coverage thresholds, execution latency thresholds, computational resource utilization thresholds, robustness thresholds, syntactic validation requirements, and/or historical hunt performance requirements associated with a candidate threat detection instruction. In some embodiments, the autonomous AI agent may function to retrieve one or more operational performance criteria associated with the message signature from the knowledge base and provide the retrieved operational performance criteria to the large language model to guide generation of the candidate threat detection instruction.

Historical validation feedback associated with prior threat detection instructions, in one or more embodiments, may include prior syntax validation results, prior deployment outcomes, prior threat hunt results, prior false-positive analysis results, prior robustness analysis results, prior execution failure results, and/or prior modification recommendations associated with previously generated candidate threat detection instructions or production-ready threat detection instructions. For instance, in one or more embodiments, the historical validation feedback may encode one or more relationships between particular categories of detection expressions and corresponding operational outcomes associated with previously deployed threat detection instructions. In some embodiments, the autonomous AI agent may function to retrieve one or more portions of the historical validation feedback associated with the message signature from the knowledge base and provide the retrieved historical validation feedback to the large language model to guide generation and modification of the candidate threat detection instruction.

For instance, in a non-limiting example, the autonomous AI agent may retrieve, from the knowledge base, one or more existing threat detection instruction patterns associated with credential phishing attacks, one or more predetermined attacker behaviors associated with impersonation-based malicious electronic messages, one or more TTPs associated with malicious link delivery techniques, syntax requirements associated with a threat detection language used by the threat detection and response service, and one or more operational performance criteria associated with acceptable false-positive thresholds for deployment of production-ready threat detection instructions. In response to retrieving the one or more portions of the knowledge base, the autonomous AI agent may provide the retrieved information as contextual input to the large language model for generation of the candidate threat detection instruction. In turn, the large language model may generate the candidate threat detection instruction based on the retrieved information such that the candidate threat detection instruction conforms with the syntax requirements of the threat detection and response service, incorporates one or more detection logic structures associated with the existing threat detection instruction patterns, evaluates one or more behavioral indicators encoded by the predetermined attacker behaviors and TTPs, and is optimized to satisfy the operational performance criteria associated with deployment of the production-ready threat detection instruction.

Additionally, in one or more embodiments, in response to the autonomous AI agent generating the candidate threat detection instruction, the autonomous AI agent may function to iteratively modify the candidate threat detection instruction over a plurality of iterations to generate a production-ready threat detection instruction that satisfies predetermined instruction performance criteria of the threat detection and response service, as shown generally by way of example in FIG. 8. For instance, in one or more embodiments, during a first iteration, the autonomous AI agent may execute one or more validation operations for the candidate threat detection instruction and identify one or more deficiencies associated with the candidate threat detection instruction based on results generated by the one or more validation operations. In response to identifying the one or more deficiencies, the autonomous AI agent may modify one or more detection expressions, logical operators, enrichment function invocations, syntax structures, and/or threshold conditions included in the candidate threat detection instruction to generate a modified candidate threat detection instruction for a subsequent iteration. In some embodiments, the autonomous AI agent may continue iteratively executing the one or more validation operations and modifying the candidate threat detection instruction until the candidate threat detection instruction satisfies the predetermined instruction performance criteria, at which point the autonomous AI agent may designate the candidate threat detection instruction as the production-ready threat detection instruction.

Predetermined instruction performance criteria of the threat detection and response service, in one or more embodiments, may include one or more predefined detection accuracy thresholds, one or more instruction evasion susceptibility thresholds, one or more predetermined instruction compute cost thresholds, one or more syntactic validity thresholds, one or more false-positive thresholds, one or more instruction execution performance thresholds, and/or one or more operational robustness thresholds associated with deployment of a production-ready threat detection instruction within the threat detection and response service. For instance, in one or more embodiments, the predetermined instruction performance criteria may specify a predetermined detection accuracy threshold associated with detecting malicious, spam-based, and/or graymail-based electronic messages, a predetermined instruction evasion susceptibility threshold associated with resistance of a candidate threat detection instruction to adversarial evasion techniques, and/or a predetermined instruction cost threshold associated with computational resource utilization, execution latency, enrichment function invocation overhead, or threat hunt execution costs associated with the candidate threat detection instruction. Additionally, or alternatively, in one or more embodiments, the predetermined instruction performance criteria may specify one or more predetermined syntactic validity thresholds associated with conformance of a candidate threat detection instruction to syntax requirements of a threat detection language (e.g., message query language (MQL)) associated with the threat detection and response service. For instance, in one or more embodiments, the predetermined syntactic validity thresholds may require that the candidate threat detection instruction include syntactically valid detection expressions, syntactically valid logical operators, syntactically valid field references, syntactically valid enrichment function invocations, syntactically valid comparison operations, and/or syntactically valid nesting structures associated with the threat detection language of the threat detection and response service. For instance, in one or more embodiments, the autonomous AI agent and/or one or more AI subagents in operable communication with the autonomous AI agent may determine that a candidate threat detection instruction satisfies the predetermined instruction performance criteria based on determining that the candidate threat detection instruction satisfies the predetermined detection accuracy threshold, satisfies the predetermined instruction evasion susceptibility threshold, satisfies the predetermined instruction compute cost threshold, satisfies the one or more predetermined syntactic validity thresholds, satisfies the one or more false-positive thresholds, satisfies the one or more instruction execution performance thresholds, and/or satisfies the one or more operational robustness thresholds associated with deployment of the production-ready threat detection instruction within the threat detection and response service.

At least one technical advantage of the systems, methods, embodiments, and computer program products described herein is that the autonomous AI agent may autonomously and iteratively modify candidate threat detection instructions until the candidate threat detection instructions satisfy predetermined instruction performance criteria of the threat detection and response service, rather than blindly relying on an initial threat detection instruction generated by a large language model. In this way, the autonomous AI agent may improve syntactic validity, detection accuracy, operational robustness, resistance to adversarial evasion techniques, and computational efficiency of production-ready threat detection instructions deployed within the threat detection and response service. Additionally, in one or more embodiments, iterative validation and modification of candidate threat detection instructions using the predetermined instruction performance criteria may reduce false-positive detections, reduce deployment of syntactically invalid threat detection instructions, reduce computational overhead associated with inefficient threat detection instructions, and improve overall operational effectiveness of the threat detection and response service.

It shall be recognized that, in one or more embodiments, a production-ready threat detection instruction may correspond to a threat detection instruction that satisfies the predetermined instruction performance criteria of the threat detection and response service and is approved for operational deployment within the threat detection and response service. In some embodiments, the production-ready threat detection instruction may correspond to a threat detection instruction that has been syntactically validated, operationally validated, iteratively tested, and iteratively modified by the autonomous AI agent and/or one or more AI subagents in operable communication with the autonomous AI agent. For instance, in one or more embodiments, the production-ready threat detection instruction may correspond to a threat detection instruction that satisfies one or more predetermined detection accuracy thresholds, one or more instruction evasion susceptibility thresholds, one or more predetermined instruction compute cost thresholds, one or more false-positive thresholds, one or more syntactic validity thresholds associated with a threat detection language of the threat detection and response service, and/or one or more operational robustness thresholds associated with deployment of the production-ready threat detection instruction within the threat detection and response service. Additionally, or alternatively, in one or more embodiments, the production-ready threat detection instruction may correspond to a threat detection instruction configured to detect malicious, spam-based, and/or graymail-based electronic messages associated with the message signature while maintaining operational compatibility with the threat detection and response service. For instance, in one or more embodiments, the production-ready threat detection instruction may include one or more syntactically valid detection expressions, one or more syntactically valid enrichment function invocations, one or more syntactically valid logical operators, and/or one or more syntactically valid field references associated with a threat detection language of the threat detection and response service. In one or more embodiments, the production-ready threat detection instruction may be electronically deployed within a production computing environment associated with the threat detection and response service in response to designation of the production-ready threat detection instruction by the autonomous AI agent. For instance, in one or more embodiments, the autonomous AI agent may electronically deploy the production-ready threat detection instruction to one or more computing environments associated with one or more subscribing entities, thereby enabling the threat detection and response service to detect additional malicious electronic messages associated with the message signature that previously evaded detection due to the detection gap.

Accordingly, in one or more embodiments, in response to generating the production-ready threat detection instruction, the autonomous AI agent or the threat detection and response service may function to (i) automatically display the production-ready threat detection instruction on a graphical user interface that is accessible by a subscribing entity that received the electronic message or (ii) automatically deploy, within the threat detection and response service, the production-ready threat detection instruction to resolve the detection gap and prevent future electronic messages corresponding to the message signature from evading the set of threat detection instructions.

In one or more embodiments, the autonomous AI agent may be encoded with one or more deployment authorization parameters that specify that a production-ready threat detection instruction satisfying the predetermined instruction performance criteria of the threat detection and response service is required to be reviewed and approved by an administrative user associated with the subscribing entity prior to deployment within the threat detection and response service. For instance, in one or more embodiments, in response to generating the production-ready threat detection instruction and determining that the production-ready threat detection instruction satisfies the predetermined instruction performance criteria of the threat detection and response service, the autonomous AI agent may automatically display the production-ready threat detection instruction via the graphical user interface and await approval from the administrative user before electronically deploying the production-ready threat detection instruction within the production computing environment associated with the subscribing entity.

In one or more embodiments, the autonomous AI agent may be encoded with one or more deployment authorization parameters that specify that a production-ready threat detection instruction satisfying the predetermined instruction performance criteria of the threat detection and response service is automatically deployable without requiring review and approval by an administrative user associated with the subscribing entity. For instance, in one or more embodiments, in response to generating the production-ready threat detection instruction and determining that the production-ready threat detection instruction satisfies the predetermined instruction performance criteria of the threat detection and response service, the autonomous AI agent may automatically deploy the production-ready threat detection instruction within the production computing environment associated with the subscribing entity to resolve the detection gap and prevent future electronic messages corresponding to the message signature from evading detection.

It shall be recognized that, in one or more embodiments, the autonomous AI agent may include one or more large language models, one or more orchestration engines, one or more knowledge retrieval engines, one or more instruction validation engines, one or more threat hunt engines, one or more enrichment engines, one or more rule modification engines, one or more subagents, and/or one or more decision engines operably configured to autonomously generate, validate, iteratively modify, and deploy production-ready threat detection instructions within the threat detection and response service. In some embodiments, the autonomous AI agent may operate according to a multi-agent architecture in which the autonomous AI agent delegates one or more specialized operations associated with generation, validation, analysis, optimization, and/or modification of candidate threat detection instructions to one or more specialized AI subagents in operable communication with the autonomous AI agent.

In one or more embodiments, the one or more orchestration engines associated with the autonomous AI agent may function to coordinate execution of one or more operations associated with generation and validation of candidate threat detection instructions. For instance, in one or more embodiments, the orchestration engine may function to receive message data associated with an electronic message that evaded detection, invoke one or more enrichment functions to derive a message signature associated with the electronic message, retrieve one or more portions of a knowledge base associated with the message signature, provide the message signature and the retrieved portions of the knowledge base as contextual input to a large language model associated with the autonomous AI agent, and coordinate one or more iterative validation and modification operations associated with a candidate threat detection instruction generated by the large language model.

In one or more embodiments, the one or more knowledge retrieval engines associated with the autonomous AI agent may function to retrieve one or more portions of the knowledge base associated with the message signature, the detection gap resolution operation, and/or the candidate threat detection instruction. For instance, in one or more embodiments, the knowledge retrieval engine may retrieve one or more detection engineering best practices, one or more existing threat detection instruction patterns, one or more historical validation feedback records, one or more syntax requirements associated with a threat detection language of the threat detection and response service, and/or one or more historical threat intelligence records associated with the message signature.

In one or more embodiments, the one or more instruction validation engines associated with the autonomous AI agent may function to validate a candidate threat detection instruction against one or more predetermined instruction performance criteria of the threat detection and response service. For instance, in one or more embodiments, the instruction validation engine may function to determine whether the candidate threat detection instruction satisfies one or more syntactic validity thresholds associated with a threat detection language of the threat detection and response service, satisfies one or more detection accuracy thresholds, satisfies one or more false-positive thresholds, satisfies one or more instruction evasion susceptibility thresholds, and/or satisfies one or more predetermined instruction compute cost thresholds.

In one or more embodiments, the one or more threat hunt engines associated with the autonomous AI agent may function to execute one or more threat hunt operations using the candidate threat detection instruction against one or more corpora of historical electronic messages associated with one or more subscribing entities. For instance, in one or more embodiments, the threat hunt engine may function to identify historical electronic messages detected by the candidate threat detection instruction, generate hunt findings data associated with the detected historical electronic messages, and provide the hunt findings data to the autonomous AI agent and/or the one or more AI subagents for assessment of false-positive rates, detection coverage, operational robustness, and/or instruction restrictiveness associated with the candidate threat detection instruction.

In one or more embodiments, the one or more rule modification engines associated with the autonomous AI agent may function to iteratively modify one or more portions of the candidate threat detection instruction responsive to one or more validation results generated by the one or more instruction validation engines, the one or more threat hunt engines, and/or the one or more AI subagents. For instance, in one or more embodiments, the rule modification engine may function to modify one or more detection expressions, logical operators, enrichment function invocations, comparison operations, field references, threshold values, and/or nesting structures encoded in the candidate threat detection instruction responsive to determining that the candidate threat detection instruction fails to satisfy one or more predetermined instruction performance criteria of the threat detection and response service.

In one or more embodiments, the one or more AI subagents associated with the autonomous AI agent may include one or more syntax analysis subagents, one or more false-positive analysis subagents, one or more robustness analysis subagents, one or more hunt result analysis subagents, one or more enrichment analysis subagents, and/or one or more detection optimization subagents. For instance, in one or more embodiments, a robustness analysis subagent may function to assess whether a candidate threat detection instruction is susceptible to adversarial evasion techniques based on determining whether the candidate threat detection instruction relies on brittle indicators of compromise, direct string matching operations, or hardcoded message characteristics rather than behavioral detection logic associated with attacker tactics, techniques, and procedures (TTPs).

In one or more embodiments, the autonomous AI agent may iteratively invoke the one or more orchestration engines, the one or more instruction validation engines, the one or more threat hunt engines, the one or more rule modification engines, and/or the one or more AI subagents over a plurality of iterations until the candidate threat detection instruction satisfies the predetermined instruction performance criteria of the threat detection and response service. In response to determining that the candidate threat detection instruction satisfies the predetermined instruction performance criteria, the autonomous AI agent may designate the candidate threat detection instruction as the production-ready threat detection instruction and electronically deploy the production-ready threat detection instruction within the threat detection and response service, as shown generally by way of example in FIGS. 2A-2B.

### Example Instances of Iteratively Modifying the Candidate Threat Detection Instruction to Generate the Production-Ready Threat Detection Instruction Based in Part on Detection Accuracy

In one or more embodiments, in response to generating the candidate threat detection instruction, the autonomous AI agent may function to automatically execute, using one or more processors, a first threat hunt that assesses a plurality of historical electronic messages that occurred during a target time span (e.g., past year, past six months, etc.) against the candidate threat detection instruction. In such an embodiment, the autonomous AI agent may receive hunt findings data in response to performing or executing the first threat hunt. The hunt findings data, in one or more embodiments, may include a total number of true positive electronic messages that the candidate threat detection instruction correctly detected as malicious, a total number of false positive electronic messages that the candidate threat detection instruction incorrectly detected as malicious, and a total number of unique true positive electronic messages that (a) the candidate threat detection instruction correctly detected as malicious and (b) were not detected as malicious by any other threat detection instructions included in the set of threat detection instructions provided by the threat detection and response service. It shall be recognized that, in some embodiments, a threat hunt may correspond to an automated operation in which a candidate threat detection instruction is executed against the plurality of historical electronic messages to determine how the candidate threat detection instruction would have performed within the threat detection and response service if deployed during the target time span.

In one or more embodiments, in response to the autonomous AI agent receiving the hunt findings data associated with the first threat hunt, the autonomous AI agent may function to route the hunt findings data to a subagent in operable communication with the autonomous AI agent. In such an embodiment, in response to the subagent receiving the hunt findings data, the subagent may function to compute a detection accuracy score for the candidate threat detection instruction based on the hunt findings data associated with the first threat hunt. For instance, in a non-limiting example, the detection accuracy score for the candidate threat detection instruction may be computed using the total number of true positive electronic messages, the total number of false positive electronic messages, and the total number of unique true positive electronic messages. In another non-limiting example, the detection accuracy score for the candidate threat detection instruction may be computed as

$$\frac{1}{2} ( \frac{total number of true positive electronic messages}{\begin{matrix}total number of true positive electronic messages + \\ total number of false positive electronic messages\end{matrix}} + \frac{total number of unique true positive electronic messages}{\begin{matrix}total number of true positive electronic messages + \\ total number of false positive electronic messages\end{matrix}} ) .$$

It shall be recognized that, in some embodiments, the total number of true positive electronic messages that the candidate threat detection instruction correctly detected as malicious electronic messages may correspond to a quantity of historical electronic messages that satisfy detection logic encoded in the candidate threat detection instruction and that are confirmed by the threat detection and response service as malicious electronic messages. Additionally, or alternatively, in some embodiments, the total number of false positive electronic messages may correspond to a quantity of historical electronic messages that satisfy the detection logic encoded in the candidate threat detection instruction but that are confirmed by the threat detection and response service as benign electronic messages. Furthermore, in one or more embodiments, the total number of unique true positive electronic messages may correspond to a quantity of historical electronic messages that satisfy the detection logic encoded in the candidate threat detection instruction and that were not detected as malicious electronic messages by any other threat detection instructions included in the set of threat detection instructions.

At least one technical benefit of the systems, methods, and computer program products described herein is that the autonomous AI agent (or corresponding subagent) may quantitatively evaluate operational effectiveness of a candidate threat detection instruction using precision-based detection metrics derived from execution of one or more threat hunts. In particular, by computing the detection accuracy score using the total number of true positive electronic messages, the total number of false positive electronic messages, and the total number of unique true positive electronic messages identified by the candidate threat detection instruction, the autonomous AI agent may determine whether the candidate threat detection instruction both accurately detects malicious electronic messages and provides increased detection coverage beyond the set of threat detection instructions already deployed within the threat detection and response service. In this way, the autonomous AI agent may reduce deployment of overly broad candidate threat detection instructions that incorrectly classify benign electronic messages as malicious while simultaneously prioritizing candidate threat detection instructions that identify malicious electronic messages not detected by existing threat detection instructions, thereby improving overall detection coverage and effectiveness of the threat detection and response service.

In one or more embodiments, in response to computing the detection accuracy score for the candidate threat detection instruction, the subagent may function to detect that the detection accuracy score computed for the candidate threat detection instruction fails to satisfy the predetermined instruction performance criteria of the threat detection and response service (e.g., a predetermined minimum detection accuracy score threshold or the like). In such an embodiment, the subagent may function to assess the hunt findings data associated with the candidate threat detection instruction and, in response, generate one or more instruction modification recommendations that specifies how detection logic encoded in the candidate threat detection instruction should be modified to improve the detection accuracy score associated with the candidate threat detection instruction. For instance, in one or more embodiments, the one or more instruction modification recommendations may specify that one or more detection expressions encoded in the candidate threat detection instruction should be broadened, narrowed, replaced, removed, combined, and/or supplemented with one or more additional detection expressions to increase the detection accuracy score.

Accordingly, in such an embodiment, the subagent may function to provide the one or more instruction modification recommendations to the autonomous AI agent and, in response, the one or more instruction modification recommendations generated by the subagent to the large language model associated with the autonomous AI agent. Furthermore, in such an embodiment, the large language model associated with the autonomous AI agent may generate a second candidate threat detection instruction by modifying detection logic encoded in the candidate threat detection instruction in accordance with the one or more instruction modification recommendations. Stated another way, in one or more embodiments, in response to detecting the detection accuracy score computed for the candidate threat detection instruction fails to satisfy the predetermined instruction performance criteria of the threat detection and response service, the autonomous AI agent may generate, using the large language model associated with the autonomous AI agent, a second candidate threat detection instruction by modifying detection logic encoded in the candidate threat detection instruction. In other words, the “first candidate threat detection instruction” is the initial version generated by the autonomous AI agent and/or the large language model based on the message signature and the detection gap resolution operation. The “second candidate threat detection instruction” is a modified version of the first candidate threat detection instruction that is generated after the autonomous AI agent determines that the first candidate threat detection instruction fails to satisfy the predetermined instruction performance criteria of the threat detection and response service.

Additionally, in one or more embodiments, in response to generating the second candidate threat detection instruction, the autonomous AI agent may function to execute a second threat hunt that assesses the plurality of historical electronic messages that occurred during the target time span against the second candidate threat detection instruction. In such an embodiment, the subagent in operable communication with the autonomous AI agent may function to compute a detection accuracy score for the second candidate threat detection instruction using new hunt findings data received from the second threat hunt. It shall be recognized that the detection accuracy score computed for the second candidate threat detection instruction may be computed in analogous ways as described above. For instance, in a non-limiting example, the subagent may compute the detection accuracy score for the second candidate threat detection instruction using a second total number of true positive electronic messages correctly classified by the second candidate threat detection instruction, a second total number of false positive electronic messages incorrectly classified by the second candidate threat detection instruction, and a second total number of unique true positive electronic messages detected by the second candidate threat detection instruction during execution of the second threat hunt.

Accordingly, in one or more embodiments, the subagent in operable communication with the autonomous AI agent may function to determine that the detection accuracy score computed for the second candidate threat detection satisfies the predetermined instruction performance criteria (e.g., the predetermined minimum detection accuracy score threshold or the like) of the threat detection and response service. In such an embodiment, in response to identifying the second candidate threat detection instruction satisfies the predetermined instruction performance criteria of the threat detection and response service, the autonomous AI agent may function to designate the second candidate threat detection instruction as the production-ready threat detection instruction.

It shall be recognized that references herein to the “second candidate threat detection instruction” are provided for explanatory purposes and should not be construed as limiting the systems, methods, embodiments, and computer program products described herein to a single iterative modification operation or a fixed quantity of iterations. In one or more embodiments, the autonomous AI agent may iteratively generate and assess any quantity of modified candidate threat detection instructions until a respective candidate threat detection instruction satisfies the predetermined instruction performance criteria of the threat detection and response service. For instance, in some embodiments, the autonomous AI agent may generate a third candidate threat detection instruction, a fourth candidate threat detection instruction, a fifteenth candidate threat detection instruction, a one-hundredth candidate threat detection instruction, and/or any other quantity of iteratively modified candidate threat detection instructions responsive to one or more corresponding threat hunts and detection accuracy scores indicating that a preceding candidate threat detection instruction failed to satisfy the predetermined instruction performance criteria of the threat detection and response service. Accordingly, the autonomous AI agent may iteratively modify detection logic encoded in a candidate threat detection instruction over any quantity of iterations until the autonomous AI agent determines that a respective candidate threat detection instruction satisfies the predetermined instruction performance criteria of the threat detection and response service and should be designated as the production-ready threat detection instruction.

At least one technical benefit of the systems, methods, embodiments, and computer program products described herein is that the autonomous AI agent may improve detection accuracy of candidate threat detection instructions by iteratively validating and modifying the candidate threat detection instructions using historical threat hunt operations prior to deployment within the threat detection and response service.

### Example Instances of Iteratively Modifying the Candidate Threat Detection Instruction to Generate the Production-Ready Threat Detection Instruction Based in Part on Instruction Evasion Susceptibility

Additionally, or alternatively, in one or more embodiments, in response to generating the candidate threat detection instruction, a subagent in operable communication with the autonomous AI agent may function to compute an instruction evasion susceptibility score for the candidate threat detection instruction. An instruction evasion susceptibility score, in one or more embodiments, may correspond to a quantitative measure of a susceptibility of the candidate threat detection instruction to adversarial evasion attempts based on an assessment of detection logic encoded in the candidate threat detection instruction. In other words, the instruction evasion susceptibility score may quantify a likelihood that the candidate threat detection instruction may be circumvented, bypassed, degraded, or rendered ineffective by one or more adversarial inputs, prompt injection techniques, obfuscation techniques, instruction-conflict techniques, or context-manipulation techniques.

For instance, in a non-limiting example, the subagent may function to identify (i) a total number of detection expressions encoded in the candidate threat detection instruction that rely on exact string matching of indicators of compromise values and (ii) a total number of detection expressions encoded in the candidate threat detection instruction that models attacker behaviors instead of relying on exacting string matching of the indicators of compromise values and, in response, compute the instruction evasion susceptibility score for the candidate threat detection instruction based on the total number of detection expressions encoded in the candidate threat detection instruction that rely on exact string matching of indicators of compromise values and the total number of detection expressions encoded in the candidate threat detection instruction that models attacker behaviors instead of relying on exacting string matching of the indicators of compromise values.

Indicators of compromise (IOCs), in one or more embodiments, may correspond to discrete or static artifacts associated with malicious electronic messages, including hardcoded domains, Internet Protocol (IP) addresses, file hashes, sender addresses, URLs, subject lines, attachment names, and/or other static identifiers associated with known malicious activity.

Exact string matching, in one or more embodiments, may correspond to detection logic that requires an exact textual match between a target message characteristic included in an electronic message and a predefined IOC value encoded in the candidate threat detection instruction. In other words, exact string-matching detection logic may only detect an electronic message when the target message characteristic exactly corresponds to the predefined IOC value without variation, substitution, modification, or deviation from the predefined IOC value encoded in the candidate threat detection instruction. For instance, in a non-limiting example, the candidate threat detection instruction may include a detection expression configured to detect an electronic message as malicious only when a sender domain (e.g., IOC) exactly matches “malicious-domain-example.com.” In such an embodiment, an attacker may evade detection by modifying the sender domain to “malicious-domain-example.net,” “mail-malicious-domain-example.com,” or another variation of the predefined IOC value that does not exactly correspond to the predefined IOC value (e.g., the sender domain) encoded in the candidate threat detection instruction.

Attacker behaviors, in one or more embodiments, may correspond to behavioral characteristics, tactics, techniques, and procedures (TTPs), communication patterns, impersonation strategies, social engineering techniques, sender reputation patterns, historical message behaviors, and/or other behavioral indicators associated with malicious activity that remain detectable despite modification of one or more static IOCs associated with the malicious electronic message. In other words, attacker behavior-based detection logic may detect malicious electronic messages based on how an attacker operates or behaves rather than requiring an exact textual match with a predefined IOC value encoded in the candidate threat detection instruction. For instance, in a non-limiting example, a candidate threat detection instruction may detect an electronic message as malicious based on the electronic message including a newly registered sender domain, impersonation language associated with executive personnel, abnormal reply-to behavior, and an out-of-band credential request, even when the sender domain, URLs, subject lines, and/or other static IOC values associated with the malicious electronic message have not been previously observed by the threat detection and response service.

Additionally, or alternatively, in one or more embodiments, in response to computing the instruction evasion susceptibility score for the candidate threat detection instruction, the subagent in operable communication with the autonomous AI agent may function to detect that the instruction evasion susceptibility score computed for the candidate threat detection instruction fails to satisfy the predetermined instruction performance criteria of the threat detection and response service (e.g., a predetermined minimum instruction evasion susceptibility score threshold or the like). In other words, the subagent may determine that the candidate threat detection instruction is not robust against adversarial evasion attempts because detection logic encoded in the candidate threat detection instruction relies too heavily on exact string-matching detection operations rather than behavioral-based detection logic associated with attacker behaviors, tactics, techniques, and procedures (TTPs). Stated differently, the subagent may determine that relatively minor modifications to the message signature (e.g., changing the sender domain, changing the internet protocol address, etc.) may prevent the candidate threat detection instruction from detecting electronic messages substantially similar to the message signature as malicious even though underlying attacker behaviors associated with the electronic messages remain (e.g., substantially) unchanged.

In one or more embodiments, in response to detecting the instruction evasion susceptibility score computed for the candidate threat detection instruction fails to satisfy the predetermined instruction performance criteria (e.g., the predetermined minimum instruction evasion susceptibility score threshold), the large language model associated with the autonomous AI agent may function to generate a second candidate threat detection instruction by modifying detection logic encoded in the candidate threat detection instruction to reduce reliance on exact string-matching detection operations and increase reliance on behavioral-based detection logic. For instance, in a non-limiting example, the large language model associated with the autonomous AI agent may replace a target exact string-matching detection expression encoded in the candidate threat detection instruction with a respective behavioral-based detection expression. In this way, the second candidate threat detection instruction may be less susceptible to adversarial evasion attempts when compared to the candidate threat detection instruction because the second candidate threat detection instruction includes less exact string-matching detection logic.

In one or more embodiments, in response to generating the second candidate threat detection instruction, the subagent in operable communication with the autonomous AI agent may function to compute an instruction evasion susceptibility score for the second candidate threat detection instruction. For instance, in a non-limiting example, the subagent may function to identify (i) a total number of detection expressions encoded in the second candidate threat detection instruction that rely on exact string matching of indicators of compromise values and (ii) a total number of detection expressions encoded in the second candidate threat detection instruction that models attacker behaviors instead of relying on exacting string matching of the indicators of compromise values and, in response, compute the instruction evasion susceptibility score for the second candidate threat detection instruction using the total number of detection expressions encoded in the second candidate threat detection instruction that rely on exact string matching of indicators of compromise values and the total number of detection expressions encoded in the second candidate threat detection instruction that models attacker behaviors instead of relying on exacting string matching of the indicators of compromise values.

In such an embodiment, the subagent in operable communication with the autonomous AI agent may determine that the instruction evasion susceptibility score computed for the second candidate threat detection instruction satisfies the predetermined instruction performance criteria based on the instruction evasion susceptibility score computed for the second candidate threat detection instruction being greater than the predetermined minimum instruction evasion susceptibility score threshold specified by the threat detection and response service. In other words, the subagent in operable communication with the autonomous AI agent may function to identify or determine that the instruction evasion susceptibility score computed for the second candidate threat detection satisfies the predetermined instruction performance criteria of the threat detection and response service. Accordingly, in one or more embodiments, in response to identifying the second candidate threat detection instruction satisfies the predetermined instruction performance criteria of the threat detection and response service, the autonomous AI agent may function to designate the second candidate threat detection instruction as the production-ready threat detection instruction.

It shall be recognized that references herein to the “second candidate threat detection instruction” are provided for explanatory purposes and should not be construed as limiting the systems, methods, embodiments, and computer program products described herein to a single iterative modification operation or a fixed quantity of iterations. In one or more embodiments, the autonomous AI agent may iteratively generate and assess any quantity of modified candidate threat detection instructions until a respective candidate threat detection instruction satisfies the predetermined instruction performance criteria of the threat detection and response service. For instance, in some embodiments, the autonomous AI agent may generate a third candidate threat detection instruction, a fourth candidate threat detection instruction, a fifteenth candidate threat detection instruction, a one-hundredth candidate threat detection instruction, and/or any other quantity of iteratively modified candidate threat detection instructions responsive to a preceding candidate threat detection instruction failing to satisfy the predetermined instruction performance criteria of the threat detection and response service. Accordingly, the autonomous AI agent may iteratively modify detection logic encoded in a candidate threat detection instruction over any quantity of iterations until the autonomous AI agent determines that a respective candidate threat detection instruction satisfies the predetermined instruction performance criteria of the threat detection and response service and should be designated as the production-ready threat detection instruction.

At least one technical benefit of the systems, methods, embodiments, and computer program products described herein is that the autonomous AI agent may autonomously evaluate and iteratively improve robustness of candidate threat detection instructions against adversarial evasion attempts prior to deployment within the threat detection and response service. In particular, by computing the instruction evasion susceptibility score based on a quantity of exact string-matching detection expressions encoded in a candidate threat detection instruction relative to a quantity of behavioral-based detection expressions encoded in the candidate threat detection instruction, the autonomous AI agent may determine whether the candidate threat detection instruction relies too heavily on brittle detection logic that may be circumvented through relatively minor modifications to the message signature associated with the malicious electronic message. That is, the autonomous AI agent may iteratively modify detection logic encoded in candidate threat detection instructions to reduce reliance on static indicators of compromise values and increase reliance on behavioral-based detection logic associated with attacker behaviors, tactics, techniques, and procedures (TTPs), thereby improving resiliency of production-ready threat detection instructions against adversarial evasion attempts.

### Example Instances of Iteratively Modifying the Candidate Threat Detection Instruction to Generate the Production-Ready Threat Detection Instruction Based in Part on Instruction Cost

Additionally, or alternatively, in one or more embodiments, the autonomous AI agent may iteratively modify the candidate threat detection instruction until the predetermined instruction performance criteria of the threat detection and response service is satisfied or a predetermined instruction cost criterion is satisfied. A predetermined instruction cost criterion, in some embodiments, may correspond to one or more predefined computational, operational, temporal, resource-utilization, iteration-based, and/or execution-related constraints associated with generation, modification, validation, testing, deployment, and/or maintenance of candidate threat detection instructions by the autonomous AI agent and/or the threat detection and response service.

In one or more embodiments, the autonomous AI agent may detect that the predetermined instruction cost criterion is satisfied and, in response, the autonomous AI agent may designate a most recent candidate threat detection instruction generated over the plurality of iterations as the production-ready threat detection instruction. Additionally, in such an embodiment, in response to detecting that the predetermined instruction cost criterion is satisfied, the large language model associated with the autonomous AI agent may generate explanatory data describing feedback data received from one or more subagents in operable communication with autonomous AI agent over the plurality of iterations and (b) one or more tradeoffs associated with the production-ready threat detection instruction. Accordingly, in such an embodiment, the threat detection and response service may function to display the one or more tradeoffs for the production-ready threat detection instruction in association with the production-ready threat detection instruction on the graphical user interface.

The explanatory data, in one or more embodiments, may include one or more computer-readable outputs generated by the autonomous AI agent and/or the large language model associated with the autonomous AI agent that describe (i) one or more iterative modifications performed to candidate threat detection instructions over the plurality of iterations, (ii) one or more feedback signals, hunt findings data, validation failures, syntax failures, detection accuracy scores, instruction evasion susceptibility scores, and/or other assessment data generated by one or more subagents in operable communication with the autonomous AI agent during the plurality of iterations, and/or (iii) one or more tradeoffs associated with designating the most recent candidate threat detection instruction as the production-ready threat detection instruction responsive to satisfaction of the predetermined instruction cost criterion. For instance, in a non-limiting example, the explanatory data may specify that the autonomous AI agent generated a plurality of iteratively modified candidate threat detection instructions responsive to repeated threat hunt operations indicating that preceding candidate threat detection instructions were overly restrictive and failed to detect historical electronic messages associated with a target attack pattern, and that the production-ready threat detection instruction was designated after the autonomous AI agent predicted that additional iterative modifications to the candidate threat detection instruction would be unlikely to improve detection performance relative to computational cost, iteration count, execution latency, or resource utilization associated with further iterative modification operations.

The feedback data received by the autonomous AI agent, in one or more embodiments, may correspond to one or more computer-readable outputs generated by the one or more subagents in operable communication with the autonomous AI agent during iterative generation, validation, assessment, and modification of candidate threat detection instructions. For instance, in one or more embodiments, the feedback data may include one or more indications that a candidate threat detection instruction is overly restrictive, overly broad, syntactically invalid, computationally inefficient, susceptible to adversarial evasion attempts, and/or otherwise fails to satisfy one or more predetermined instruction performance criteria associated with the threat detection and response service. Additionally, or alternatively, the feedback data may include one or more recommended modifications to detection logic encoded in a candidate threat detection instruction, including recommendations to broaden, narrow, replace, remove, combine, reorder, and/or supplement one or more detection expressions encoded in the candidate threat detection instruction. In this way, the feedback data may enable the autonomous AI agent and/or the large language model associated with the autonomous AI agent to iteratively modify candidate threat detection instructions over the plurality of iterations in accordance with the feedback data received from the one or more subagents.

The one or more tradeoffs associated with the production-ready threat detection instruction, in one or more embodiments, may correspond to one or more operational compromises, performance limitations, detection coverage limitations, false-positive risks, computational cost considerations, robustness considerations, and/or deployment considerations associated with designating the most recent candidate threat detection instruction as the production-ready threat detection instruction responsive to satisfaction of the predetermined instruction cost criterion. For instance, in one or more embodiments, the one or more tradeoffs may specify that the production-ready threat detection instruction remains more restrictive than desired, includes reduced detection coverage for one or more attack patterns, relies on broader detection expressions that may increase false-positive detections, and/or excludes one or more computationally expensive detection expressions to satisfy one or more computational resource utilization thresholds associated with the threat detection and response service.

It shall be recognized that, in one or more embodiments, the predetermined instruction cost criterion may be satisfied when the autonomous AI agent determines that feedback data received from a first iteration of the plurality of iterations and feedback data received from a subsequent iteration (e.g., the next iteration) of the plurality of iterations are equivalent, substantially similar, repetitive, and/or otherwise indicate that continued iterative modification of the candidate threat detection instruction is unlikely to produce meaningful improvements in operational performance of the candidate threat detection instruction relative to computational, operational, temporal, and/or resource-utilization costs. For instance, in a non-limiting example, the hunt findings data (e.g., feedback data) received from the first iteration may indicate that a first modified candidate threat detection instruction failed to detect any historical electronic messages associated with a target attack pattern because the first modified candidate threat detection instruction was overly restrictive, and the hunt findings data (e.g., feedback data) received from the subsequent iteration may similarly indicate that a second modified candidate threat detection instruction also failed to detect any historical electronic messages associated with the target attack pattern. In such an embodiment, the autonomous AI agent may determine that the hunt findings data associated with the first iteration and the subsequent iteration are equivalent or substantially similar and, in response, designate the second candidate threat detection instruction as the production-ready threat detection instruction.

### Example Instances of Iteratively Modifying the Candidate Threat Detection Instruction to Generate the Production-Ready Threat Detection Instruction Based in Part on Syntax Validation and Hunt Findings Data

Additionally, or alternatively, in one or more embodiments, in response to generating the candidate threat detection instruction, the autonomous AI agent may function to detect that at least one detection expression encoded in the candidate threat detection instruction does not conform to syntax requirements defined by the threat detection and response service. The at least one detection expression, in one or more embodiments, may include one or more logical operators, one or more comparison operations, one or more field references, one or more enrichment function invocations, one or more variable references, one or more conditional statements, one or more nested structures, one or more query constructs, and/or one or more pattern-matching expressions that do not conform to the syntax requirements defined by the threat detection and response service. In such an embodiment, in response to detecting that the at least one detection expression encoded in the candidate threat detection instruction does not conform to the syntax requirements defined by the threat detection and response service, the large language model associated with the autonomous AI agent may function to generate a second candidate threat detection instruction by modifying the at least one detection expression to conform to the syntax requirements defined by the threat detection and response service.

Additionally, in such an embodiment, in response to the generating the second candidate threat detection instruction, the autonomous AI agent may function to assess the second candidate threat detection instruction against the electronic message and, in turn, confirm that the second candidate threat detection instruction detects the electronic message as malicious, spam, or graymail. In one or more embodiments, in response to confirming that the second candidate threat detection instruction detects the electronic message as malicious, spam, or graymail, the autonomous AI agent may function to automatically execute a first threat hunt that assesses a plurality of historical electronic messages of the subscribing entity using the second candidate threat detection instruction.

In one or more embodiments, the autonomous AI agent may function to receive, in response to executing the first threat hunt, hunt findings data that indicates the second candidate threat detection instruction did not detect any historical electronic messages of the plurality of historical electronic messages as malicious, spam, or graymail. In such an embodiment, one or more subagents in operable communication with the autonomous AI agent may function to determine that the second candidate threat detection instruction is too restrictive based in part on the one or more subagents assessing the hunt findings data. Accordingly, in one or more embodiments, the large language model associated with the autonomous AI agent may generate a third candidate threat detection instruction by modifying one or more portions of the second candidate threat detection instruction to reduce a restrictiveness of the second candidate threat detection instruction.

In one or more embodiments, in response to generating the third candidate threat detection instruction, the autonomous AI agent may function to assess the third candidate threat detection instruction and, in response, confirm that (i) the third candidate threat detection instruction satisfies the syntax requirements defined by the threat detection and response service and (ii) the third candidate threat detection instruction detects the electronic message as malicious, spam, or graymail. In such an embodiment, in response to confirming that the third candidate threat detection instruction detects the electronic message as malicious, spam, or graymail, the autonomous AI agent may function to execute a second threat hunt that assesses the plurality of historical electronic messages of the subscribing entity using the third candidate threat detection instruction and, in turn, receive a subset of the plurality of historical electronic messages that the third candidate threat detection instruction detected as malicious, spam, or graymail. Furthermore, in such an embodiment, the one or more subagents in operable communication with the autonomous AI agent may function to determine that the third candidate threat detection instruction is not restrictive based on the one or more subagents assessing the subset of the plurality of historical electronic messages returned from the second threat hunt and, in turn, the one or more subagents may function to identify that the third candidate threat detection instruction satisfies the predetermined instruction performance criteria of the threat detection and response service in response to the one or more subagents determining that the third candidate threat detection instruction is not restrictive. Accordingly, in such an embodiment, in response to identifying the third candidate threat detection instruction satisfies the predetermined instruction performance criteria, the autonomous AI agent may designate the third candidate threat detection instruction as the production-ready threat detection instruction.

At least one technical benefit of the systems, methods, embodiments, and computer program products described herein is that the autonomous AI agent may autonomously validate, modify, and optimize candidate threat detection instructions responsive to syntax validation operations and historical threat hunt operations performed prior to deployment within the threat detection and response service. In particular, by iteratively modifying detection expressions encoded in candidate threat detection instructions responsive to syntax validation failures and threat hunt findings data indicating that a candidate threat detection instruction is overly restrictive, the autonomous AI agent may generate production-ready threat detection instructions that both conform to syntax requirements defined by the threat detection and response service and improve detection coverage of malicious, spam, and/or graymail electronic messages.

### Production-Ready Threat Detection Instruction

In one or more embodiments, the production-ready threat detection instruction generated by the autonomous AI agent may be encoded with a computer-executable enrichment function (e.g., a message screenshot enrichment function, a base64 scanning enrichment function, a file screenshot enrichment function, a machine learning-based link analysis enrichment function, a machine learning-based logo detection enrichment function, a machine learning-based macro classification enrichment function, a HTML screenshot enrichment function, and/or a machine learning-based natural language understanding enrichment function) that is configured to perform an enrichment operation. In such an embodiment, the threat detection and response service may function to (i) assess a data model of one of the future electronic messages against the production-ready threat detection instruction, (ii) invoke the computer-executable enrichment function during the assessment of the data model of the one of the future electronic messages against the production-ready threat detection instruction, (iii) transmit a request to a backend service of the threat detection and response service to perform the enrichment operation in response to invoking the computer-executable enrichment function, and (iv) receive a response from the backend service that includes an enrichment output in response to the backend service performing the enrichment operation, wherein the production-ready threat detection instruction determines that the one of the future electronic messages is malicious based at least in part on the enrichment output.

Stated another way, in one or more embodiments, the production-ready threat detection instruction may include one or more computer-executable enrichment functions that cause the threat detection and response service to perform one or more supplemental cybersecurity assessment operations, including machine learning-based analysis operations, that extend detection capabilities of the production-ready threat detection instruction beyond simple string matching operations.

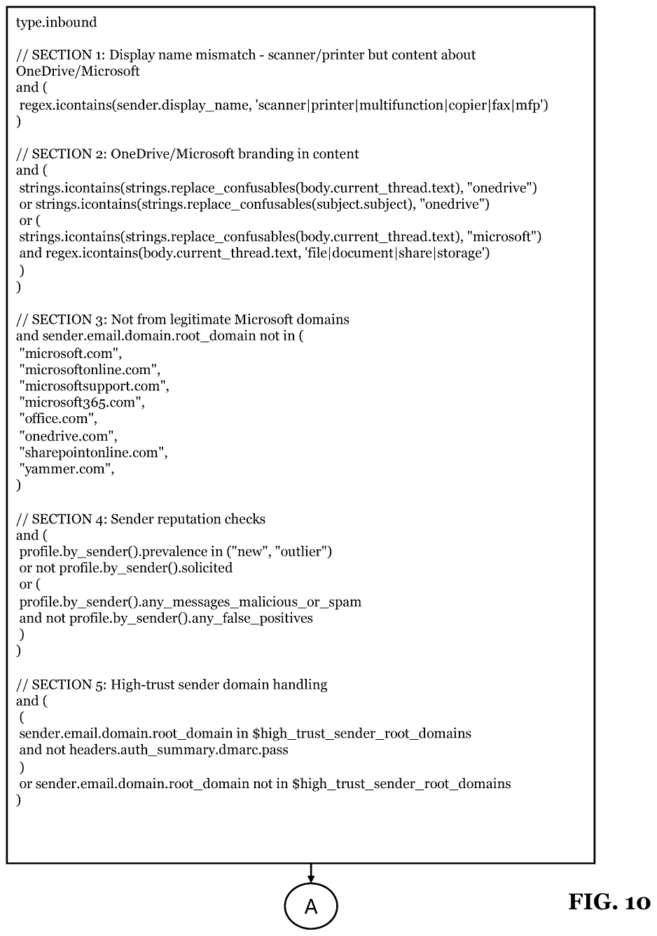

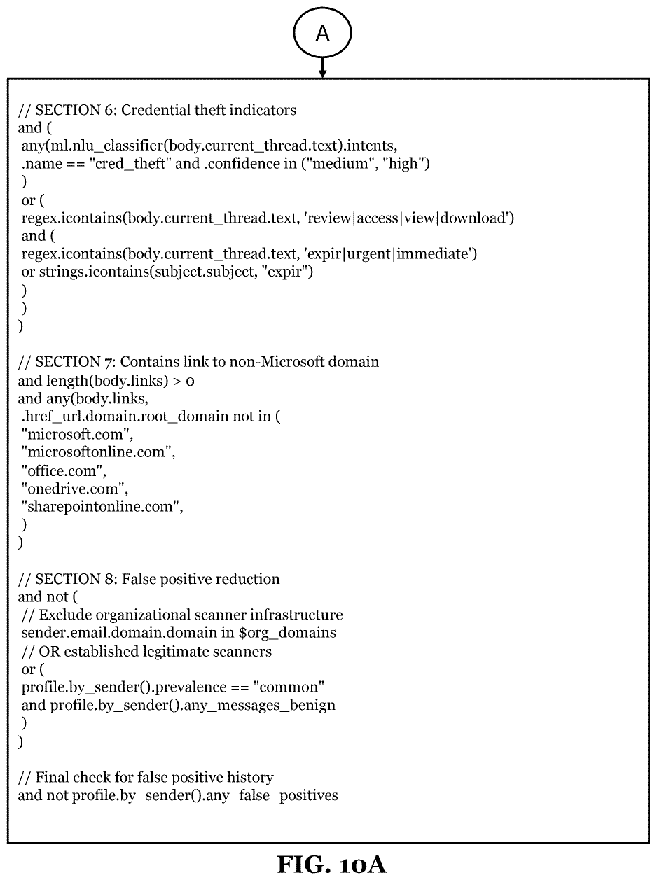

Additionally, or alternatively, in one or more embodiments, the production-ready threat detection instruction generated by the autonomous AI agent may include a plurality of distinct threat detection sections. In such an embodiment, each distinct threat detection section of the plurality of distinct threat detection sections may include (i) a respective subset of threat detection logic associated with a corresponding threat detection objective, and (ii) one or more natural language code comments that describe the corresponding threat detection objective associated with the respective subset of threat detection logic, as shown generally by way of example in FIG. 10 and FIG. 10A. In other words, the production-ready threat detection instruction may be logically segmented into multiple distinct threat detection sections that each (i) perform a corresponding portion of an overall threat detection operation associated with the production-ready threat detection instruction and (ii) include corresponding natural language code comments that describe the corresponding portion of the overall threat detection operation performed by the respective threat detection section.

### Graphical User Interface(s)

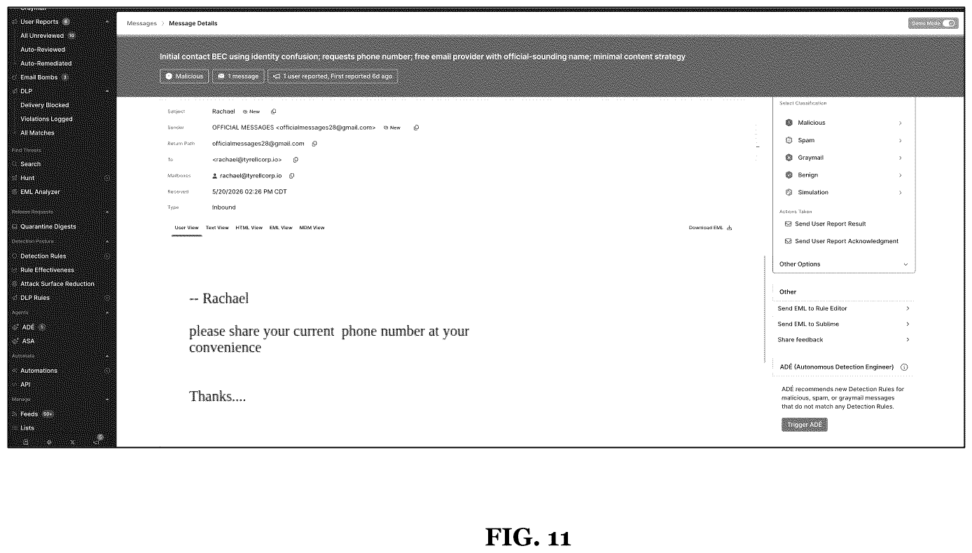

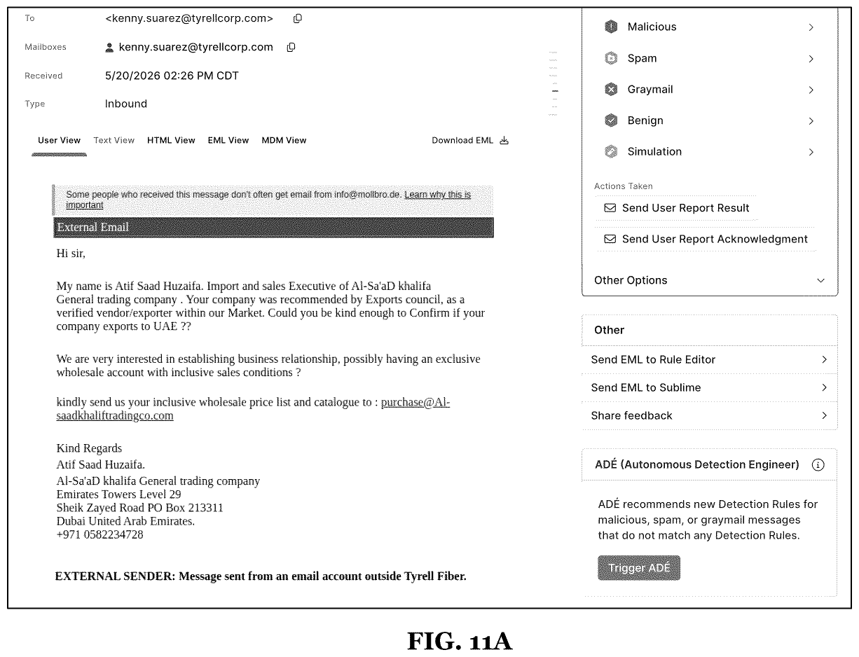

In one or more embodiments, the threat detection and response service may function to display the electronic message of the subscribing entity and an AI agent invocation user interface button configured to invoke the autonomous AI agent on the graphical user interface, as shown generally by way of example in FIGS. 11 and 11A. In such an embodiment, the threat detection and response service may function to receive an input from a user selecting the AI agent invocation user interface button while the electronic message and the AI agent invocation user interface button is displayed on the graphical user interface. Accordingly, in one or more embodiments, in response to receiving the input selecting the AI agent invocation user interface button, the threat detection and response service may function to electronically transmit, in real-time or near real-time, the message data of the electronic message to the autonomous AI agent. At least one technical benefit of the systems, methods, embodiments, and computer program products described herein is that a user associated with the subscribing entity may invoke the autonomous AI agent from a graphical user interface displaying the electronic message, thereby enabling automated generation of production-ready threat detection instructions responsive to user interaction.

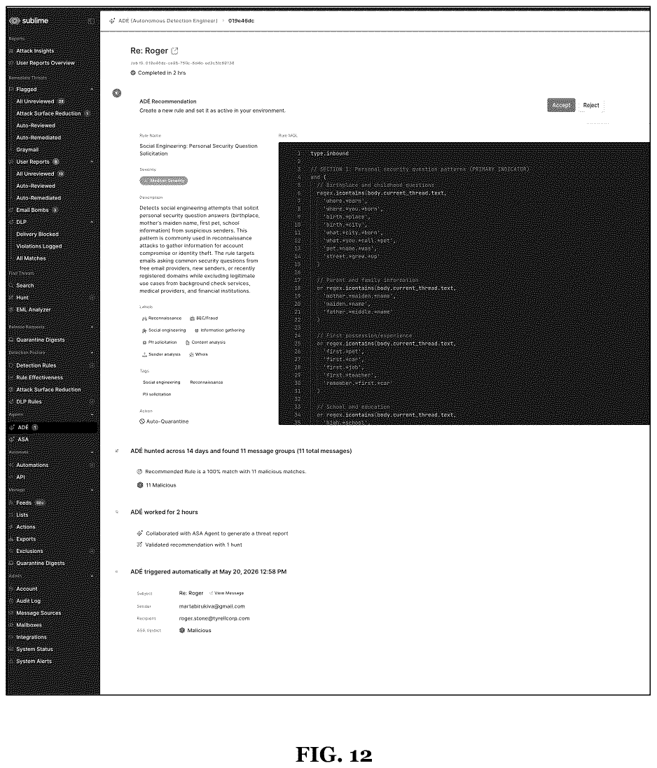

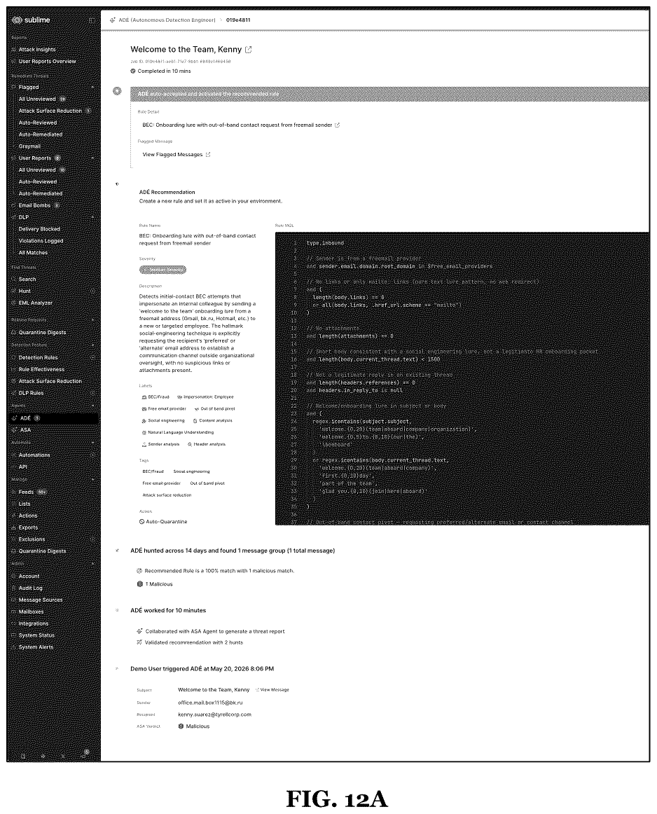

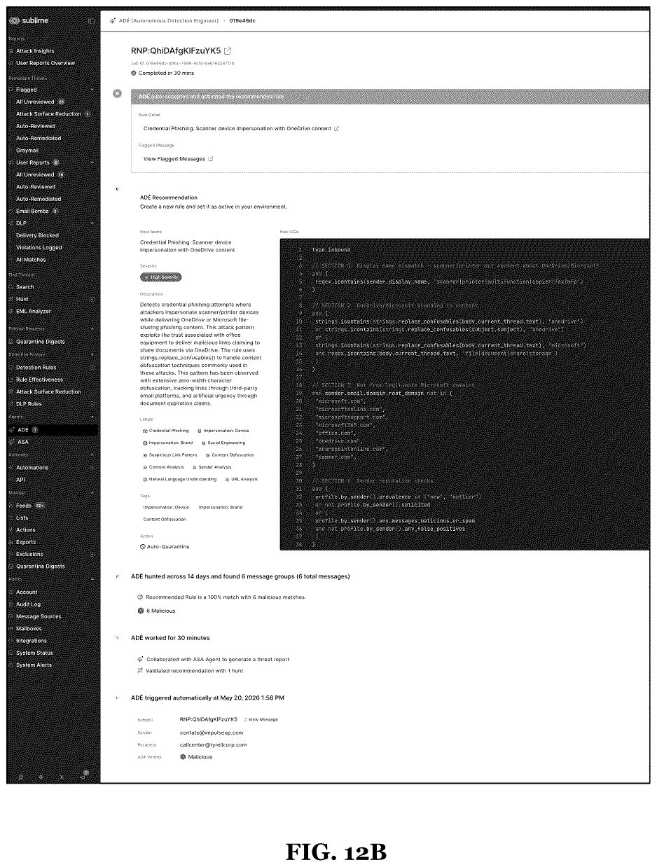

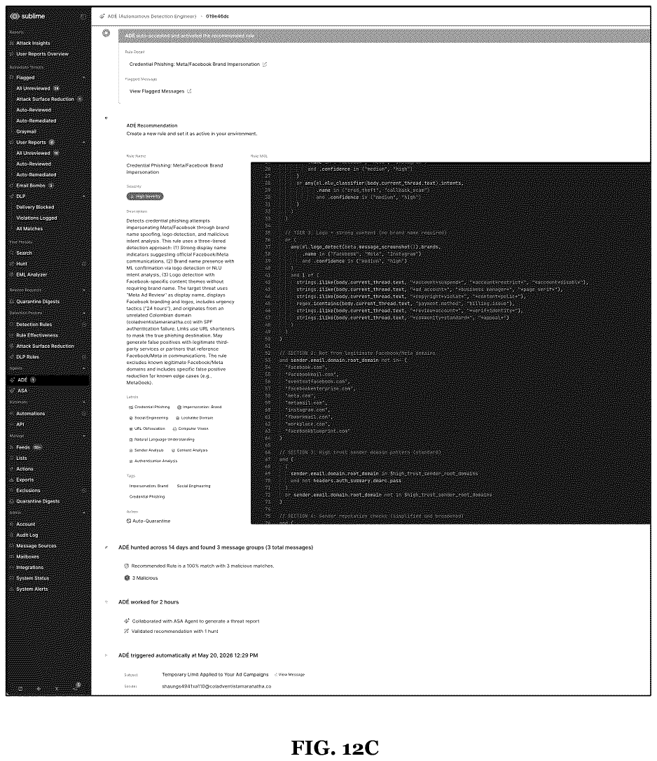

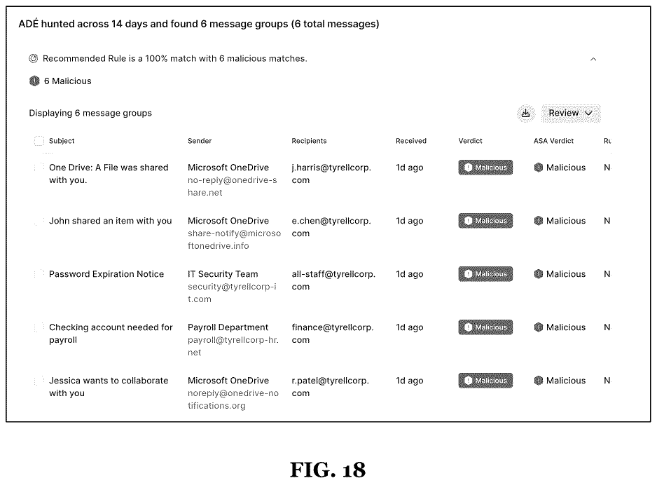

Turning to FIGS. 12-12C, in one or more embodiments, the production-ready threat detection instruction (e.g., rule MQL or the like) may be displayed on a graphical user in response to the autonomous AI agent generating the production-ready threat detection instruction. In such a non-limiting example, the graphical user interface may include one or more of (a) the production-ready threat detection instruction, (b) a calendar date and a clock time at which the autonomous AI agent was automatically invoked to assess the message data of the electronic message, (c) a total amount of time the autonomous AI agent autonomously operated to generate the production-ready threat detection instruction, (d) a natural language description generated for the production-ready threat detection instruction, (e) an autonomous AI agent reasoning summary describing, in natural language, a sequence of operations performed by the autonomous AI agent to generate and test the production-ready threat detection instruction, (f) a message hunt user interface object specifying a set of historical electronic messages detected by the production-ready threat detection instruction over a predetermined historical time period, (g) an instruction acceptance user interface button for approving deployment of the production-ready threat detection instruction, and (h) an instruction rejection user interface button for rejecting deployment of the production-ready threat detection instruction. Non-limiting example of the message hunt user interface object is illustrated in FIG. 18 and FIG. 7.

Accordingly, in one or more embodiments, the threat detection and response service may function to receive, via the graphical user interface, an input from a user selecting the instruction acceptance user interface button displayed on the graphical user interface. In such an embodiment, in response to receiving the input selecting the instruction acceptance user interface button, the threat detection and response service may function to automatically deploy the production-ready threat detection instruction within a distinct instance (e.g., compute environment) of the threat detection and response service that is configured for the subscribing entity, thereby preventing the future electronic messages from evading threat detection within the distinct instance of the threat detection and response service.

A non-limiting example of an autonomous AI agent reasoning summary associated with a respective production-ready threat detection instruction is illustrated in TABLE 1.

TABLE 1
<thinking>
Let me analyze this email report and create detection rules for this Initial Contact BEC
attempt. Let me start by fetching the email and looking for existing rules.
Key indicators from the report:
1. Sender from Russian freemail (bk.ru - Mail.ru domain)
2. Display name mismatch with signature (Nicholas Robertson vs “Robert”)
3. Welcome/onboarding lure targeting new employee
4. Request for alternate/out-of-band email address
5. Vague “project” reference
6. No prior communication history
7. Authentication passes but from bk.ru not org domain
Let me start investigating.
# ADÉ Tool Use: get_filtered_mdm
# ADÉ Tool Use: search_detection_rules
Good. I can see the email clearly now. Let me analyze the key indicators:
1. Sender: ‘Nicholas Robertson <office.mail.box1115@bk.ru>’ - Russian freemail (bk.ru is
Mail.ru's domain)
2. Subject: “Welcome to the Team, Kenny” - onboarding/welcome lure targeting new
employee
3. Body: Asks for preferred email address for “regular contact” - classic out-of-band pivot
4. Also vaguely mentions a “project” - typical BEC engagement attempt
5. Signature: “Robert” (not “Nicholas Robertson” - display name mismatch)
6. No attachments or suspicious links, though authentication passes for the bk.ru domain
The X-Mailer header identifies this as coming directly from Mail.Ru's service, which is a
strong technical indicator. Now I'm looking for specific attack patterns around initial contact
BEC attempts that use onboarding pretexts.
# ADÉ Tool Use: search_detection_rules
# ADÉ Tool Use: search_detection_rules
Good findings. I found some relevant rules. Now let me look more specifically at rules
targeting:
1. Display name mismatch with email signature
2. Onboarding/welcome lure targeting
3. Request for alternate email (out-of-band pivot without explicit freemail in body)
The key distinguishing features of this email are:
- Sender uses bk.ru (Russian freemail) with a Western-sounding display name
- Welcome/onboarding lure targeting new employee
- Asks for recipient's preferred email address (out-of-band pivot)
- Signature mismatch (signed “Robert” but display name is “Nicholas Robertson”)
- No links except mailto: to the organization domain, and the X-Mailer header indicates
Mail.Ru Mailer 1.0
Now I'm checking the NLU analysis for this email and searching for more specific detection
rules.
# ADÉ Tool Use: get_nlu_classification
# ADÉ Tool Use: search_detection_rules
The NLU classification didn't return anything, which is interesting. Let me try to evaluate
NLU against the email directly to see what it returns.
Now let me think about the key indicators for this attack:
1. **Sender from Russian freemail (bk.ru)** with a Western-sounding display name
2. **Welcome/onboarding lure** - “Welcome to the Team, Kenny” subject
3. **Request for alternate email** - “could you share the email address you'd prefer us to use
for regular contact” - classic out-of-band pivot
4. **Signature mismatch** - signed “Robert” but display name is “Nicholas Robertson”
5. **No suspicious links** - only mailto: links to the org domain
6. **X-Mailer header from Mail.Ru** - confirms the Russian email service origin
7. **Unsolicited sender with no prior relationship**
The most telling pattern here is the combination of a Russian freemail account with a Western
identity, the onboarding pretext, and the request to pivot communication to a different email
address. I should check what existing rules might already catch this and decide whether to
create a new detection or refine an existing one.
Looking at the current rule set, none of them would reliably flag this email. The signature
name mismatch is a strong indicator but difficult to detect without knowing the sender's actual
first name. What really stands out is the pairing of a Russian freemail domain with
welcome/onboarding language designed to establish initial contact.
Now I'm considering how to structure the detection rule. The out-of-band pivot request—
asking for a preferred email address—is the third key element that completes the attack
pattern. I'm weighing different approaches: focusing specifically on Mail.ru and bk.ru senders
with BEC-like content, or taking a broader approach that catches this pattern regardless of
which freemail provider is used. The most effective rule would likely combine the freemail
sender with the onboarding lure and the request for contact information, since that
combination is distinctive enough to avoid false positives while catching this type of
impersonation attempt.
# ADÉ Tool Use: evaluate_mql_snippet
# ADÉ Tool Use: evaluate_mql_snippet
Interesting findings:
1. ‘bk.ru’ IS in ‘$free_email_providers’ - good
2. NLU returns “benign” as high confidence intent, “B2B Cold Outreach” as a topic with high
confidence, and “Out of Band Pivot” as medium confidence topic
3. NLU entities include “sender: Robert” (from signature) and “sender: Nicholas Robertson”
(from the quoted context at top)
So the NLU doesn't confidently flag this as BEC. The intent is “benign” with high confidence.
However, the “Out of Band Pivot” topic at medium confidence is interesting.
Looking at the distinctive malicious signals here: the freemail sender, the welcome/onboarding
lure targeting new employees, the request for a preferred email address as an out-of-band pivot
attempt, the unsolicited nature, and the Mail.Ru Mailer header. Since NLU is returning
“benign” with high confidence, I can't rely on intent detection alone. The real detection
opportunity lies in combining the freemail sender with these behavioral patterns.
The existing Russia return path rule would catch this due to the .ru TLD and new sender, but
it's low severity. What I really need to capture is the specific pattern of a freemail sender using
a new employee onboarding lure combined with an out-of-band contact request-this is a
targeted BEC initial contact. I'm building a rule that detects inbound messages from freemail
providers with welcome/onboarding language and requests for alternative contact methods.
# ADÉ Tool Use: evaluate_mql_snippet
# ADÉ Tool Use: evaluate_mql_snippet
Excellent! So:
1. The ‘beta.ml_topic’ returns “Out of Band Pivot” with medium confidence - this is a useful
signal
2. The X-Mailer header ‘Mail.Ru Mailer 1.0’ is detectable and can be used as a signal
Now let me think about the best rule. Given the email characteristics, I want to create a rule
that:
1. Targets inbound emails from freemail senders
2. Uses onboarding/welcome lure language
3. Detects out-of-band pivot request (asking for preferred email, alternate contact)
Key MQL elements:
Building the detection rule to filter for inbound messages from freemail domains with no
suspicious links or attachments, then matching on welcome-themed subject lines and body
content that suggests onboarding... I'm second-guessing the ML function I used here—I need
to verify whether ‘beta.ml_topic’ actually returns topics or if I should be using
‘ml.nlu_classifier’ instead, since both seem to produce similar output structures based on what
I'm seeing in the documentation. the beta.ml_topic documentation either. So “Out of Band
Pivot” is either a newly added topic or an undocumented field that's being returned by the API.
Looking back at the actual output structure from ml.nlu_classifier, the docs show it should
only have entities, intents, language, and tags—no topics field at all. Yet the API response I
received included topics, which suggests this might be a beta feature or something that's not
yet reflected in the documentation. I see that “Out of Band Pivot” is actually listed in the
‘beta.ml_topic’ documentation as a valid topic category, so the function should return it
directly. Though the output I got included ‘intents’ and ‘entities’ fields too, which suggests the
function might be wrapping an NLU classifier internally. Rather than relying on the topic
classification, I'll use pattern matching to detect out-of-band pivot requests more reliably—
looking for phrases like “share email,” “preferred email,” “contact email,” and similar
variations that indicate the sender is trying to move communication off-platform.
Now I'm putting together the actual detection rule by combining all the signals: a freemail
sender, welcome/onboarding language, an out-of-band pivot request, a new unsolicited sender,
and the absence of suspicious links.
# ADÉ Tool Use: evaluate_mql_snippet
# ADÉ Tool Use: evaluate_mql_snippet
Both methods work! Let me now draft the rule. Given the key TTPs:
1. **Freemail sender** sending a welcome/onboarding lure
2. **Out-of-band pivot** - requesting preferred email address
3. **New/unsolicited sender**
4. **No suspicious links** (only org domain mailto: or no links)
Let me also check the welcome/onboarding subject/body detection:
# ADÉ Tool Use: evaluate_mql_snippet
# ADÉ Tool Use: evaluate_mql_snippet
All the key components check out. Now let me assemble the full rule. The core detection
logic:1. type.inbound2. Sender from freemail provider3. Welcome/onboarding lure in subject
or body4. Out-of-band contact pivot request5. No suspicious links (only org domain / mailto)6.
No attachments7. New/unsolicited senderLet me write the rule now:
# ADÉ Tool Use: validate_rule
Good, the rule is valid. Now let me run it against the email to make sure it fires.
# ADÉ Tool Use: run_mql_by_message_id
The rule fires on the email. Now let me get MQL feedback on the rule.
# ADÉ Tool Use: get_mql_feedback
Excellent feedback! Let me address all the issues raised. The key fixes are:
1. Remove the non-existent “Out of Band Pivot” topic - replace with request entity or NLU
intents
2. Add the ‘any_messages_malicious_or_spam’ branch to sender check
3. Simplify link check to just ‘mailto:’ only
4. Add body length cap
5. Add reply exclusion
6. Fix ‘onboard’ regex word boundary
Let me also note that the “Out of Band Pivot” topic actually DID return in my evaluation of
‘ml.nlu_classifier( )’ and ‘beta.ml_topic( )’.
Now I'm looking back at the NLU output from my evaluation - it definitely returned “Out of
Band Pivot” as a medium-confidence topic alongside B2B Cold Outreach and Professional and
Career Development. But my coworker is saying it's not a valid topic, which is strange. The
evaluation function might be returning topics in a different structure than what the official
docs list, so I need to be careful about this discrepancy.
I tested the condition directly and got true when checking for “Out of Band Pivot” with
medium or high confidence, so the coworker's claim that it would be dead code doesn't match
my results. This is likely a newer or beta topic that wasn't documented yet. I'll keep the Out of
Band Pivot check since I've verified it works, and I'll also add the regex fallback to cover the
other issues the coworker flagged.
Now I'm refining the rule by incorporating the malicious or spam message branch, switching
the link detection to only check for ‘mailto:’ links, capping the body length around 1500
characters, excluding replies, and fixing the word boundary in the ‘onboard’ regex pattern.
# ADÉ Tool Use: validate_rule
Good, valid. Let me test it against the email.
# ADÉ Tool Use: run_mql_by_message_id
The rule fires. Now let me run a threat hunt to see if there are any false positives or true
positives.
# ADÉ Tool Use: get_threat_hunt_feedback
The threat hunt found 1 result—the seed message itself—with no false positives. The rule is
performing exactly as intended. The hunt reviewer gave it a clean bill of health.
Now let me finalize the rule, incorporating any minor improvements suggested in the
feedback:
1. Consider adding a few more out-of-band pivot regex patterns based on the reviewer's
suggestions
2. The reviewer also noted some minor redundancy in the sender check, but it's correct
behavior
Let me add the additional regex patterns suggested and finalize the rule.
The reviewer's suggestions for additional regex patterns:
- ‘‘best.{0,15}(way|method).{0,15}(reach|contact)’’
- ‘‘how.{0,10}(can i|should i|do i).{0,10}(reach|contact|get in touch)’’
- ‘‘contact.{0,10}(details|info|information)’
These additions look solid. I'll incorporate them and wrap up the rule.
# ADÉ Tool Use: validate_rule
Let me run this final version against the email to confirm it still fires.
# ADÉ Tool Use: run_mql_by_message_id
The final rule fires and has been threat-hunted with 0 false positives. Let me now assemble the
final JSON output. Key summary points:
- Threat: Initial Contact BEC using a welcome/onboarding lure from a Russian freemail (bk.ru
/ Mail.ru) sender targeting a new employee, with a request for out-of-band contact channel
- Rule approach: New rule targeting the specific combination of freemail sender + onboarding
lure + OOB pivot + no links/attachments + new unsolicited sender
- Threat hunt: 1 result, 100% true positive (the seed message), 0 false positives
- MQL feedback addressed a couple of key issues: added the missing branch for malicious or
spam messages, kept the topics check since it actually worked during evaluation, and made
structural refinements like capping body length, excluding replies, streamlining the link
detection, and tightening the regex with word boundaries
Now I'm ready to put together the final output.

A non-limiting example of an autonomous AI agent reasoning summary associated with another production-ready threat detection instruction is illustrated in TABLE 2.

TABLE 2
Let me analyze this ASA report carefully to understand the threat and create effective
detection rules.
## Threat Analysis
This email is a credential phishing attack with the following characteristics:
**Key Indicators:**
1. **Brand Impersonation**: Impersonates Microsoft/OneDrive
2. **Sender Mismatch**: Display name “Scanned from a multifunction printer” doesn't match
OneDrive content
3. **Domain Mismatch**: Sent from impulseup.com, not Microsoft domains
4. **Content Obfuscation**: Extensive use of zero-width spaces and Unicode characters
5. **HTML Manipulation**: Letter-spacing manipulation, obfuscated title text
6. **Tracking Links**: Uses tracking infrastructure (url7554.impulseup.com) with click
tracking parameters
7. **Social Engineering**: Artificial urgency with expiration date, references to sensitive
documents (invoice, statement)
8. **Authentication Passing**: SPF/DMARC pass for impulseup.com (but not Microsoft)
9. **Spam Flag**: X-this-is-spam header present
**Attack Type**: Credential Phishing
**Tactics**: Brand Impersonation, Content Obfuscation, Social Engineering
## Rule Strategy
I'll create a detection rule targeting:
1. Scanner/printer display name impersonation
2. OneDrive/Microsoft branding in body content (after confusable normalization)
3. Non-Microsoft sender domain
4. Sender reputation signals
5. Credential theft intent (NLU)
6. Suspicious external links
# ADÉ Tool Use: get_filtered_mdm
I have the message data. Key observations:
- Display name: “Scanned from a multifunction printer” (device impersonation)
- Sender domain: impulseup.com (not Microsoft)
- Body contains OneDrive references (obfuscated with zero-width characters)
- DMARC/SPF pass for impulseup.com
- X-This-Is-Spam header present
- Link goes to impulseup.com domain
Now let me search for existing rules that handle similar patterns.
# ADÉ Tool Use: search_detection_rules
Found related rules but none specifically target the scanner/printer impersonation + OneDrive
combination. The closest is ‘credential_phishing_one_drive_impersonation.yml’ but it focuses
on OneDrive in the display name/subject, not the scanner display name mismatch. I need to
create a new rule.
Let me draft the rule and test it against the target message.
# ADÉ Tool Use: run_mql_by_message_id
The rule matches the target email. Now let me run a threat hunt to see how many other
messages this pattern catches.
# ADÉ Tool Use: get_threat_hunt_feedback
Hunt found 0 detections, but the rule is validated against the target email. Given the
sophistication (zero-width character obfuscation, tracking infrastructure, device
impersonation), this appears to be a new/emerging threat. I'll finalize the rule with all the
sections I designed.
# ADÉ Tool Use: validate rule

A non-limiting example of an autonomous AI agent reasoning summary associated with another production-ready threat detection instruction is illustrated in TABLE 3.

TABLE 3
Let me analyze this ASA report to understand the threat and develop appropriate detection
rules.
## Threat Analysis
### Key Indicators from the Report:
1. **Fake Reply Pattern**: Subject has “Re:” but no real thread history
(length(headers.references) == 0)
2. **Display Name Mismatch**: Display name “Susan” doesn't match email local part
“martabirukiva”
3. **Personal Information Solicitation**: Asking for birthplace (common security question)
4. **Free Email Provider**: Gmail account
5. **Minimal Content**: Very brief message with generic greeting
6. **Prior Communication**: Sender HAS previously contacted the organization
(complicating factor)
7. **Authentication Passes**: DMARC and SPF pass (legitimate Gmail infrastructure)
### Attack Classification:
- **Primary**: Reconnaissance/Social Engineering
- **Secondary**: Initial Contact BEC (establishing relationship for future attacks)
### Detection Strategy:
This is a sophisticated social engineering attempt that:
1. Uses fake reply threading to appear legitimate
2. Solicits personal information (PII/security questions)
3. Uses established sender history to build trust
4. Displays name/email mismatch suggesting potential account compromise
### Rule Approach:
I should create rules that detect:
1. Fake reply patterns combined with personal information requests
2. Display name/email mismatches with suspicious content
3. Reconnaissance patterns (minimal content + information solicitation)
Let me search for existing rules that might be relevant, then create or modify rules
accordingly.
# ADÉ Tool Use: get_filtered_mdm
Great! Now I have the full MDM. Let me analyze the key indicators:
### Confirmed Indicators:
1. **Fake Reply**: Subject has “Re:” but headers.references is not present (no reference to
previous email thread)
2. **Display Name Mismatch**: “Susan” vs “martabirukiva”
3. **Personal Information Request**: “Where were you born?” - classic security question
4. **Free Email Provider**: gmail.com
5. **Minimal Content**: Very brief message
6. **Single Recipient**: Only one person targeted
7. **Authentication Passes**: DMARC and SPF both pass
### Key Detection Elements:
- Fake reply pattern: ‘regex.icontains(subject.subject, ‘\b(?:RE|FWD?)\s*:’)’ AND
‘length(headers.references) == 0’
- Display name/email mismatch: Display name doesn't match email local part
- Personal information solicitation: Questions about birthplace, birthdate, mother's maiden
name, etc.
- Very minimal content length
- From free email provide
Let me search for existing rules that detect similar patterns.
# ADÉ Tool Use: search_detection_rules
Good! I found some relevant patterns. Now let me search for rules about personal information
solicitation and display name mismatches.
# ADÉ Tool Use: search_detection_rules
No existing rules for personal information solicitation. Let me search for display name
mismatch patterns.
# ADÉ Tool Use: search_detection_rules
Now let me search for reconnaissance patterns.
# ADÉ Tool Use: search_detection_rules
Good! I found a rule that detects fake threads. Now let me test some MQL snippets on this
message to understand what conditions I should use.
# ADÉ Tool Use: run_mql_by_message_id
Good! The fake reply pattern works. Now let me test the display name mismatch.
# ADÉ Tool Use: run_mql_by_message_id
Excellent! Now let me test for personal information solicitation patterns.
# ADÉ Tool Use: run_mql_by_message_id
Perfect! Now let me check for minimal content and free email provider.
# ADÉ Tool Use: run_mql_by_message_id
Great! All the key indicators are matching. Now let me create a comprehensive rule that
combines these elements. I'll create a rule specifically for this type of reconnaissance/social
engineering attack.
Let me draft a rule and get feedback on it.
# ADÉ Tool Use: validate_rule
Great! The rule validated successfully. Now let me test it against the message to ensure it flags
correctly.
# ADÉ Tool Use: run_mql_by_message_id
Perfect! The rule flags the target email. Now let me get feedback from a coworker on this rule
to ensure it's well-structured and effective.
# ADÉ Tool Use: get_mql_feedback
Great feedback! The coworker identified several issues:
1. Display name mismatch is too broad and will cause false positives - I should remove or
significantly narrow this
2. Personal information patterns are too broad without context
3. Missing key reconnaissance indicators like undisclosed recipients, self-sender patterns
4. Logical contradiction in false positive section
5. Rule is too narrow and might miss variants
6. Performance issues with multiple regex patterns
However, I need to balance this feedback with the specific threat I'm targeting. The original
email:
- Has “Re:” with no reply headers ✓
- Asks for birthplace (security question) ✓
- Has display name mismatch (Susan vs martabirukiva) - but coworker says this is too broad
- From Gmail ✓
- Very brief (28 characters after removing Microsoft banner) ✓
Let me reconsider the rule. The coworker's feedback is helpful, but I need to:
1. Keep the fake reply pattern (solid indicator)
2. Keep the personal information solicitation but make it more contextual
3. Remove or significantly narrow the display name mismatch check
4. Add better reconnaissance indicators
5. Fix the logical contradiction
6. Consider splitting into two rules as suggested
Let me create an improved version that focuses on the key indicators while addressing the
feedback. I'll create a rule that balances specificity with generalization.
Actually, looking at the target email again:
- Very short message: “Hiya, Roger Where were you born?”
- This is exactly 28 characters (without Microsoft banner)
- It's asking a personal question in a very direct way
- The display name issue is legitimate but the coworker is right that checking for it too broadly
will cause FPs
Let me create a more focused rule that:
1. Keeps the fake reply pattern
2. Focuses on personal information solicitation with relationship-building context
3. Removes the problematic display name mismatch
4. Keeps minimal content requirement but lowers threshold
# ADÉ Tool Use: validate_rule
Ah! I made a critical error - ‘strings.icontains’ only takes 2 parameters, not multiple patterns. I
need to use ‘regex.icontains’ for multiple patterns or chain multiple ‘strings.icontains’ calls
with ‘or’. Let me fix this.
# ADÉ Tool Use: validate_rule
Good! Now let me test this improved rule against the target email.
# ADÉ Tool Use: run_mql_by_message_id
The hunt returned 0 results, which suggests the rule is too restrictive. The coworker makes
excellent points:
1. Content length < 150 is too restrictive - social engineering often needs more context
2. The complexity requirements (< 5 sentences or < 20 words) are too narrow
3. Security question patterns could be expanded
However, I need to be careful. The target email IS very brief (28 characters). Let me think
about this...
The coworker suggests:
- Remove sections 4 and 5 (minimal content and low complexity)
- Expand security question patterns
- Keep the rest
But the original email WAS very brief. Let me check if removing those sections will cause too
many false positives. Let me create an improved version that balances the feedback.
I'll:
1. Keep the fake reply pattern (solid)
2. Expand security question patterns
3. Remove the overly restrictive complexity check (Section 5)
4. Keep but relax the minimal content requirement (increase from 150 to 500)
5. Keep the good false positive reduction
Let me create this improved version.
# ADÉ Tool Use: validate_rule
Good! The rule validates. Now let me test it against the target email.
# ADÉ Tool Use: run_mql_by_message_id
Perfect! The rule still flags the target email. Now let me run another threat hunt with this
improved version.
# ADÉ Tool Use: get_threat_hunt_feedback
Another hunt with 0 results. The coworker is right - the combination of fake reply + security
questions is too narrow. They suggest:
1. Make fake reply optional (use “2 of 3” approach)
2. Increase content length to 1000-1500 or remove entirely
3. Consider splitting into two rules
This makes sense. The target email DOES have both fake reply and security questions, but this
might be a rare combination. Let me create a final version that balances all the feedback I've
received:
Option 1: Make the rule broader by making fake reply optional
Option 2: Keep the rule narrow but as a high-confidence detection
I think I should go with Option 1 - make it broader but still effective. Let me create a final
version that uses the “2 of 3” approach or similar logic to make it less restrictive while
maintaining high confidence.
Actually, let me reconsider the entire approach. The key indicators from the target email are:
1. Fake reply pattern (strong)
2. Personal security question (strong)
3. From free email (medium)
4. Very brief content (medium)
5. Display name mismatch (weak/causes FPs)
The issue is that requiring ALL of these is too narrow. Let me create a rule that requires the
two strongest indicators (fake reply + security questions) but makes the others optional or part
of a “2 of N” logic.
Let me create one more version that's more balanced.
# ADÉ Tool Use: validate_rule
Good! Now let me test it on the target email.
# ADÉ Tool Use: run_mql_by_message_id
Perfect! The rule still flags the target email. Let me run one more threat hunt with this more
flexible version.
# ADÉ Tool Use: get_threat_hunt_feedback
Still 0 results even with the more flexible “2 of 3” logic. The coworker suggests:
1. Test with just security questions to see if they exist at all
2. Loosen to “1 of 3” logic
3. Add more secondary indicators (making it “2 of 5” instead of “2 of 3”)
4. Expand security question patterns
Given that I've now had 3 hunts with 0 results, this suggests that this specific combination is
very rare. However, I know the target email exists, so the rule SHOULD work in theory.
Let me reconsider my approach. Perhaps I should:
1. Create a simpler, more focused rule that just detects the core pattern
2. Accept that this might be a very rare attack pattern
Let me create one final version that's simpler and more likely to catch similar attacks. I'll focus
on the core indicators that made the original email suspicious:
- Personal security question (required)
- Suspicious sender context (required)
- Optional: fake reply pattern OR brief content
This should be more flexible while still maintaining reasonable detection capability.
# ADÉ Tool Use: validate_rule
Good! Let me test this simplified version on the target email.
# ADÉ Tool Use: run_mql_by_message_id
Perfect! The simplified rule still flags the target email. Now let me run one final threat hunt
with this version.
# ADÉ Tool Use: get_threat_hunt_feedback
The coworker identified the critical issue! Section 3 says “OPTIONAL” in the comment but
uses ‘and’ which makes it REQUIRED. This is why the hunt found 0 results. I need to either:
1. Remove Section 3 entirely (recommended)
2. Make Section 3 truly optional by adding ‘or length(body.current_thread.text) > 0’ as a
baseline
Let me create the final version following the recommendation to remove Section 3. This
should catch more attacks while still maintaining good false positive reduction.
# ADÉ Tool Use: validate_rule
Good! Now let me verify it still flags the target email.
# ADÉ Tool Use: run_mql_by_message_id
Perfect! The rule still flags the target email. Now let me run a final threat hunt with this
optimized version.
# ADÉ Tool Use: get_threat_hunt_feedback

A non-limiting example of an autonomous AI agent reasoning summary associated with another production-ready threat detection instruction is illustrated in TABLE 4.

TABLE 4
Let me analyze this threat report to understand what detection rules would be most effective.
## Key Indicators from the Report:
1. **Brand Impersonation**: Meta/Facebook brand impersonation
- Display name: “Meta Ad Review”
- Facebook logo detected (high confidence)
- Sender domain: coladventistamaranatha.co (unrelated Colombian domain)
- Claims to be from Meta Platforms, Inc.
2. **Authentication Issues**:
- SPF: “none”
- No DKIM/DMARC
- Sender domain doesn't match claimed sender
3. **URL Shortener**:
- Primary CTA uses rebrand.ly URL shortener
- Obscures true destination
4. **Social Engineering**:
- Urgency: “24 hours” deadline
- Fear: threatens “permanent restrictions”
- Account violation claims
5. **Domain Characteristics**:
- Recently registered (within 14 days)
- Colombian TLD (.co)
- No connection to Meta
6. **Landing Page**:
- AOL logo detected on linked page (medium confidence)
- Suggests credential harvesting
## Attack Type: Credential Phishing
## Detection Strategy:
Based on the threat report and MQL documentation, I should focus on:
1. **Primary Detection**: Brand impersonation + URL shortener + suspicious domain
2. **Supporting Indicators**: Authentication failure, urgency language, new domain
3. **ML Functions**: Logo detection, link analysis (if available), NLU for urgency
Let me create a comprehensive rule that targets this attack pattern.
## Rule Design Approach:
I'll create a rule that detects:
- Facebook/Meta brand impersonation (via logo detection and display name)
- Sender domain mismatch (not from facebook.com/meta.com)
- URL shortener usage (rebrand.ly and others)
- Urgency/threat language
- Newly registered sender domains
Now I'll structure this following the best practices from the documentation.
# ADÉ Tool Use: get_filtered_mdm
Good, now I have the full MDM. Let me analyze the key detection points:
1. **Sender**:
- Display name: “Meta Ad Review”
- Email: shaungs4941xa110@coladventistamaranatha.co
- Domain: coladventistamaranatha.co (Colombian TLD)
2. **Subject**: “Temporary Limit Applied to Your Ad Campaigns”
3. **Body Content**:
- Multiple Facebook/Meta references
- Urgency: “24 hours”
- Threats: “permanent” restrictions
- Account violation language
- Meta Platforms, Inc. footer
4. **Links**:
- Legitimate Facebook links (terms, community standards)
- Primary malicious link: https://rebrand.ly/kz8xyqv (URL shortener)
5. **Authentication**:
- SPF: “none”
Now let me test a few detection approaches:
1. First, I'll test if logo detection works on the message screenshot
2. Then test NLU for urgency/cred_theft intent
3. Test URL shortener detection
4. Build a comprehensive rule
Let me start by testing logo detection:
# ADÉ Tool Use: evaluate_mql_snippet
Perfect! Facebook logo is detected with high confidence. Now let me check if NLU detects
urgency or credential theft intent:
# ADÉ Tool Use: evaluate_mql_snippet
Excellent! NLU detects:
- Intent: “cred_theft” with “high” confidence
- Entities: Multiple “urgency” entities detected
- Topics: “Security and Authentication” (high), “Social Media and Networking” (high)
Now let me check the URL shortener detection and sender profile:
# ADÉ Tool Use: evaluate_mql_snippet
Good! The URL shortener is detected. Now let me check sender profile and domain age:
# ADÉ Tool Use: evaluate_mql_snippet
Perfect! The sender has:
- prevalence: “new” (first time sender)
- solicited: false (recipient hasn't emailed them before)
- days_known: 0Now let me check domain age:
# ADÉ Tool Use: evaluate_mql_snippet
Interesting! The days_old is −98.66, which means the domain will be created in the future
(likely a data issue or timezone problem). However, the domain status is “inactive” which is a
strong indicator. The report mentioned the domain was registered within 14 days. Let me now
check the authentication status:
# ADÉ Tool Use: evaluate_mql_snippet
Perfect! SPF verdict is “none” - no authentication. Now let me draft a comprehensive detection
rule. I'll create a rule that focuses on:
1. **Primary Detection**: Facebook/Meta brand impersonation via logo detection
2. **Supporting Indicators**: - Sender domain mismatch (not from facebook.com/meta.com)
- URL shortener usage - Credential theft intent (NLU)
- Urgency entities (NLU)
- SPF authentication failure - New sender3.**False Positive Reduction**:
- Exclude legitimate Facebook domains
- Exclude legitimate partner domainsLet me write the rule:
# ADÉ Tool Use: validate_rule
Great! The rule is syntactically valid. Now let me test it against the target message to confirm
it flags correctly:
# ADÉ Tool Use: run_mql_by_message_id
Wow, that's extensive feedback! The coworker has identified several critical issues with my
initial rule. Let me address the main concerns:
**Critical Issues:**
1. URL shorteners are not reliable for Facebook impersonation - need to use ml.link_analysis
or recipient targeting instead
2. Authentication logic needs the standard high trust domain pattern
3. Need a tiered OR structure instead of too many ANDs
4. Missing Salesforce infrastructure abuse detection
**Moderate Issues:**
5. Weak account security language patterns
6. Missing Unicode/confusable character handling
7. Missing Facebook footer pattern
8. Missing reply-to mismatch detection
9. Incomplete domain exclusions
10. Performance optimization needed
Let me create an improved version that addresses these issues. I'll focus on
1. Removing URL shortener logic and replacing with ml.link_analysis or recipient targeting
2. Using the standard high trust domain authentication pattern
3. Creating a tiered structure with multiple detection paths
4. Adding comprehensive domain exclusions
5. Using strings.replace_confusables for Unicode handling
6. Adding comprehensive account security patterns
Let me draft a revised rule:
# ADÉ Tool Use: validate_rule
I have a scope reference error. The ‘...email.email’ notation is incorrect - I need to use a
different scope reference. Let me fix this. The issue is in the base64 scanning section where
I'm trying to reference the recipient email from within nested any( ) calls.
Let me reconsider the scope references: - ‘recipients.to’ is the outer loop (recipient)
- ‘body.links’ is the middle loop (link)
- ‘beta.scan_base64( )’ returns an array of strings
So the scope should be:
- ‘.’ refers to the current item in scan_base64 results
- ‘..’ refers to the link
- ‘...’ refers to the recipient
Actually, looking at the error, I think the issue is that I need to be more careful about the
nesting. Let me simplify this part or restructure it.
Actually, from the feedback, the pattern should be:
‘‘‘javascript
any(recipients.to,
.email.domain.valid
and any(body.links,
strings.icontains(.href_url.url, ..email.email)
)
)
’’’
But I'm inside a ‘any(body.links, ...)’ already, so I need to restructure. Let me fix this:
# ADÉ Tool Use: validate_rule
Good! The rule validates. Now let me test it against the target message to ensure it still flags
correctly:
# ADÉ Tool Use: run_mql_by_message_id
Great! The revised rule still flags the target message. Now let me run a threat hunt to validate
effectiveness and check for false positives:
# ADÉ Tool Use: get_threat_hunt_feedback
The hunt returned 0 results, which means the rule is too restrictive. The main issue identified is
the mandatory urgency requirement. Let me revise the rule to make it less restrictive while still
being effective. The key changes needed:
1. Make urgency optional or expand to include more Facebook-specific themes2. Fix the
triple-dot scope reference issue in Tier 3 (MQL only supports single-level back-reference)
3. Simplify or adjust the tier structure
Let me create a final version that addresses these issues:
# ADÉ Tool Use: validate_rule
Good, the simplified rule validates. Let me test it against the target message to ensure it still
flags correctly:
# ADÉ Tool Use: run_mql_by_message_id
Excellent! The rule still flags the target message. Now let me run one more threat hunt on the
optimized version to see if it catches more samples:
# ADÉ Tool Use: get_threat_hunt_feedback
Still 0 results. The feedback suggests the rule is too restrictive. The main issues are:
1. Tier 2 requires triple conditions (brand + ML + content themes)
2. Tier 3 is too specific
3. Sender reputation requirements may be too narrow
Let me create one final simplified version that should actually catch some samples while still
being effective. I'll:
1. Make Tier 2 use OR logic between ML and content patterns (not AND)
2. Broaden the sender reputation slightly
3. Remove or simplify Tier 3
4. Add a comment noting this is optimized for broader coverage
Let me create the final version:
# ADÉ Tool Use: validate_rule
Good! Let me test this against the target message:
# ADÉ Tool Use: run_mql_by_message_id
Perfect! The rule still flags the target message. Let me now run a final threat hunt to see if this
simplified version gets better results:
# ADÉ Tool Use: get_threat_hunt_feedback
Still 0 results after multiple iterations. The feedback is consistent - the rule is too restrictive.
Given the time spent and the consistent feedback, I think I should now present the final
candidate rule with clear documentation about what was learned and what trade-offs were
made.
The key insights from the feedback are:1. TIER 1 keywords are too specific
2. TIER 2 requires brand name first which creates a bottleneck 3. “2 of 5” content patterns may
be too restrictive 4. Sender reputation logic could be simplifiedGiven that I need to provide a
final candidate rule, I'll create one more version that's broader but still maintains good
detection quality. However, I should also acknowledge in my summary that without actual
threat hunt data showing successful matches, the rule may need further tuning in
production.Let me create one final version with maximum broadening while still being
responsible about precision:
# ADÉ Tool Use: validate_rule
Good! Let me test against the target message one final time:
# ADÉ Tool Use: run_mgl_by_message_id

Furthermore, in one or more embodiments, in response to generating the production-ready threat detection instruction, the large language model associated with the autonomous AI agent may function to generate one or more natural language artifacts for the production-ready threat detection instruction. The one or more natural language artifacts, in such an embodiment, may include one or more of a first set of natural language text strings describing a plurality of detection expressions encoded in the production-ready threat detection instruction, a second set of natural language text strings describing one or more computational cost reduction operations encoded in the production-ready threat detection instruction, a third set of natural language text strings describing an efficacy of the production-ready threat detection instruction, a fourth set of natural language text strings describing a set of false positive mitigation controls that the autonomous AI agent encoded in the production-ready threat detection instruction, and a fifth set of natural language text strings describing a set of proposed instruction tuning recommendations generated by the autonomous AI agent for modifying the production-ready threat detection instruction upon occurrence of false positives or missed detections associated with the production-ready threat detection instruction. It shall be recognized that one or more natural language artifacts may be further displayed on the graphical user interface.

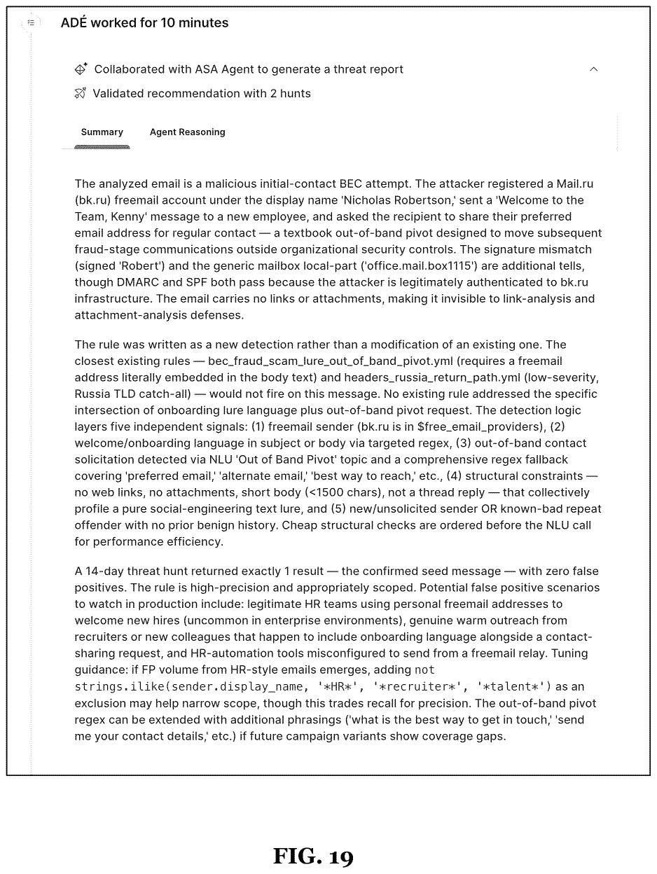

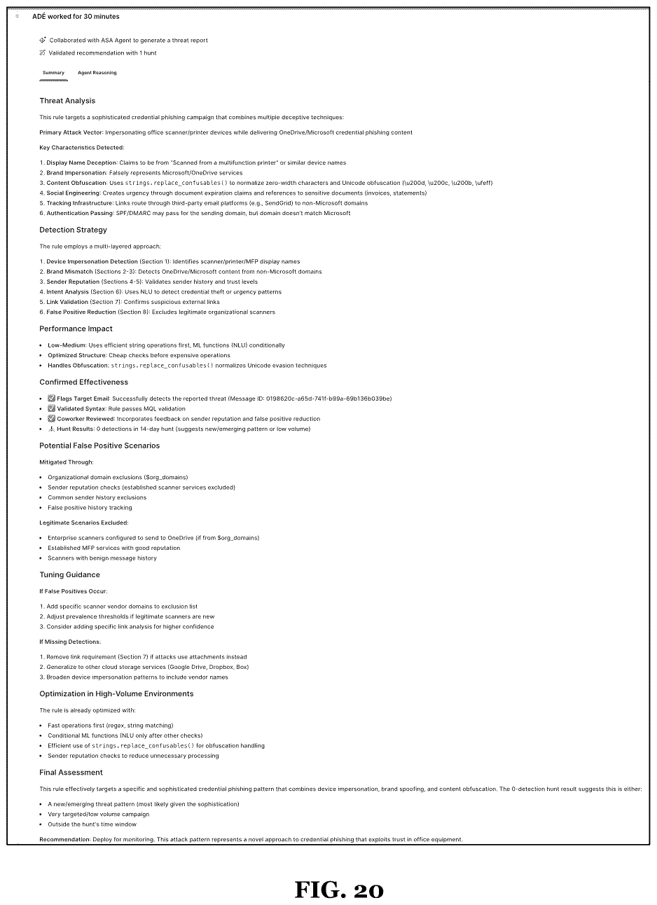

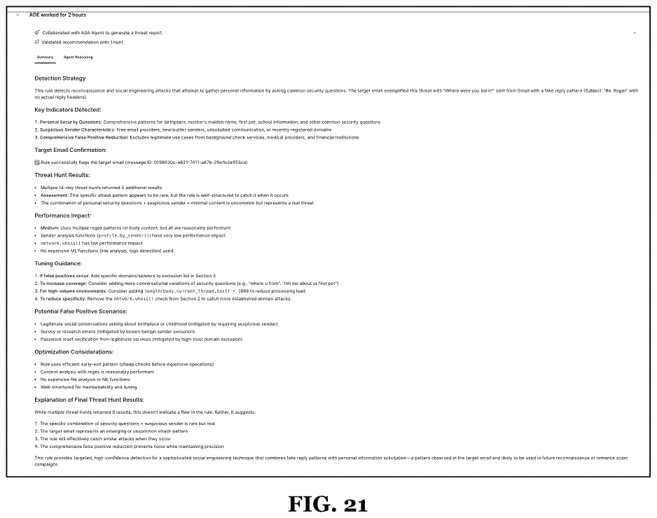

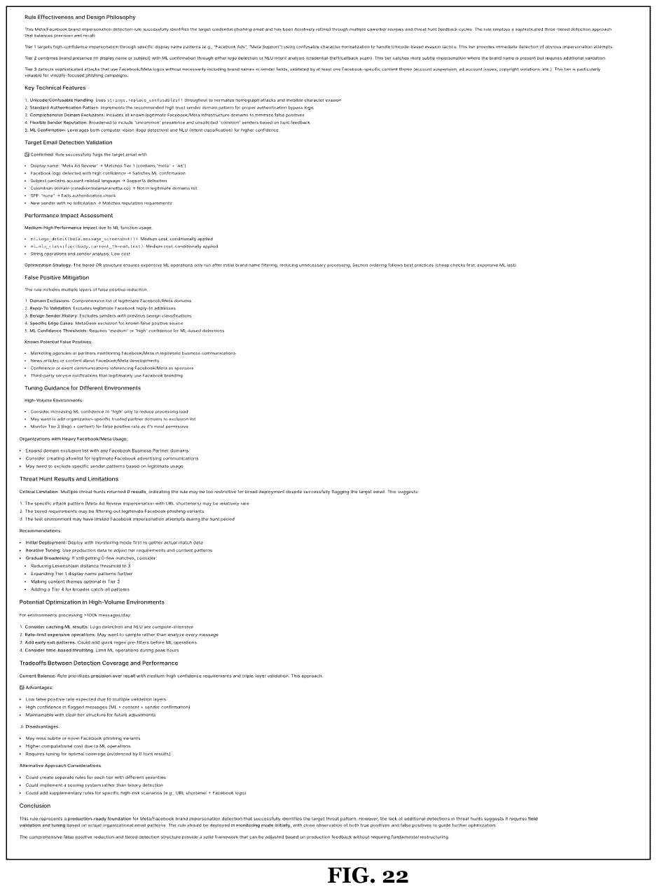

A non-limiting example of the one or more natural language artifacts generated for a first production-ready threat detection instruction is illustrated in FIG. 19. A non-limiting example of the one or more natural language artifacts generated for a second production-ready threat detection instruction is illustrated in FIG. 20. A non-limiting example of the one or more natural language artifacts generated for a third production-ready threat detection instruction is illustrated in FIG. 21. A non-limiting example of the one or more natural language artifacts generated for a fourth production-ready threat detection instruction is illustrated in FIG. 22.

### Autonomous AI Agent Activation UI Component(s)

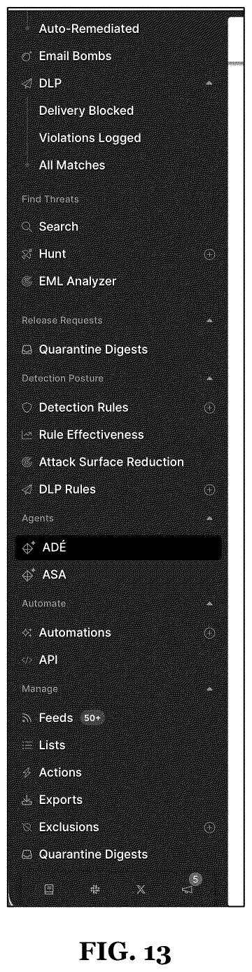

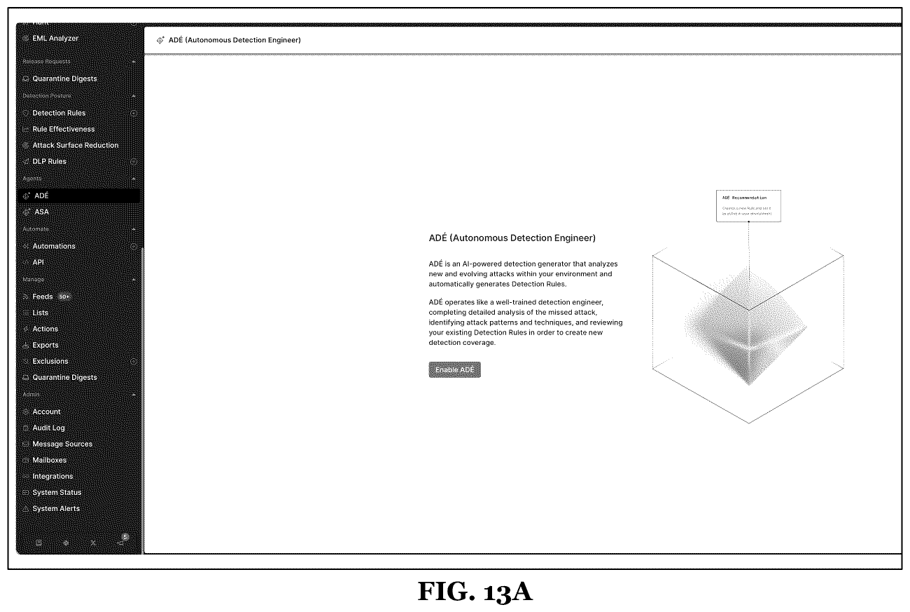

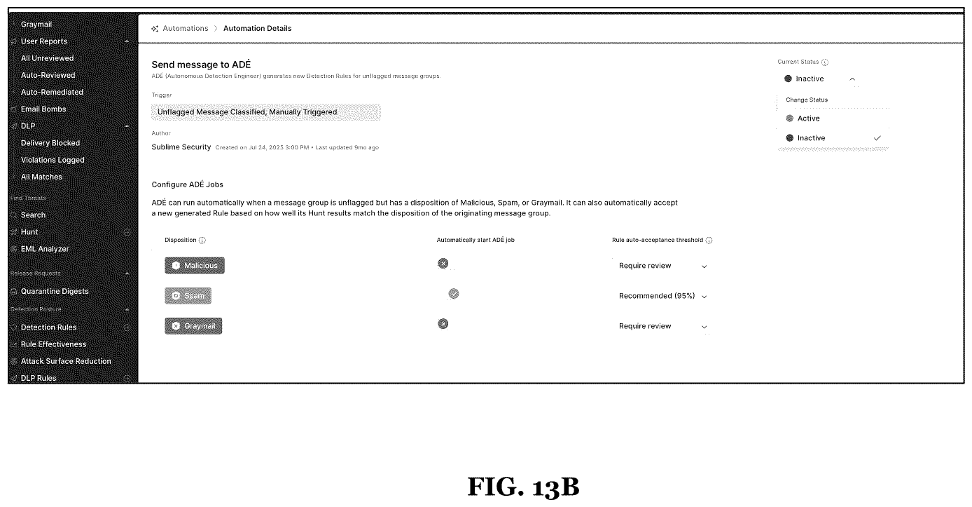

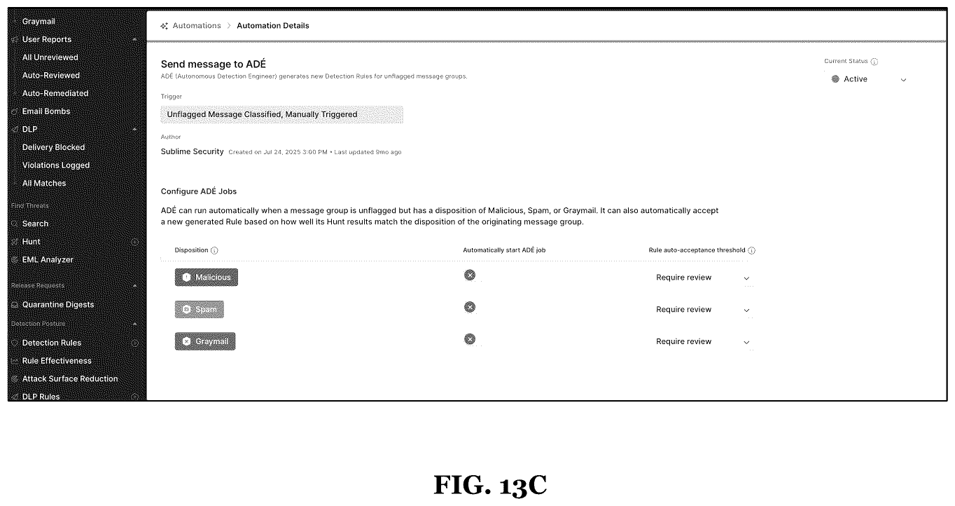

Turning to FIGS. 13-13C, in one or more embodiments, before electronically transmitting the message data of the electronic message to the autonomous AI agent, the threat detection and response service may receive, via the graphical user interface, a first input from a user selecting a user interface object associated with the autonomous AI agent. In such an embodiment, in response to receiving the first input selecting the user interface object associated with the autonomous AI agent, the threat detection and response service may function to display, on the graphical user interface, an AI agent activation button for activating the autonomous AI agent. Additionally, in such an embodiment, the threat detection and response service may receive, via the graphical user interface, a second input from the user selecting the AI agent activation button.

Accordingly, in one or more embodiments, in response to the threat detection and response service receiving the second input selecting the AI agent activation button, the threat detection and response service may function to display, on the graphical user interface, an AI agent control user interface element that indicates the autonomous AI agent is in an inactive state. Additionally, in such an embodiment, the threat detection and response service may receive, via the graphical user interface, a third user input from the user selecting the AI agent control user interface element.

In one or more embodiments, in response to receiving the third user input selecting the AI agent control user interface element, the threat detection and response service may function to display, on the graphical user interface, a drop-down element that includes a selectable active state option and a selectable inactive state option for the autonomous AI agent. In such an embodiment, the threat detection and response service may receive a fourth user input selecting the selectable active state option while the drop-down element is displayed on the graphical user interface.

Accordingly, in one or more embodiments, in response to receiving the fourth user input, the threat detection and response service may function to activate the autonomous AI agent for the subscribing entity to enable automated generation of production-ready threat detection instructions by the autonomous AI agent electronic messages when the autonomous AI agent receives a subject electronic message associated with the subscribing entity that (a) evaded the set of threat detection instructions and (b) determined to correspond to one of a malicious message class, a spam message class, and a graymail message class. Furthermore, in such an embodiment, in response to receiving the fourth user input, the AI agent control user interface element may be automatically transitioned or updated from indicating the autonomous AI agent is in the inactive state to indicating that the autonomous AI agent is active.

In other words, in some embodiments, the graphical user interface may enable a user associated with the subscribing entity to selectively activate or deactivate autonomous operation of the autonomous AI agent for the subscribing entity through one or more user interactions with the AI agent activation button, the AI agent control user interface element, and/or the drop-down element displayed on the graphical user interface.

### Autonomous AI Agent Configuration UI Component(s) for Malicious Message Class

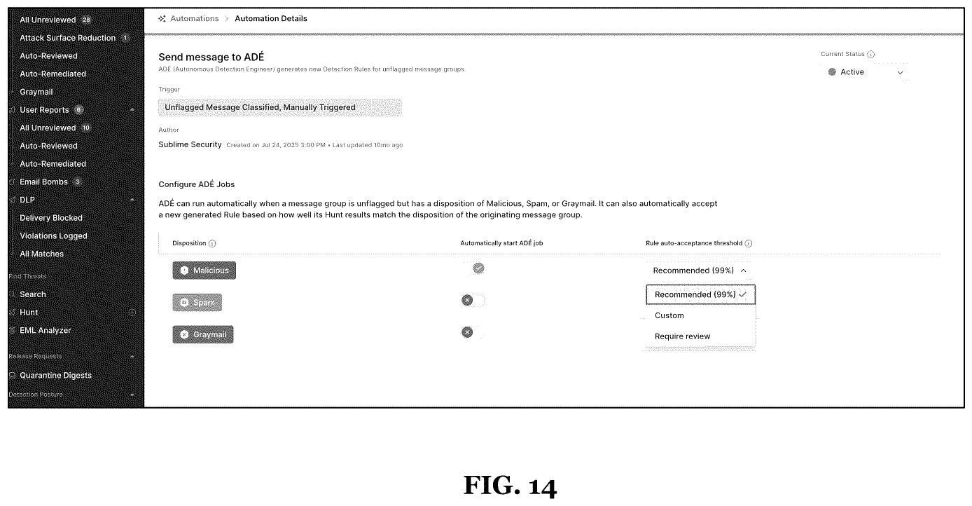

Turning to FIGS. 13C and 14, in one or more embodiments, before electronically transmitting the message data of the electronic message to the autonomous AI agent, the threat detection and response service may function to display, on the graphical user interface, a plurality of autonomous AI agent control user interface objects mapped to a malicious message class. In such an embodiment, the threat detection and response service may receive, via a first user interface control object of the plurality of autonomous AI agent control user interface objects, an input from a user that enables automated execution of the autonomous AI agent for the malicious message class. Accordingly, in such an embodiment, in response to receiving the input enabling automated execution of the autonomous AI agent for the malicious message class, the first user interface control object may be automatically transitioned or updated from a disabled state to an enabled state for the malicious message class.

In one or more embodiments, after enabling automated execution of the autonomous AI agent for the malicious message class, the threat detection and response service may receive, in real-time or near real-time, the electronic message and, in response, determine, in real-time or near real-time by an automated message triaging agent, that the electronic message is of the malicious message class. In one or more embodiments, in response to the automated message triaging agent determining that the electronic message is of the malicious message class, the threat detection and response service may automatically transmit, by the automated message triaging agent, the message data of the electronic message to the autonomous AI agent in real-time or near real-time.

Additionally, in such an embodiment, the threat detection and response service may receive, via the graphical user interface, an additional input from the user selecting a second user interface control object of the plurality of autonomous AI agent control user interface objects mapped to the malicious message class. In such an embodiment, in response to receiving the additional input selecting the second user interface control object, the graphical user interface may display a drop-down element that includes a plurality of distinct instruction acceptance options for the malicious message class. The plurality of distinct instruction acceptance options, in such an embodiment, may include (i) an automatic instruction acceptance option that, when selected, encodes (or instructions) the autonomous AI agent to automatically deploy all production-ready threat detection instructions generated by the autonomous AI agent for the malicious message class that satisfy a target instruction acceptance criterion defined by the threat detection and response service, (ii) a custom instruction acceptance option that, when selected, encodes (or instructs) the autonomous AI agent to automatically deploy all production-ready threat detection instructions generated by the autonomous AI agent for the malicious message class that satisfy a custom instruction acceptance criterion defined by the user, and (iii) a user instruction review option that, when selected, encodes (or instructs) the autonomous AI agent to prevent automatic deployment of production-ready threat detection instructions generated by the autonomous AI agent for the malicious message class until review and approval by the user. Furthermore, in such an embodiment, the threat detection and response service may receive a subsequent user input from the user selecting the automatic instruction acceptance option while the drop-down element is displayed on the graphical user interface.

Accordingly, in one or more embodiments, in response to generating the production-ready threat detection instruction, the autonomous AI agent may function to automatically deploy the production-ready threat detection instruction within a distinct instance (e.g., compute environment or the like) of the threat detection and response service configured for the subscribing entity based on detecting (a) the subsequent user input selected the automatic instruction acceptance option and (b) the target instruction acceptance criterion defined by the threat detection and response service is satisfied.

### Autonomous AI Agent Configuration UI Component(s) for Spam Message Class

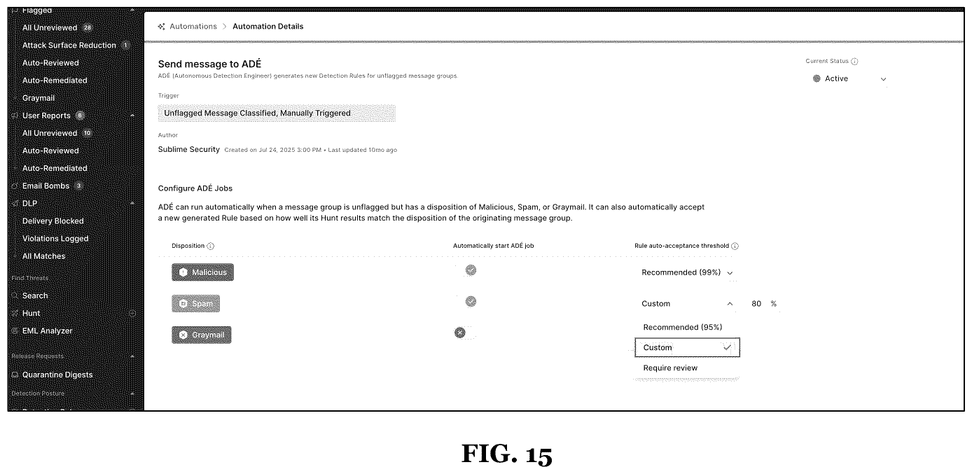

Turning to FIGS. 13C and 15, in one or more embodiments, before electronically transmitting the message data of the electronic message to the autonomous AI agent, the threat detection and response service may function to display, on the graphical user interface, a plurality of autonomous AI agent control user interface objects mapped to a spam message class. In such an embodiment, the threat detection and response service may receive, via a first user interface control object of the plurality of autonomous AI agent control user interface objects mapped to the spam message class, an input from a user that enables automated execution of the autonomous AI agent for the spam message class. Accordingly, in such an embodiment, in response to receiving the input enabling automated execution of the autonomous AI agent for the spam message class, the first user interface control object may be automatically transitioned or updated from a disabled state to an enabled state for the spam message class.

In one or more embodiments, after enabling automated execution of the autonomous AI agent for the spam message class, the threat detection and response service may receive, in real-time or near real-time, the electronic message and, in response, determine, in real-time or near real-time by an automated message triaging agent, that the electronic message is of the spam message class. In one or more embodiments, in response to the automated message triaging agent determining that the electronic message is of the spam message class, the threat detection and response service may automatically transmit, by the automated message triaging agent, the message data of the electronic message to the autonomous AI agent in real-time or near real-time.

Additionally, in such an embodiment, the threat detection and response service may receive, via the graphical user interface, an additional input from the user selecting a second user interface control object of the plurality of autonomous AI agent control user interface objects mapped to the spam message class. In such an embodiment, in response to receiving the additional input selecting the second user interface control object, the graphical user interface may display a drop-down element that includes a plurality of distinct instruction acceptance options for the spam message class. The plurality of distinct instruction acceptance options, in such an embodiment, may include (i) an automatic instruction acceptance option that, when selected, encodes (or instructions) the autonomous AI agent to automatically deploy all production-ready threat detection instructions generated by the autonomous AI agent for the spam message class that satisfy a target instruction acceptance criterion defined by the threat detection and response service, (ii) a custom instruction acceptance option that, when selected, encodes (or instructs) the autonomous AI agent to automatically deploy all production-ready threat detection instructions generated by the autonomous AI agent for the spam message class that satisfy a custom instruction acceptance criterion defined by the user, and (iii) a user instruction review option that, when selected, encodes (or instructs) the autonomous AI agent to prevent automatic deployment of production-ready threat detection instructions generated by the autonomous AI agent for the spam message class until review and approval by the user. Furthermore, in such an embodiment, the threat detection and response service may receive a subsequent user input from the user selecting the custom instruction acceptance option while the drop-down element is displayed on the graphical user interface.

Accordingly, in one or more embodiments, in response to generating the production-ready threat detection instruction, the autonomous AI agent may function to automatically deploy the production-ready threat detection instruction within a distinct instance of the threat detection and response service configured for the subscribing entity based on detecting (a) the subsequent user input selected the custom instruction acceptance option and (b) the custom instruction acceptance criterion defined by the user is satisfied.

### Autonomous AI Agent Configuration UI Component(s) for Graymail Message Class

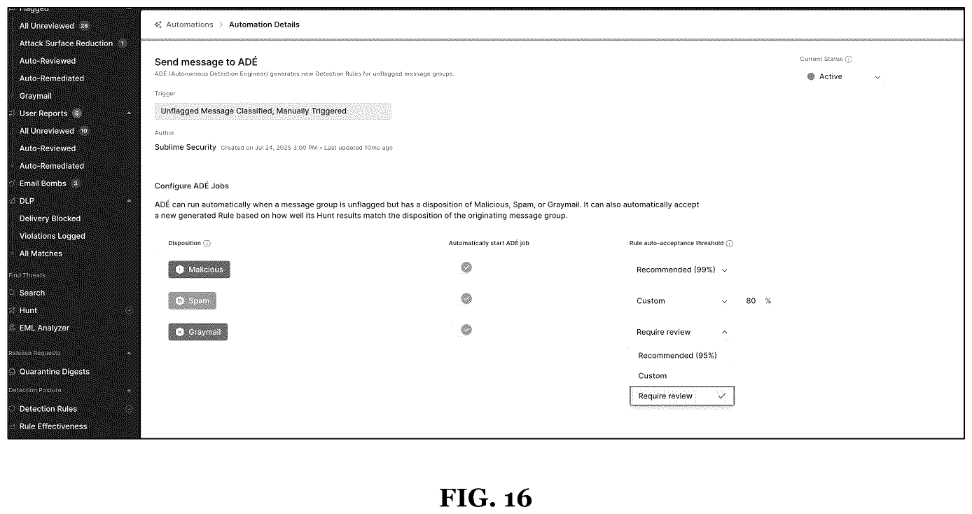

Turning to FIGS. 13C and 16, in one or more embodiments, before electronically transmitting the message data of the electronic message to the autonomous AI agent, the threat detection and response service may function to display, on the graphical user interface, a plurality of autonomous AI agent control user interface objects mapped to a graymail message class. In such an embodiment, the threat detection and response service may receive, via a first user interface control object of the plurality of autonomous AI agent control user interface objects mapped to the graymail message class, an input from a user that enables automated execution of the autonomous AI agent for the graymail message class. Accordingly, in such an embodiment, in response to receiving the input enabling automated execution of the autonomous AI agent for the graymail message class, the first user interface control object may be automatically transitioned or updated from a disabled state to an enabled state for the graymail message class.

In one or more embodiments, after enabling automated execution of the autonomous AI agent for the graymail message class, the threat detection and response service may receive, in real-time or near real-time, the electronic message and, in response, determine, in real-time or near real-time by an automated message triaging agent, that the electronic message is of the graymail message class. In one or more embodiments, in response to the automated message triaging agent determining that the electronic message is of the graymail message class, the threat detection and response service may automatically transmit, by the automated message triaging agent, the message data of the electronic message to the autonomous AI agent in real-time or near real-time.

Additionally, in such an embodiment, the threat detection and response service may receive, via the graphical user interface, an additional input from the user selecting a second user interface control object of the plurality of autonomous AI agent control user interface objects mapped to the graymail message class. In such an embodiment, in response to receiving the additional input selecting the second user interface control object, the graphical user interface may display a drop-down element that includes a plurality of distinct instruction acceptance options for the graymail message class. The plurality of distinct instruction acceptance options, in such an embodiment, may include (i) an automatic instruction acceptance option that, when selected, encodes (or instructions) the autonomous AI agent to automatically deploy all production-ready threat detection instructions generated by the autonomous AI agent for the graymail message class that satisfy a target instruction acceptance criterion defined by the threat detection and response service, (ii) a custom instruction acceptance option that, when selected, encodes (or instructs) the autonomous AI agent to automatically deploy all production-ready threat detection instructions generated by the autonomous AI agent for the graymail message class that satisfy a custom instruction acceptance criterion defined by the user, and (iii) a user instruction review option that, when selected, encodes (or instructs) the autonomous AI agent to prevent automatic deployment of production-ready threat detection instructions generated by the autonomous AI agent for the graymail message class until review and approval by the user. Furthermore, in such an embodiment, the threat detection and response service may receive a subsequent user input from the user selecting the user instruction review option while the drop-down element is displayed on the graphical user interface.

Accordingly, in one or more embodiments, in response to generating the production-ready threat detection instruction, the autonomous AI agent may function to automatically display the production-ready threat detection instruction on the graphical user interface based on detecting the subsequent user input selected the user instruction review option.

### Autonomous AI Agent and Automated Messaging Triage Agent Communication

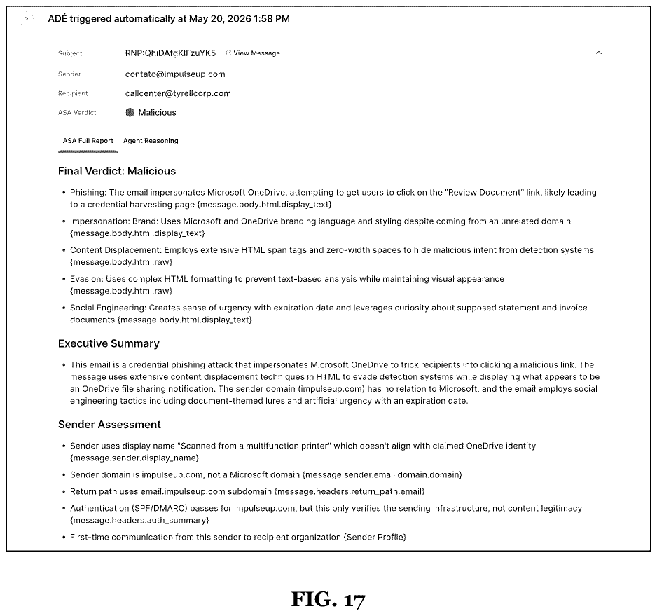

Additionally, or alternatively, in one or more embodiments, before electronically transmitting the message data of the electronic message of the subscribing entity to the autonomous AI agent, an automated message triaging agent may function to automatically generate a threat assessment object for the electronic message. The threat assessment object, in some embodiments, may include a message threat class predicted for the electronic message and a plurality of distinct threat assessment sections that explains, in natural language, a rationale describing why the automated message triaging agent predicted the message threat class for the electronic message, as shown generally by of example in FIG. 17. It shall be recognized that the automated message triaging agent is described in U.S. Patent Application No. 63/912,604, titled “Autonomous Security Analyst,” which is incorporated herein by reference in its entirety.

In one or more embodiments, generating the candidate threat detection instruction may include providing the threat assessment object generated for the electronic message to the large language model associated with the autonomous AI agent; generating, using the large language model, the message signature for the electronic message in response to the large language model assessing the message data of the electronic message and the threat assessment object, wherein the message signature includes a plurality of message characteristics associated with the electronic message; in response to generating the message signature for the electronic message, querying, using a representation of the message signature as a query parameter, the set of threat detection instructions to determine whether an existing threat detection instruction included in the set of threat detection instructions is associated with the message signature; determining, based on query results returned from the querying, that no threat detection instruction included in the set of threat detection instructions is determined to be extensible to detect the message signature; and in response to determining that no threat detection instruction included in the set of threat detection instructions is extensible to detect the message signature, generating, using the large language model, the new threat detection instruction based in part on the message signature, wherein the new threat detection instruction includes a plurality of detection expressions operably configured to detect the message signature.

It shall be recognized that, in a first implementation, the query results may have returned at least one threat detection instruction that is associated with a subset of the plurality of message characteristics included in the message signature. In such an embodiment, the large language model associated with the autonomous AI agent may determine that the at least one threat detection instruction is not extensible to detect the message signature due to the at least one threat detection instruction failing to evaluate the subset of the plurality of message characteristics in combination with one or more additional message characteristics included in the message signature. Stated another way, in one or more embodiments, the large language model may have determined that no threat detection instruction included in the set of threat detection instructions is extensible to detect the message signature based on the large language model determining that the at least one threat detection instruction does not evaluate the subset of the plurality of message characteristics together with the one or more additional message characteristics within a single threat detection instruction. For instance, in a non-limiting example, the query results may identify a historical threat detection instruction associated with a OneDrive impersonation attack pattern, but the large language model associated with the autonomous AI agent may determine that the historical threat detection instruction is not extensible because the historical threat detection instruction fails to additionally evaluate scanner or printer impersonation indicators included in the message signature.

It shall be recognized that, in a second implementation, the large language model may have determined that no threat detection instruction included in the set of threat detection instructions is extensible to detect the message signature due to the querying failing to identify any threat detection instruction associated with the message signature.

Alternatively, in another embodiment, before electronically transmitting the message data of the electronic message of the subscribing entity to the autonomous AI agent, an automated message triaging agent may function to automatically generate a threat assessment object for the electronic message. The threat assessment object, in some embodiments, may include a message threat class predicted for the electronic message and a plurality of distinct threat assessment sections that explains, in natural language, a rationale describing why the automated message triaging agent predicted the message threat class for the electronic message. In such an embodiment, generating the candidate threat detection instruction may include providing the threat assessment object generated for the electronic message to the large language model associated with the autonomous AI agent; generating, using the large language model, the message signature for the electronic message in response to the large language model assessing the message data of the electronic message and the threat assessment object, wherein the message signature includes a plurality of message characteristics associated with the electronic message; querying, based on the message signature, the set of threat detection instructions to determine whether an existing threat detection instruction included in the set of threat detection instructions is associated with the message signature; returning the respective threat detection instruction based on the querying detecting the respective threat detection instruction is associated with the message signature; determining, by the large language model associated with the autonomous AI agent, that (a) the respective threat detection instruction is extensible to detect the message signature and (b) one or more additional message characteristics included in the message signature are not evaluated by the respective threat detection instruction; and generating, using the large language model associated with the autonomous AI agent, a modified version of the respective threat detection instruction by adding, within the respective threat detection instruction, one or more detection expressions configured to evaluate the one or more additional message characteristics.

In other words, in one or more embodiments, the large language model associated with the autonomous AI agent may determine that the respective threat detection instruction is partially extensible to detect the message signature because the respective threat detection instruction already evaluates a first subset of message characteristics included in the message signature but fails to additionally evaluate one or more additional message characteristics included in the message signature. Accordingly, in such an embodiment, the large language model associated with the autonomous AI agent may extend the respective threat detection instruction by adding one or more additional detection expressions configured to evaluate the one or more additional message characteristics included in the message signature.

At least one technical benefit of the systems, methods, embodiments, and computer program products described herein is that the autonomous AI agent may automatically extend existing threat detection instructions responsive to determining that the existing threat detection instructions already evaluate a first subset of message characteristics associated with a message signature, thereby reducing redundant generation of entirely new threat detection instructions while enabling the threat detection and response service to detect new attack patterns.

### Subagents

In one or more embodiments, the subagents described herein may correspond to one or more specialized autonomous software agents configured to perform distinct cybersecurity assessment operations for the autonomous AI agent. For instance, in one or more embodiments, the one or more subagents may include one or more large language models, machine learning models, deterministic algorithms, heuristic assessment engines, and/or software processes configured to access, invoke, and/or execute one or more invokable tools, backend services, APIs, cybersecurity analysis functions, threat hunt functions, validation functions, enrichment functions, and/or other executable computational operations for the autonomous AI agent, as described above.

### 3. Computer-Implemented Method and Computer Program Product

Embodiments of the system and/or method can include every combination and permutation of the various system components and the various method processes, wherein one or more instances of the method and/or processes described herein can be performed in real-time or near real-time, asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although omitted for conciseness, the preferred embodiments include every combination and permutation of the implementations of the systems and methods described herein. Furthermore, each method step, process step, or the like described herein may be performed in real-time or near real-time. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

As a person skilled in the art will recognize from the previous detailed description and from the figures and claims, modifications and changes can be made to the preferred embodiments of the invention without departing from the scope of this invention defined in the following claims.

We claim:

1. A computer-implemented method comprising:
at a threat detection and response service:
electronically transmitting, to an autonomous artificial intelligence (AI) agent, message data of an electronic message that evaded a set of threat detection instructions provided by the threat detection and response service, wherein the electronic message evaded detection by the threat detection and response service due to a detection gap in the set of threat detection instructions;
in response to the autonomous AI agent receiving the message data of the electronic message:
automatically detecting, based on the autonomous AI agent assessing the message data of the electronic message, a message signature associated with the electronic message;
automatically determining, based on the autonomous AI agent assessing the message signature against the set of threat detection instructions, a detection gap resolution operation to resolve the detection gap, wherein:
the detection gap resolution operation corresponds to updating a respective threat detection instruction included in the set of threat detection instructions when the respective threat detection instruction is determined to be extensible to detect the message signature, and
the detection gap resolution operation corresponds to generating a new threat detection instruction when no threat detection instruction included in the set of threat detection instructions is determined to be extensible to detect the message signature;
generating, using a large language model associated with the autonomous AI agent and in accordance with the detection gap resolution operation, a candidate threat detection instruction that is operably configured to (i) resolve the detection gap and (ii) detect suspicious electronic messages that correspond to the message signature;
iteratively modifying, by the autonomous AI agent, the candidate threat detection instruction over a plurality of iterations to generate a production-ready threat detection instruction that satisfies predetermined instruction performance criteria of the threat detection and response service; and
in response to generating the production-ready threat detection instruction:
displaying the production-ready threat detection instruction on a graphical user interface that is accessible by a subscribing entity that received the electronic message, or
automatically deploying, within the threat detection and response service, the production-ready threat detection instruction to resolve the detection gap and prevent future electronic messages corresponding to the message signature from evading the set of threat detection instructions.

2. The computer-implemented method according to claim 1, wherein iteratively modifying the candidate threat detection instruction over the plurality of iterations to generate the production-ready threat detection instruction includes:
in response to generating the candidate threat detection instruction, executing, by the autonomous AI agent, a first threat hunt that assesses a plurality of historical electronic messages that occurred during a target time span against the candidate threat detection instruction;
receiving, based on executing the first threat hunt, hunt findings data that specifies:
a total number of true positive electronic messages that the candidate threat detection instruction correctly detected as malicious,
a total number of false positive electronic messages that the candidate threat detection instruction incorrectly detected as malicious, and
a total number of unique true positive electronic messages that (a) the candidate threat detection instruction correctly detected as malicious and (b) were not detected as malicious by any other threat detection instructions included in the set of threat detection instructions;
computing, using a subagent in operable communication with the autonomous AI agent, a detection accuracy score for the candidate threat detection instruction based on the hunt findings data associated with the first threat hunt, wherein the detection accuracy score is computed using the total number of true positive electronic messages, the total number of false positive electronic messages, and the total number of unique true positive electronic messages;
detecting, by the subagent in operable communication with the autonomous AI agent, that the detection accuracy score computed for the candidate threat detection instruction fails to satisfy the predetermined instruction performance criteria of the threat detection and response service;
in response to detecting the detection accuracy score computed for the candidate threat detection instruction fails to satisfy the predetermined instruction performance criteria of the threat detection and response service, generating, using the large language model associated with the autonomous AI agent, a second candidate threat detection instruction by modifying detection logic encoded in the candidate threat detection instruction;
in response to generating the second candidate threat detection instruction, executing, by the autonomous AI agent, a second threat hunt that assesses the plurality of historical electronic messages that occurred during the target time span against the second candidate threat detection instruction;
computing, using the subagent in operable communication with the autonomous AI agent, a detection accuracy score for the second candidate threat detection instruction using new hunt findings data received from the second threat hunt;
determining, by the subagent in operable communication with the autonomous AI agent, that the detection accuracy score computed for the second candidate threat detection satisfies the predetermined instruction performance criteria of the threat detection and response service; and
in response to identifying the second candidate threat detection instruction satisfies the predetermined instruction performance criteria of the threat detection and response service:
designating, by the autonomous AI agent, the second candidate threat detection instruction as the production-ready threat detection instruction.

3. The computer-implemented method according to claim 1, wherein iteratively modifying the candidate threat detection instruction over the plurality of iterations to generate the production-ready threat detection instruction includes:
in response to generating the candidate threat detection instruction, computing, using a subagent in operable communication with the autonomous AI agent, an instruction evasion susceptibility score for the candidate threat detection instruction based on:
(a) a total number of detection expressions encoded in the candidate threat detection instruction that rely on exact string matching of indicators of compromise values, and
(b) a total number of detection expressions encoded in the candidate threat detection instruction that models attacker behaviors instead of relying on exacting string matching of the indicators of compromise values;
detecting, by the subagent in operable communication with the autonomous AI agent, that the instruction evasion susceptibility score computed for the candidate threat detection instruction fails to satisfy the predetermined instruction performance criteria of the threat detection and response service;
in response to detecting the instruction evasion susceptibility score computed for the candidate threat detection instruction fails to satisfy the predetermined instruction performance criteria of the threat detection and response service, generating, using the large language model associated with the autonomous AI agent, a second candidate threat detection instruction by modifying detection logic encoded in the candidate threat detection instruction;
in response to generating the second candidate threat detection instruction, computing, using the subagent in operable communication with the autonomous AI agent, an instruction evasion susceptibility score for the second candidate threat detection instruction;
determining, by the subagent in operable communication with the autonomous AI agent, that the instruction evasion susceptibility score computed for the second candidate threat detection satisfies the predetermined instruction performance criteria of the threat detection and response service; and
in response to identifying the second candidate threat detection instruction satisfies the predetermined instruction performance criteria of the threat detection and response service:
designating, by the autonomous AI agent, the second candidate threat detection instruction as the production-ready threat detection instruction.

4. The computer-implemented method according to claim 1, wherein:
the production-ready threat detection instruction is encoded with a computer-executable enrichment function that is configured to perform an enrichment operation, and
the computer-implemented method further includes:
assessing a data model of one of the future electronic messages against the production-ready threat detection instruction;
invoking the computer-executable enrichment function during the assessment of the data model of the one of the future electronic messages against the production-ready threat detection instruction;
transmitting a request to a backend service of the threat detection and response service to perform the enrichment operation in response to invoking the computer-executable enrichment function; and
receiving a response from the backend service that includes an enrichment output in response to the backend service performing the enrichment operation, wherein the production-ready threat detection instruction determines that the one of the future electronic messages is malicious based at least in part on the enrichment output.

5. The computer-implemented method according to claim 1, wherein iteratively modifying the candidate threat detection instruction over the plurality of iterations to generate the production-ready threat detection instruction includes:
detecting, based on the autonomous AI agent assessing the candidate threat detection instruction, that at least one detection expression encoded in the candidate threat detection instruction does not conform to syntax requirements defined by the threat detection and response service;
generating, using the large language model associated with the autonomous AI agent, a second candidate threat detection instruction by modifying the at least one detection expression to conform to the syntax requirements defined by the threat detection and response service;
in response to generating the second candidate threat detection instruction, confirming, based on the autonomous AI agent assessing the second candidate threat detection instruction against the electronic message, that the second candidate threat detection instruction detects the electronic message as malicious, spam, or graymail;
in response to confirming that the second candidate threat detection instruction detects the electronic message as malicious, spam, or graymail, executing, by the autonomous AI agent, a first threat hunt that assesses a plurality of historical electronic messages of the subscribing entity using the second candidate threat detection instruction;
receiving, based on executing the first threat hunt, hunt findings data that indicates the second candidate threat detection instruction did not detect any historical electronic messages of the plurality of historical electronic messages as malicious, spam, or graymail;
determining, using one or more subagents in operable communication with the autonomous AI agent, that the second candidate threat detection instruction is too restrictive based in part on the one or more subagents assessing the hunt findings data;
generating, using the large language model associated with the autonomous AI agent, a third candidate threat detection instruction based on modifying one or more portions of the second candidate threat detection instruction to reduce a restrictiveness of the second candidate threat detection instruction;
in response to generating the third candidate threat detection instruction:
confirming, based on the autonomous AI agent assessing the third candidate threat detection instruction, that the third candidate threat detection instruction satisfies the syntax requirements defined by the threat detection and response service; and
confirming, based on the autonomous AI agent assessing the third candidate threat detection instruction against the electronic message, that the third candidate threat detection instruction detects the electronic message as malicious, spam, or graymail;
in response to confirming that the third candidate threat detection instruction detects the electronic message as malicious, spam, or graymail, executing, by the autonomous AI agent, a second threat hunt that assesses the plurality of historical electronic messages of the subscribing entity using the third candidate threat detection instruction;
receiving, based on executing the second threat hunt, a subset of the plurality of historical electronic messages that the third candidate threat detection instruction detected as malicious, spam, or graymail;
determining, using the one or more subagents in operable communication with the autonomous AI agent, that the third candidate threat detection instruction is not restrictive based on the one or more subagents assessing the subset of the plurality of historical electronic messages returned from the second threat hunt;
identifying that the third candidate threat detection instruction satisfies the predetermined instruction performance criteria of the threat detection and response service in response to the one or more subagents determining that the third candidate threat detection instruction is not restrictive, and
in response to identifying the third candidate threat detection instruction satisfies the predetermined instruction performance criteria, designating the third candidate threat detection instruction as the production-ready threat detection instruction.

6. The computer-implemented method according to claim 1, wherein:
the production-ready threat detection instruction generated by the autonomous AI agent includes a plurality of distinct threat detection sections, and
each distinct threat detection section of the plurality of distinct threat detection sections includes:
a respective subset of threat detection logic associated with a corresponding threat detection objective, and
one or more natural language code comments that describe the corresponding threat detection objective associated with the respective subset of threat detection logic.

7. The computer-implemented method according to claim 1, further comprising:
before electronically transmitting the message data of the electronic message to the autonomous AI agent:
displaying, on the graphical user interface, the electronic message of the subscribing entity and an AI agent invocation user interface button configured to invoke the autonomous AI agent; and
receiving, while displaying the electronic message and the AI agent invocation user interface button on the graphical user interface, an input from a user selecting the AI agent invocation user interface button; and
in response to receiving the input selecting the AI agent invocation user interface button, electronically transmitting, in real-time or near real-time, the message data of the electronic message to the autonomous AI agent.

8. The computer-implemented method according to claim 1, wherein:
the production-ready threat detection instruction is displayed on the graphical user interface in response to the autonomous AI agent generating the production-ready threat detection instruction, wherein the graphical user interface includes:
the production-ready threat detection instruction,
a calendar date and a clock time at which the autonomous AI agent was automatically invoked to assess the message data of the electronic message,
a total amount of time the autonomous AI agent autonomously operated to generate the production-ready threat detection instruction,
a natural language description generated for the production-ready threat detection instruction,
an autonomous AI agent reasoning summary describing, in natural language, a sequence of operations performed by the autonomous AI agent to generate and test the production-ready threat detection instruction,
a message hunt user interface object specifying a set of historical electronic messages detected by the production-ready threat detection instruction over a predetermined historical time period,
an instruction acceptance user interface button for approving deployment of the production-ready threat detection instruction, and
an instruction rejection user interface button for rejecting deployment of the production-ready threat detection instruction, and the computer-implemented method further includes:
receiving, via the graphical user interface, an input from a user selecting the instruction acceptance user interface button displayed on the graphical user interface; and
in response to receiving the input selecting the instruction acceptance user interface button, automatically deploying the production-ready threat detection instruction within a distinct instance of the threat detection and response service that is configured for the subscribing entity, thereby preventing the future electronic messages from evading threat detection within the distinct instance of the threat detection and response service.

9. The computer-implemented method according to claim 8, further comprising:
in response to generating the production-ready threat detection instruction:
generating, using the large language model associated with the autonomous AI agent, one or more natural language artifacts for the production-ready threat detection instruction, wherein:
the one or more natural language artifacts are displayed on the graphical user interface, and
the one or more natural language artifacts includes:
a first set of natural language text strings describing a plurality of detection expressions encoded in the production-ready threat detection instruction,
a second set of natural language text strings describing one or more computational cost reduction operations encoded in the production-ready threat detection instruction,
a third set of natural language text strings describing an efficacy of the production-ready threat detection instruction,
a fourth set of natural language text strings describing a set of false positive mitigation controls that the autonomous AI agent encoded in the production-ready threat detection instruction, and
a fifth set of natural language text strings describing a set of proposed instruction tuning recommendations generated by the autonomous AI agent for modifying the production-ready threat detection instruction upon occurrence of false positives or missed detections associated with the production-ready threat detection instruction.

10. The computer-implemented method according to claim 1, further comprising:
before electronically transmitting the message data of the electronic message to the autonomous AI agent:
displaying, on the graphical user interface, a plurality of autonomous AI agent control user interface objects mapped to a malicious message class, and
receiving, via a first user interface control object of the plurality of autonomous AI agent control user interface objects, an input from a user that enables automated execution of the autonomous AI agent for the malicious message class;
in response to receiving the input enabling automated execution of the autonomous AI agent for the malicious message class, transitioning the first user interface control object from a disabled state to an enabled state for the malicious message class; and
after enabling automated execution of the autonomous AI agent for the malicious message class:
receiving, in real-time or near real-time, the electronic message;
determining, in real-time or near real-time by an automated message triaging agent, that the electronic message is of the malicious message class; and
in response to the automated message triaging agent determining that the electronic message is of the malicious message class, automatically transmitting, by the automated message triaging agent, the message data of the electronic message to the autonomous AI agent in real-time or near real-time.

11. The computer-implemented method according to claim 10, further comprising:
before electronically transmitting the message data of the electronic message to the autonomous AI agent and while displaying the plurality of autonomous AI agent control user interface objects mapped to the malicious message class on the graphical user interface:
receiving, via the graphical user interface, an additional input from the user selecting a second user interface control object of the plurality of autonomous AI agent control user interface objects mapped to the malicious message class;
in response to receiving the additional input selecting the second user interface control object, displaying a drop-down element that includes a plurality of distinct instruction acceptance options for the malicious message class, wherein the plurality of distinct instruction acceptance options includes at least:
an automatic instruction acceptance option that, when selected, encodes the autonomous AI agent to automatically deploy all production-ready threat detection instructions generated by the autonomous AI agent for the malicious message class that satisfy a target instruction acceptance criterion defined by the threat detection and response service;
a custom instruction acceptance option that, when selected, encodes the autonomous AI agent to automatically deploy all production-ready threat detection instructions generated by the autonomous AI agent for the malicious message class that satisfy a custom instruction acceptance criterion defined by the user, and
a user instruction review option that, when selected, encodes the autonomous AI agent to prevent automatic deployment of production-ready threat detection instructions generated by the autonomous AI agent for the malicious message class until review and approval by the user;
receiving, while the drop-down element is displayed on the graphical user interface, a subsequent user input from the user selecting the automatic instruction acceptance option; and
in response to generating the production-ready threat detection instruction:
automatically deploying the production-ready threat detection instruction within a distinct instance of the threat detection and response service configured for the subscribing entity based on detecting (a) the subsequent user input selected the automatic instruction acceptance option and (b) the target instruction acceptance criterion defined by the threat detection and response service is satisfied.

12. The computer-implemented method according to claim 1, further comprising:
before electronically transmitting the message data of the electronic message to the autonomous AI agent:
displaying, on the graphical user interface, a plurality of autonomous AI agent control user interface objects mapped to a spam message class,
receiving, via a first user interface control object of the plurality of autonomous AI agent control user interface objects, an input from a user that enables automated execution of the autonomous AI agent for the spam message class;
in response to receiving the input enabling automated execution of the autonomous AI agent for the spam message class, transitioning the first user interface control object from a disabled state to an enabled state for the spam message class; and
after enabling automated execution of the autonomous AI agent for the spam message class:
receiving, in real-time or near real-time, the electronic message; and
determining, in real-time or near real-time by an automated message triaging agent, that the electronic message is of the spam message class; and
in response to the automated message triaging agent determining that the electronic message is of the spam message class, automatically transmitting, by the automated message triaging agent, the message data of the electronic message to the autonomous AI agent in real-time or near real-time.

13. The computer-implemented method according to claim 12, further comprising:
before electronically transmitting the message data of the electronic message to the autonomous AI agent and while displaying the plurality of autonomous AI agent control user interface objects mapped to the spam message class on the graphical user interface:
receiving, via the graphical user interface, an additional input from the user selecting a second user interface control object of the plurality of autonomous AI agent control user interface objects mapped to the spam message class;
in response to receiving the additional input selecting the second user interface control object, displaying a drop-down element that includes a plurality of distinct instruction acceptance options for the spam message class, wherein the plurality of distinct instruction acceptance options includes at least:
an automatic instruction acceptance option that, when selected, encodes the autonomous AI agent to automatically deploy all production-ready threat detection instructions generated by the autonomous AI agent for the spam message class that satisfy a target instruction acceptance criterion defined by the threat detection and response service;
a custom instruction acceptance option that, when selected, encodes the autonomous AI agent to automatically deploy all production-ready threat detection instructions generated by the autonomous AI agent for the spam message class that satisfy a custom instruction acceptance criterion defined by the user, and
a user instruction review option that, when selected, encodes the autonomous AI agent to prevent automatic deployment of production-ready threat detection instructions generated by the autonomous AI agent for the spam message class until review and approval by the user;
receiving, while the drop-down element is displayed on the graphical user interface, a subsequent user input from the user selecting the custom instruction acceptance option; and
in response to generating the production-ready threat detection instruction:
automatically deploying the production-ready threat detection instruction within a distinct instance of the threat detection and response service configured for the subscribing entity based on detecting (a) the subsequent user input selected the custom instruction acceptance option and (b) the custom instruction acceptance criterion defined by the user is satisfied.

14. The computer-implemented method according to claim 1, further comprising:
before electronically transmitting the message data of the electronic message to the autonomous AI agent:
displaying, on the graphical user interface, a plurality of autonomous AI agent control user interface objects mapped to a graymail message class,
receiving, via a first user interface control object of the plurality of autonomous AI agent control user interface objects, an input from a user that enables automated execution of the autonomous AI agent for the graymail message class;
in response to receiving the input enabling automated execution of the autonomous AI agent for the graymail message class, transitioning the first user interface control object from a disabled state to an enabled state for the graymail message class; and
after enabling automated execution of the autonomous AI agent for the graymail message class:
receiving, in real-time or near real-time, the electronic message; and
determining, in real-time or near real-time by an automated message triaging agent, that the electronic message is of the graymail message class; and
in response to the automated message triaging agent determining that the electronic message is of the graymail message class, automatically transmitting, by the automated message triaging agent, the message data of the electronic message to the autonomous AI agent in real-time or near real-time.

15. The computer-implemented method according to claim 14, further comprising:
before electronically transmitting the message data of the electronic message to the autonomous AI agent and while displaying the plurality of autonomous AI agent control user interface objects mapped to the graymail message class on the graphical user interface:
receiving, via the graphical user interface, an additional input from the user selecting a second user interface control object of the plurality of autonomous AI agent control user interface objects mapped to the graymail message class;
in response to receiving the additional input selecting the second user interface control object, displaying a drop-down element that includes a plurality of distinct instruction acceptance options for the graymail message class, wherein the plurality of distinct instruction acceptance options includes at least:
an automatic instruction acceptance option that, when selected, encodes the autonomous AI agent to automatically deploy all production-ready threat detection instructions generated by the autonomous AI agent for the graymail message class that satisfy a target instruction acceptance criterion defined by the threat detection and response service;
a custom instruction acceptance option that, when selected, encodes the autonomous AI agent to automatically deploy all production-ready threat detection instructions generated by the autonomous AI agent for the graymail message class that satisfy a custom instruction acceptance criterion defined by the user, and
a user instruction review option that, when selected, encodes the autonomous AI agent to prevent automatic deployment of production-ready threat detection instructions generated by the autonomous AI agent for the graymail message class until review and approval by the user;
receiving, while the drop-down element is displayed on the graphical user interface, a subsequent user input from the user selecting the user instruction review option; and
in response to generating the production-ready threat detection instruction:
displaying the production-ready threat detection instruction on the graphical user interface based on detecting the subsequent user input selected the user instruction review option.

16. The computer-implemented method according to claim 1, further comprising:
before electronically transmitting the message data of the electronic message to the autonomous AI agent:
receiving, via the graphical user interface, a first input from a user selecting a user interface object associated with the autonomous AI agent;
in response to receiving the first input selecting the user interface object associated with the autonomous AI agent, displaying, on the graphical user interface, an AI agent activation button for activating the autonomous AI agent;
receiving, via the graphical user interface, a second input from the user selecting the AI agent activation button;
in response to receiving the second input selecting the AI agent activation button, displaying, on the graphical user interface, an AI agent control user interface element that indicates the autonomous AI agent is in an inactive state;
receiving, via the graphical user interface, a third user input from the user selecting the AI agent control user interface element;
in response to receiving the third user input selecting the AI agent control user interface element, displaying, on the graphical user interface, a drop-down element that includes a selectable active state option and a selectable inactive state option for the autonomous AI agent; and
receiving, while displaying the drop-down element, a fourth user input selecting the selectable active state option; and
in response to receiving the fourth user input selecting the selectable active state option:
activating the autonomous AI agent for the subscribing entity to enable automated generation of production-ready threat detection instructions by the autonomous AI agent electronic messages when the autonomous AI agent receives a subject electronic message associated with the subscribing entity that (a) evaded the set of threat detection instructions and (b) determined to correspond to one of a malicious message class, a spam message class, and a graymail message class; and
transitioning the AI agent control user interface element from indicating the autonomous AI agent is in the inactive state to indicating that the autonomous AI agent is active.

17. The computer-implemented method according to claim 1, wherein:
the computer-implemented method further includes:
before electronically transmitting the message data of the electronic message of the subscribing entity to the autonomous AI agent:
automatically generating, using an automated message triaging agent, a threat assessment object for the electronic message, wherein the threat assessment object specifies a message threat class predicted for the electronic message and a plurality of distinct threat assessment sections that explains, in natural language, a rationale describing why the automated message triaging agent predicted the message threat class for the electronic message, and
generating the candidate threat detection instruction includes:
providing the threat assessment object generated for the electronic message to the large language model associated with the autonomous AI agent;
generating, using the large language model, the message signature for the electronic message in response to the large language model assessing the message data of the electronic message and the threat assessment object, wherein the message signature includes a plurality of message characteristics associated with the electronic message;
in response to generating the message signature for the electronic message, querying, using a representation of the message signature as a query parameter, the set of threat detection instructions to determine whether an existing threat detection instruction included in the set of threat detection instructions is associated with the message signature;
determining, based on query results returned from the querying, that no threat detection instruction included in the set of threat detection instructions is determined to be extensible to detect the message signature; and
in response to determining that no threat detection instruction included in the set of threat detection instructions is extensible to detect the message signature, generating, using the large language model, the new threat detection instruction based in part on the message signature, wherein the new threat detection instruction includes a plurality of detection expressions operably configured to detect the message signature.

18. The computer-implemented method according to claim 17, wherein:
the query results returned at least one threat detection instruction that is associated with a subset of the plurality of message characteristics included in the message signature, and
the computer-implemented method further includes:
determining, by the large language model, that the at least one threat detection instruction is not extensible to detect the message signature due to the at least one threat detection instruction failing to evaluate the subset of the plurality of message characteristics in combination with one or more additional message characteristics included in the message signature, wherein:
the large language model determined that no threat detection instruction included in the set of threat detection instructions is extensible to detect the message signature based on the large language model determining that the at least one threat detection instruction does not evaluate the subset of the plurality of message characteristics together with the one or more additional message characteristics within a single threat detection instruction.

19. The computer-implemented method according to claim 17, wherein:
the large language model determined that no threat detection instruction included in the set of threat detection instructions is extensible to detect the message signature due to the querying failing to identify any threat detection instruction associated with the message signature.

20. The computer-implemented method according to claim 1, wherein:
the computer-implemented method further includes:
before electronically transmitting the message data of the electronic message to the autonomous AI agent:
automatically generating, using an automated message triaging agent, a threat assessment object for the electronic message, wherein the threat assessment object specifies a threat class predicted for the electronic message and a plurality of distinct threat assessment sections that explains, in natural language, a rationale describing why the automated message triaging agent predicted the threat class for the electronic message, and
generating the candidate threat detection instruction includes:
providing the threat assessment object generated for the electronic message to the large language model associated with the autonomous AI agent;
generating, using the large language model, the message signature for the electronic message in response to the large language model assessing the message data of the electronic message and the threat assessment object, wherein the message signature includes a plurality of message characteristics associated with the electronic message;
querying, based on the message signature, the set of threat detection instructions to determine whether an existing threat detection instruction included in the set of threat detection instructions is associated with the message signature;
returning the respective threat detection instruction based on the querying detecting the respective threat detection instruction is associated with the message signature;
determining, by the large language model, that (a) the respective threat detection instruction is extensible to detect the message signature and (b) one or more additional message characteristics included in the message signature are not evaluated by the respective threat detection instruction; and
generating, using the large language model, a modified version of the respective threat detection instruction by adding, within the respective threat detection instruction, one or more detection expressions configured to evaluate the one or more additional message characteristics, wherein the modified version of the respective threat detection instruction corresponds to the candidate threat detection instruction.

21. The computer-implemented method according to claim 1, wherein:
the autonomous AI agent iteratively modifies the candidate threat detection instruction until the predetermined instruction performance criteria of the threat detection and response service is satisfied or a predetermined instruction cost criterion is satisfied, and
the computer-implemented method further includes:
detecting, via the autonomous AI agent, that the predetermined instruction cost criterion is satisfied; and
in response to detecting that the predetermined instruction cost criterion is satisfied:
designating, by the autonomous AI agent, a most recent candidate threat detection instruction generated over the plurality of iterations as the production-ready threat detection instruction;
generating, using the large language model associated with the autonomous AI agent, (a) explanatory data describing feedback data received from one or more subagents in operable communication with autonomous AI agent over the plurality of iterations and (b) one or more tradeoffs associated with the production-ready threat detection instruction; and
displaying the one or more tradeoffs for the production-ready threat detection instruction in association with the production-ready threat detection instruction on the graphical user interface.
